(19) United States
(12) Patent Application Publication
(10) Pub. No.: US 2013/0319899 A1
(43) Pub. Date: Dec. 5, 2013

(54) STACKABLE VESSELS

(71) Applicants: Lawrence Morgan Fowler, Redmond, WA (US); Zihong Guo, Bellevue, WA (US); Jenny Hu, Seattle, WA (US); John Arthur Ohrt, Redmond, WA (US)

(72) Inventors: Lawrence Morgan Fowler, Redmond, WA (US); Zihong Guo, Bellevue, WA (US); Jenny Hu, Seattle, WA (US); John Arthur Ohrt, Redmond, WA (US)

(73) Assignee: TOKITAE LLC, a limited liability company of the State of Delaware

(21) Appl. No.: 13/485,059

(22) Filed: May 31, 2012

Related U.S. Application Data
(63) Continuation-in-part of application No. 13/485,027, filed on May 31, 2012.

(51) Int. Cl. B65D 21/00; B65D 51/00; B29C 49/00; B65B 7/28

(52) U.S. Cl. 206/499; 220/752; 215/44; 220/200; 264/523

(57) ABSTRACT

The present disclosure relates to vessels and processes that may be used to fabricate vessels.

### CROSS-REFERENCE TO RELATED APPLICATIONS

The present application is related to and claims the benefit of the earliest available effective filing date(s) from the following listed application(s) (the “Related applications”) (e.g., claims earliest available priority dates for other than provisional patent applications or claims benefits under 35 USC §119(e) for provisional patent applications, for any and all parent, grandparent, great-grandparent, etc. applications of the Related application(s)).

### RELATED APPLICATIONS

For purposes of the USPTO extra-statutory requirements, the present application constitutes a continuation-in-part of U.S. patent application No. To Be Assigned, entitled VESSELS, naming Lawrence Morgan Fowler; Zihong Guo; Jenny Hu and John Arthur Ohrt as inventors, filed 31 May 2012, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related applications and of any and all parent, grandparent, great-grandparent, etc. applications of the Related applications is incorporated herein by reference to the extent such subject matter is not inconsistent herewith.

### TECHNICAL FIELD

The present disclosure relates to vessels and processes to fabricate vessels.

### SUMMARY

In some embodiments one or more vessels are provided that include, but are not limited to, a body portion that includes one or more side walls, a top portion that is operably connected to the body portion and that includes a shoulder portion that includes at least one opening that is positioned substantially adjacent to the one or more side walls of the body portion and at least one neck member that circumscribes the at least one opening and includes one or more attachment members, a bottom portion that is operably connected to the body portion and that includes at least one recessed portion and a substantially continuous non-recessed portion, one or more sealed handles that are operably connected to the vessel, and one or more recessed portions that protrude into the one or more side walls of the body portion. In addition to the foregoing, other aspects are described in the claims, drawings, and text forming a part of the present disclosure.

In some embodiments one or more vessels are provided that include, but are not limited to, a body portion that includes one or more side walls, a top portion that is operably connected to the body portion and that includes a shoulder portion that includes at least one opening that is positioned substantially adjacent to the one or more side walls of the body portion and at least one neck member that circumscribes the at least one opening and includes one or more attachment members, a bottom portion that is operably connected to the body portion and that includes at least one recessed portion and a substantially continuous non-recessed portion, one or more sealed handles that are operably connected to the vessel, and one or more recessed portions that protrude into the one or more side walls of the body portion. In some embodiments, the vessel may optionally include at least one lid. In addition to the foregoing, other aspects are described in the claims, drawings, and text forming a part of the present disclosure.

In some embodiments one or more vessels are provided that include, but are not limited to, a body portion that includes one or more side walls, a top portion that is operably connected to the body portion and that includes a shoulder portion that includes at least one opening that is positioned substantially adjacent to the one or more side walls of the body portion and at least one neck member that circumscribes the at least one opening and includes one or more attachment members, a bottom portion that is operably connected to the body portion and that includes at least two recessed portions and a substantially continuous non-recessed portion, and one or more sealed handles that are operably connected to the vessel. In addition to the foregoing, other aspects are described in the claims, drawings, and text forming a part of the present disclosure.

In some embodiments one or more vessels are provided that include, but are not limited to, a body portion that includes one or more side walls, a top portion that is operably connected to the body portion and that includes a shoulder portion that includes at least one opening that is positioned substantially adjacent to the one or more side walls of the body portion and at least one neck member that circumscribes the at least one opening and includes one or more attachment members, a bottom portion that is operably connected to the body portion and that includes at least two recessed portions and a substantially continuous non-recessed portion, and one or more sealed handles that are operably connected to the vessel. In some embodiments, the vessel may optionally include one or more recessed portions that protrude into the one or more side walls of the body portion. In addition to the foregoing, other aspects are described in the claims, drawings, and text forming a part of the present disclosure.

In some embodiments one or more vessels are provided that include, but are not limited to, a body portion that includes one or more side walls, a top portion that is operably connected to the body portion and that includes a shoulder portion that includes at least one opening that is positioned substantially adjacent to the one or more side walls of the body portion and at least one neck member that circumscribes the at least one opening and includes one or more attachment members, a bottom portion that is operably connected to the body portion and that includes at least two recessed portions and a substantially continuous non-recessed portion, and one or more sealed handles that are operably connected to the vessel. In some embodiments, the vessel may optionally include one or more recessed portions that protrude into the one or more side walls of the body portion. In some embodiments, the vessel may optionally include at least one lid. In addition to the foregoing, other aspects are described in the claims, drawings, and text forming a part of the present disclosure.

In some embodiments one or more processes are provided that include, but are not limited to, closing a mold that is configured to form at least one vessel having two recessed portions around a parison so that a portion of the parison is pinched together in at least two positions in a portion of the mold that forms a handle on the vessel, and injecting gas into one or more portions of the parison to form the at least one vessel defined by the mold. In addition to the foregoing, other aspects are described in the claims, drawings, and text forming a part of the present disclosure.

In some embodiments one or more processes are provided that include, but are not limited to, closing a mold that is configured to form at least one vessel having two recessed portions around a parison so that a portion of the parison is pinched together in at least two positions in a portion of the mold that forms a handle on the vessel, and injecting gas into one or more portions of the parison to form the at least one vessel defined by the mold. In some embodiments, the process may optionally include inserting at least one blow pin into the parison. In addition to the foregoing, other aspects are described in the claims, drawings, and text forming a part of the present disclosure.

In some embodiments one or more processes are provided that include, but are not limited to, closing a mold that is configured to form at least one vessel having two recessed portions around a parison so that a portion of the parison is pinched together in at least two positions in a portion of the mold that forms a handle on the vessel, and injecting gas into one or more portions of the parison to form the at least one vessel defined by the mold. In some embodiments, the process may optionally include inserting at least one blow needle into at least one portion of the mold that forms at least one handle on the at least one vessel. In addition to the foregoing, other aspects are described in the claims, drawings, and text forming a part of the present disclosure.

In some embodiments one or more processes are provided that include, but are not limited to, closing a mold that is configured to form at least one vessel having two recessed portions around a parison so that a portion of the parison is pinched together in at least two positions in a portion of the mold that forms a handle on the vessel, and injecting gas into one or more portions of the parison to form the at least one vessel defined by the mold. In some embodiments, the process may optionally include cooling the mold. In addition to the foregoing, other aspects are described in the claims, drawings, and text forming a part of the present disclosure.

In some embodiments, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In some embodiments, related systems include but are not limited to circuitry and/or programming for effecting the herein referenced process aspects; the circuitry and/or programming can be virtually any combination of hardware, software, and/or firmware configured to effect the herein referenced process aspects depending upon the design choices of the system designer. In addition to the foregoing, other system aspects are described in the claims, drawings, and/or text forming a part of the present application.

The foregoing summary is illustrative only and is not intended to be in any way limiting. In addition to the illustrative aspects, embodiments, and features described above, further aspects, embodiments, and features will become apparent by reference to the drawings, claims, and the following detailed description.

### BRIEF DESCRIPTION OF THE FIGURES

FIG. 1 illustrates an example vessel 100 in which embodiments may be implemented.

FIG. 2 illustrates alternate embodiments of the vessel of FIG. 1.

FIG. 3 illustrates alternate embodiments of the vessel of FIG. 1.

FIG. 4 illustrates alternate embodiments of the vessel of FIG. 1.

FIG. 5 illustrates alternate embodiments of the vessel of FIG. 1.

FIG. 6 illustrates alternate embodiments of the vessel of FIG. 1.

FIG. 7 illustrates alternate embodiments of the vessel of FIG. 1.

FIG. 8 illustrates alternate embodiments of the vessel of FIG. 1.

FIG. 9 illustrates alternate embodiments of the vessel of FIG. 1.

FIG. 10 illustrates alternate embodiments of the vessel of FIG. 1.

FIG. 11 illustrates alternate embodiments of the vessel of FIG. 1.

FIG. 12 illustrates alternate embodiments of the vessel of FIG. 1.

FIG. 13 illustrates alternate embodiments of the vessel of FIG. 1.

FIG. 14 illustrates an example vessel 1400 in which embodiments may be implemented.

FIG. 15 illustrates alternate embodiments of the vessel of FIG. 14.

FIG. 16 illustrates an example vessel 1600 in which embodiments may be implemented.

FIG. 17 illustrates alternate embodiments of the vessel of FIG. 16.

FIG. 18 illustrates alternate embodiments of the vessel of FIG. 16.

FIG. 19 illustrates alternate embodiments of the vessel of FIG. 16.

FIG. 20 illustrates alternate embodiments of the vessel of FIG. 16.

FIG. 21 illustrates alternate embodiments of the vessel of FIG. 16.

FIG. 22 illustrates alternate embodiments of the vessel of FIG. 16.

FIG. 23 illustrates alternate embodiments of the vessel of FIG. 16.

FIG. 24 illustrates alternate embodiments of the vessel of FIG. 16.

FIG. 25 illustrates alternate embodiments of the vessel of FIG. 16.

FIG. 26 illustrates alternate embodiments of the vessel of FIG. 16.

FIG. 27 illustrates an example vessel 2700 in which embodiments may be implemented.

FIG. 28 illustrates alternate embodiments of the vessel of FIG. 27.

FIG. 29 illustrates alternate embodiments of the vessel of FIG. 27.

FIG. 30 illustrates an example vessel 3000 in which embodiments may be implemented.

FIG. 31 illustrates alternate embodiments of the vessel of FIG. 30.

FIG. 32 illustrates an example process 3200 in which embodiments may be implemented.

FIG. 33 illustrates alternate embodiments of the process of FIG. 32.

FIG. 34 illustrates alternate embodiments of the process of FIG. 32.

FIG. 35 illustrates alternate embodiments of the process of FIG. 32.

FIG. 36 illustrates an example process 3600 in which embodiments may be implemented.

FIG. 37 illustrates alternate embodiments of the process of FIG. 36.

FIG. 38 illustrates an example process 3800 in which embodiments may be implemented.

FIG. 39 illustrates alternate embodiments of the process of FIG. 38.

FIG. 40 illustrates an example process 4000 in which embodiments may be implemented.

FIG. 41 illustrates alternate embodiments of the process of FIG. 40.

FIGS. 42A-42L illustrate an example vessel 4200.

FIGS. 43A-43E illustrate an example vessel 4300.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

A vessel may be constructed from a variety of materials. Examples of materials include, but are not limited to, one or more polymeric materials (e.g., high density polyethylene), one or more types of glass (e.g., borosilicate glass, soda-lime glass) one or more types of metal (e.g., liquidmetal) (see Liquidmetal Technologies, Rancho Santa Margarita, Calif., 92688), and the like. A vessel may be configured to contain numerous volumes and/or quantities of material. For example, in some embodiments, a vessel may be constructed to hold ten liters of fluid. In some embodiments, a vessel may be constructed to hold five liters of fluid. In some embodiments, a vessel may be constructed to hold twenty liters of fluid.

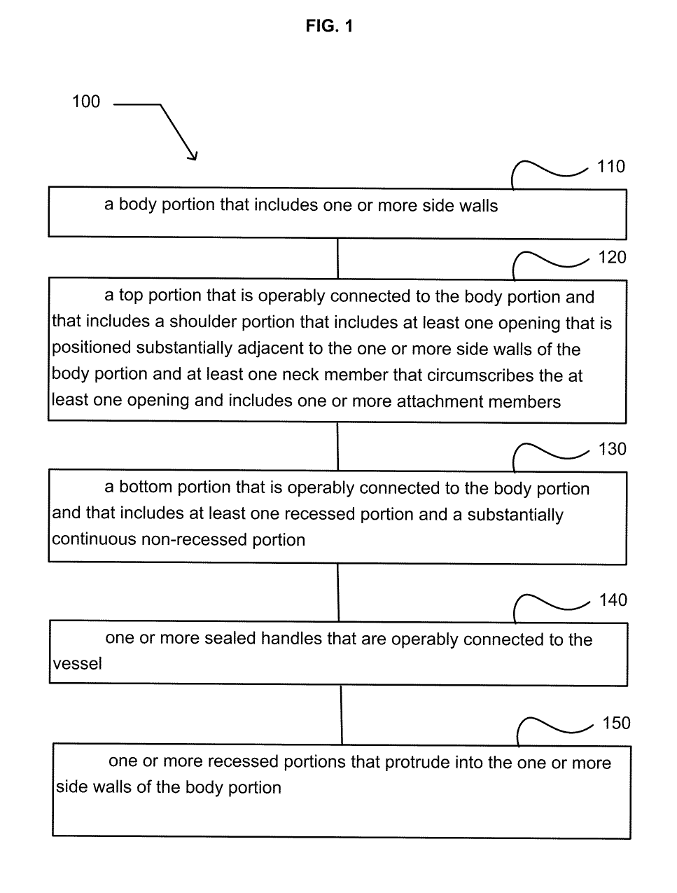

FIG. 1 illustrates an example vessel 100 in which embodiments may be implemented. A vessel 100 includes a body portion 110. In some embodiments, the body portion 110 may be formed from a single side wall. In some embodiments, the body portion 110 may be formed from two or more side walls. For example, in some embodiments, a vessel 100 may include two or more side walls that include an air space between the two or more side walls. In some embodiments, a vessel 100 may include two or more side walls that include insulation between the two or more side walls. In some embodiments, a vessel 100 may include two or more side walls that include a vacuum between the two or more side walls. In some embodiments, a vessel 100 may include two or more side walls that include a phase change material between the two or more side walls. In some embodiments, a vessel 100 may include one or more walls that separate the interior of the vessel into two or more chambers.

A vessel 100 includes a top portion 120 that is operably connected to the body portion 110. In some embodiments, a vessel 100 may include a top portion that is operably connected to the body portion and that includes a shoulder portion that includes at least one opening that is positioned substantially adjacent to one or more side walls of the body portion. The top portion 120 includes at least one neck member that circumscribes the at least one opening. The opening may be constructed to have numerous sizes. For example, in some embodiments, the size of the opening may be great enough to allow a person to insert their hand through the opening to access the interior of the vessel 100. In some embodiments, the neck member may optionally include one or more attachment members. The neck member may optionally include numerous types of attachment members. Examples, of such attachment members include, but are not limited to, threads, lugs, compression fittings, ridges, and the like. In some embodiments, a neck member may include transverse members that protrude from the neck member. In some embodiments, a neck member may include a friction fitting. In some embodiments, a neck member may include one or more insets that are configured to receive one or more protruding members. Accordingly, a neck member may include numerous types of attachment members.

A vessel 100 includes a bottom portion 130 that is operably connected to the body portion 110. In some embodiments, a vessel 100 includes a bottom portion 130 that is operably connected to the body portion 110 and that includes at least one recessed portion and a substantially continuous non-recessed portion. In some embodiments, the recessed portion 150 is configured to accept the neck portion of another vessel 100. In some embodiments, the recessed portion 150 is configured to accept a neck portion that is attached to a lid of another vessel 100. Accordingly, in some embodiments, a top vessel 100 may be stacked on top of a lower vessel 100 with the neck and lid of the lower vessel 100 being accepted into the recessed portion 150 of the top vessel 100. In some embodiments, a vessel 100 may include a substantially continuous non-recessed portion. The substantially continuously non-recessed portion may circumscribe the recessed portion 150 of the bottom portion 130 of the vessel 100. Accordingly, in some embodiments, a top vessel 100 may be stacked on top of a lower vessel 100 such that the neck and attached lid of the lower vessel 100 is accepted into the recessed portion 150 in the bottom portion 130 of the top vessel 100 and the substantially continuous non-recessed portion of the top vessel 100 substantially continuously rests on the shoulder portion of the lower vessel 100.

A vessel 100 includes one or more sealed handles 140 that are operably connected to the vessel 100. The sealed handles 140 are sealed on both ends of the handle such that the interior of the handle is isolated from the interior portion of the body of the vessel 100. Accordingly, in some embodiments, fluid is unable to flow from the interior of the body of the vessel 100 into a handle that is coupled to the vessel 100. In some embodiments, a handle is attached to the vessel 100 with one end of the handle being coupled to the shoulder of the top portion 120 of the vessel 100 and the other end being coupled to a side wall of the vessel 100. In some embodiments, a handle is attached to the vessel 100 with one end of the handle being coupled to the side wall of the vessel 100 and the other end being coupled to a side wall of the vessel 100. In some embodiments, a handle may extend beyond the outline of the body portion 110 of a vessel 100 to which it is attached. In some embodiments, a handle may not extend beyond the outline of the body portion 110 of a vessel 100 to which it is attached. Accordingly, in some embodiments, a handle may be attached to a vessel 100 such that the overall outline of the vessel 100 is maintained.

A vessel 100 includes one or more recessed portions 150 that protrude into the one or more side walls of the body portion 110. In some embodiments, a recessed portion 150 may protrude into a side wall of the vessel 100 at a position that is adjacent a handle such that the handle may be grasped and the fingers of the grasping hand will be positioned adjacent the recessed portion. In some embodiments, a recessed portion 150 may protrude into a side wall of the vessel 100 at a position on the vessel 100 that is opposite the position of a handle that is attached to the vessel 100. In some embodiments, a recessed portion 150 may protrude into a side wall of a vessel 100 at a position on the vessel 100 that is opposite that of an attached handle so that the recessed portion 150 serves as a handle for lifting the vessel 100. For example, in some embodiments, a worker may grasp a handle that is attached to a vessel 100 with one hand and grasp a recessed portion 150 that protrudes into a side wall of the vessel 100 on the opposite side of the handle with the other hand. Recessed portions 150 may protrude into the side wall of a vessel 100 in numerous places relative to the vessel 100. For example, in some embodiments, a recessed portion 150 may protrude into the vessel 100 at a position that is in the middle of the vessel 100 relative to the vertical axis of the vessel 100. In some embodiments, a recessed portion 150 may protrude into the vessel 100 at a position that is near the bottom portion 130 of the vessel 100. In some embodiments, a recessed portion 150 may protrude into the vessel 100 at a position that is near the top portion 120 of the vessel 100.

The following figure descriptions include various embodiments of vessels 100, discussion and explanation with respect to other alternative embodiments and contexts. However, it should be understood that a vessel 100 may have numerous configurations and modifications. Also, although various embodiments are presented in the figures, it should be understood that a vessel 100 may have a configuration that is other than those which are illustrated.

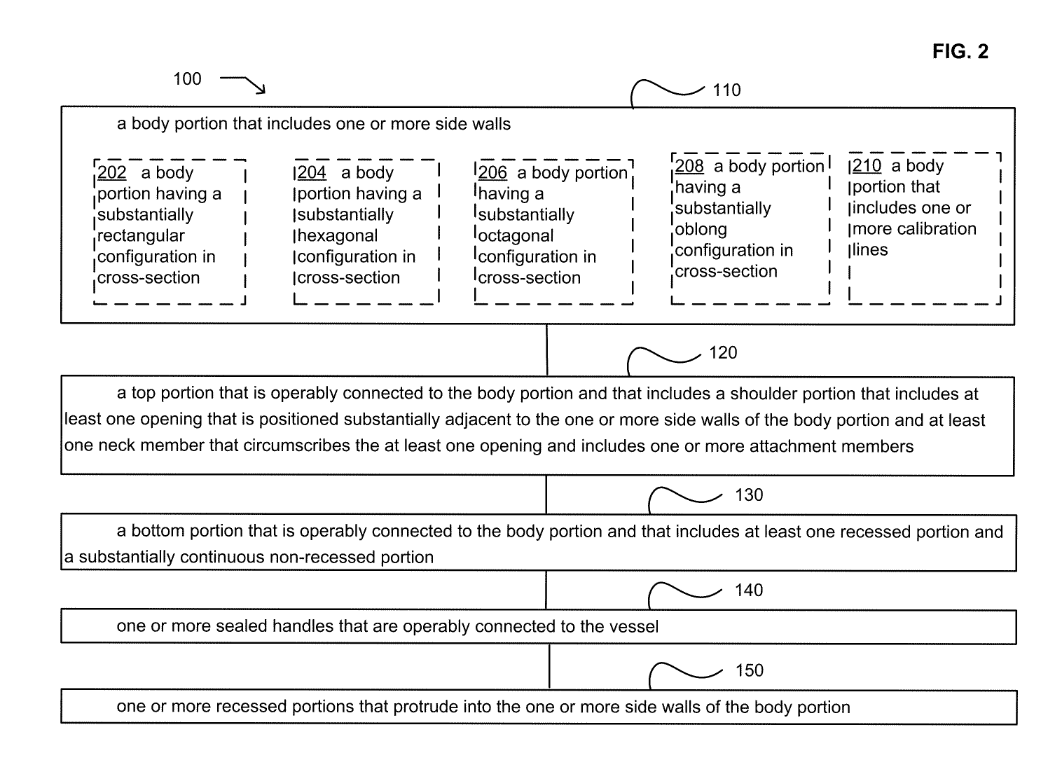

FIG. 2 illustrates example embodiments of a vessel 100. Additional embodiments may include an embodiment 202, an embodiment 204, an embodiment 206, an embodiment 208, and/or an embodiment 210.

Embodiment 202 illustrates a vessel 100 having a body portion having a substantially rectangular configuration in cross-section. In some embodiments, a vessel 100 may have a body portion 110 that has a substantially rectangular shape in cross-section relative to the vertical axis of the vessel 100. In some embodiments, a vessel 100 may include two or more side walls that are in a substantially rectangular shape.

Embodiment 204 illustrates a vessel 100 having a body portion having a substantially hexagonal configuration in cross-section. In some embodiments, a vessel 100 may have a body portion 110 that has a substantially hexagonal shape in cross-section relative to the vertical axis of the vessel 100. In some embodiments, a vessel 100 may include two or more side walls that are in a substantially hexagonal shape.

Embodiment 206 illustrates a vessel 100 having a body portion having a substantially octagonal configuration in cross-section. In some embodiments, a vessel 100 may have a body portion 110 that has a substantially octagonal shape in cross-section relative to the vertical axis of the vessel 100. In some embodiments, a vessel 100 may include two or more side walls that are in a substantially octagonal shape.

Embodiment 208 illustrates a vessel 100 having a body portion having a substantially oblong configuration in cross-section. In some embodiments, a vessel 100 may have a body portion 110 that has a substantially oblong shape in cross-section relative to the vertical axis of the vessel 100. In some embodiments, a vessel 100 may include two or more side walls that are in a substantially oblong shape.

Embodiment 210 illustrates a vessel 100 having a body portion that includes one or more calibration lines. In some embodiments, a vessel 100 may have a body portion 110 that includes one or more calibration lines. In some embodiments, a vessel 100 may include calibration lines that indicate a volume of material that is held within a vessel 100. For example, in some embodiments, calibration lines may be configured to indicate the quantity of liquid that is held within a vessel 100. In some embodiments, a vessel 100 may include calibration lines that indicate a mass of material that is held within a vessel 100. For example, in some embodiments, calibration lines may be configured to indicate the mass of grain that is held within a vessel 100. Accordingly, a vessel 100 may include calibration lines that are configured to provide information about numerous materials that may be held within the vessel 100.

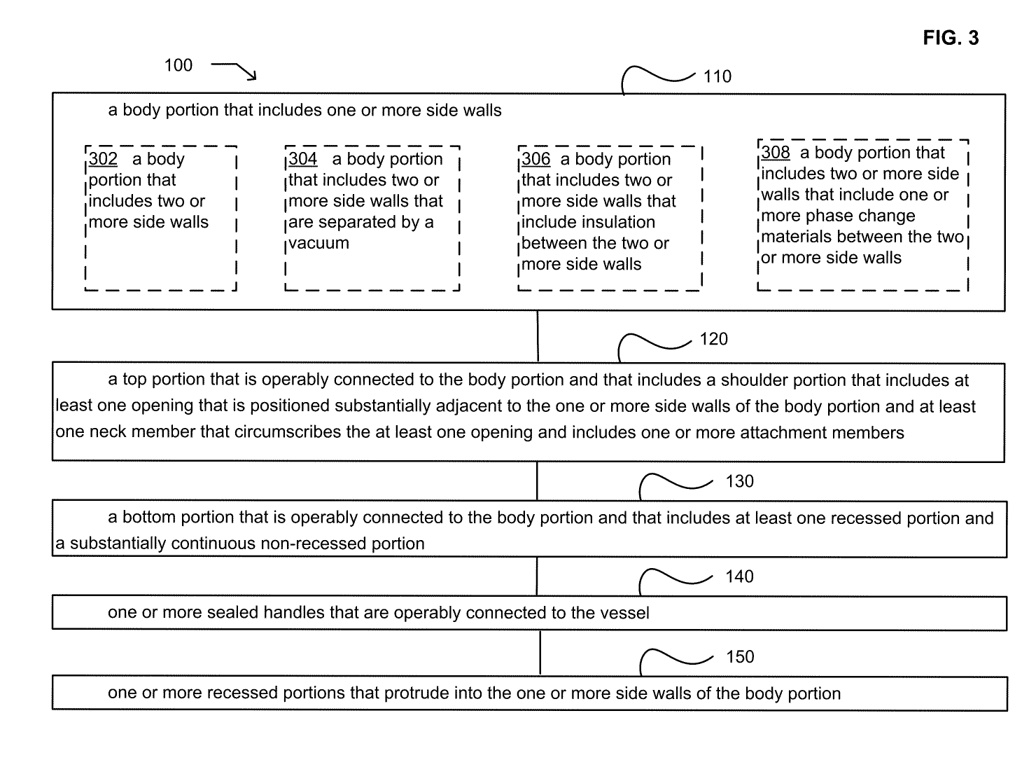

FIG. 3 illustrates example embodiments of a vessel 100. Additional embodiments may include an embodiment 302, an embodiment 304, an embodiment 306, and/or an embodiment 308.

Embodiment 302 illustrates a vessel 100 having a body portion that includes two or more side walls. In some embodiments, a vessel 100 may have a body portion 110 that includes two or more side walls. In some embodiments, a vessel 100 may include a body portion that includes two or more side walls that are separated by a vacuum. In some embodiments, a vessel 100 may include a body portion 110 that includes two or more side walls that are separated by insulation material. Numerous types of insulation material may be included between the walls of a vessel 100. Examples of such insulation material include, but are not limited to, one or more aerogels, polymeric foam materials, fiberglass, and the like. In some embodiments, a vessel 100 may include a body portion 110 that includes two or more side walls that are separated by a phase change material. Numerous types of phase change materials may be included between the walls of a vessel 100. Examples of such phase change materials include, but are not limited to, eutectics, salt hydrates, organic materials, and the like. Numerous phase change materials are known (e.g., Farid et al., A review on phase change energy storage: materials and applications, Energy Conservation and Management (45), pgs. 1597-1615 (2004)).

Embodiment 304 illustrates a vessel 100 having a body portion that includes two or more side walls that are separated by a vacuum. In some embodiments, a vessel 100 may include a body portion 110 that includes two or more side walls that are separated by a vacuum. In some embodiments, a vessel 100 may include a body portion 110 that includes two or more side walls that are separated by a vacuum and that include one or more getters within the vacuum space. Numerous types of getters are known and may be used. In some embodiments, a vessel 100 may include a body portion 110 that includes two or more side walls that are separated by a vacuum and that include one or more getters and insulation within the vacuum space.

Embodiment 306 illustrates a vessel 100 having a body portion that includes two or more side walls that include insulation between the two or more side walls. In some embodiments, a vessel 100 may include a body portion 110 that includes two or more side walls that include insulation between the two or more side walls. Numerous types of insulation material may be included between the walls of a vessel 100. Examples of such insulation material include, but are not limited to, one or more aerogels, polymeric foam materials, fiberglass, and the like.

Embodiment 308 illustrates a vessel 100 having a body portion that includes two or more side walls that include one or more phase change materials between the two or more side walls. In some embodiments, a vessel 100 may include a body portion 110 that includes two or more side walls that include one or more phase change materials between the two or more side walls. Numerous types of phase change materials may be included between the walls of a vessel 100. Examples of such phase change materials include, but are not limited to, eutectics, salt hydrates, organic materials, and the like. Numerous phase change materials are known (e.g., Farid et al., A review on phase change energy storage: materials and applications, Energy Conservation and Management (45), pgs. 1597-1615 (2004)).

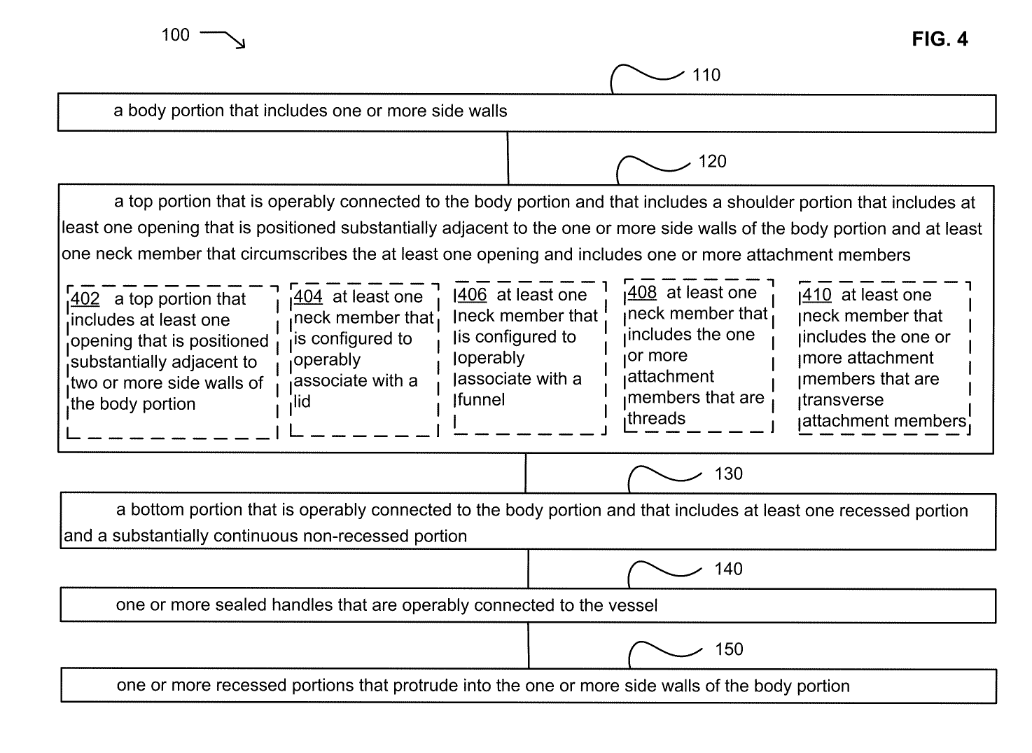

FIG. 4 illustrates example embodiments of a vessel 100. Additional embodiments may include an embodiment 402, an embodiment 404, an embodiment 406, an embodiment 408, and/or an embodiment 410.

Embodiment 402 illustrates a vessel 100 having a top portion that includes at least one opening that is positioned substantially adjacent to two or more side walls of the body portion. In some embodiments, a vessel 100 may include a top portion 120 that includes at least one opening that is positioned substantially adjacent to two or more side walls of the body portion 110. For example, in some embodiments, an opening may be positioned in the top portion 120 of a vessel 100 in a position that is substantially in a corner of the top portion 120 of the vessel 100 that is operably connected to two side walls of the vessel 100.

Embodiment 404 illustrates a vessel 100 having at least one neck member that is configured to operably associate with a lid. In some embodiments, a vessel 100 may include a neck member that is configured to operably associate with a lid. In some embodiments, the neck member is threaded and configured to associate with a threaded lid. In some embodiments, the neck member may include one or more transverse members that are configured to associate with a lid that includes attachment members that are configured to accept the one or more transverse members. Accordingly, a neck member may be configured in numerous ways to associate with a lid.

Embodiment 406 illustrates a vessel 100 having at least one neck member that is configured to operably associate with a funnel. In some embodiments, a vessel 100 may include a neck member that is configured to operably associate with a funnel. In some embodiments, the neck member is threaded and configured to associate with a threaded funnel. In some embodiments, the neck member may include one or more transverse members that are configured to associate with a funnel that includes attachment members that are configured to accept the one or more transverse members. Accordingly, a neck member may be configured in numerous ways to associate with a funnel.

Embodiment 408 illustrates a vessel 100 having at least one neck member that includes the one or more attachment members that are threads. In some embodiments, a vessel 100 may include a neck member that includes the one or more attachment members that are threads. Accordingly, in some embodiments, a vessel 100 may be configured to accept numerous types of similarly threaded items. Examples of such items include, but are not limited to, pouring spouts, lids, funnels, and the like.

Embodiment 410 illustrates a vessel 100 having at least one neck member that includes the one or more attachment members that are transverse attachment members. In some embodiments, a vessel 100 may include a neck member that includes the one or more attachment members that are transverse attachment members. A vessel 100 may include numerous types of transverse attachment members. Transverse attachment members may have numerous configurations. For example, in some embodiments, a transverse attachment member may be shaped as a rod that protrudes in a transverse manner from the neck member of a vessel 100. In some embodiments, a transverse attachment member may be shaped as a bolt that protrudes in a transverse manner from the neck member of a vessel 100. Accordingly, in some embodiments, a vessel 100 may be configured to accept numerous types of items having similar attachment members. Examples of such items include, but are not limited to, pouring spouts, lids, funnels, and the like.

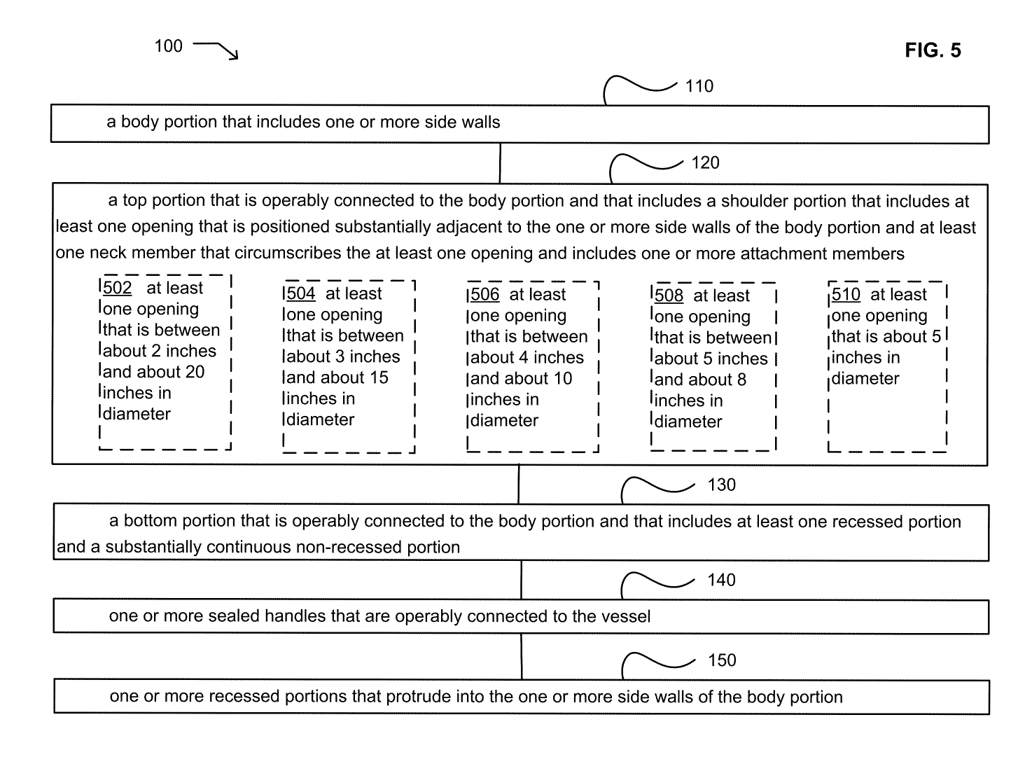

FIG. 5 illustrates example embodiments of a vessel 100. Additional embodiments may include an embodiment 502, an embodiment 504, an embodiment 506, an embodiment 508, and/or an embodiment 510.

Embodiment 502 illustrates a vessel 100 having at least one opening that is between about 2 inches and about 20 inches in diameter. In some embodiments, a vessel 100 may include at least one opening that is between about 2 inches and about 20 inches in diameter.

Embodiment 504 illustrates a vessel 100 having at least one opening that is between about 3 inches and about 15 inches in diameter. In some embodiments, a vessel 100 may include at least one opening that is between about 3 inches and about 15 inches in diameter.

Embodiment 506 illustrates a vessel 100 having at least one opening that is between about 4 inches and about 10 inches in diameter. In some embodiments, a vessel 100 may include at least one opening that is between about 4 inches and about 10 inches in diameter.

Embodiment 508 illustrates a vessel 100 having at least one opening that is between about 5 inches and about 8 inches in diameter. In some embodiments, a vessel 100 may include at least one opening that is between about 5 inches and about 8 inches in diameter.

Embodiment 510 illustrates a vessel 100 having at least one opening that is about 5 inches in diameter. In some embodiments, a vessel 100 may include at least one opening that is about 5 inches in diameter.

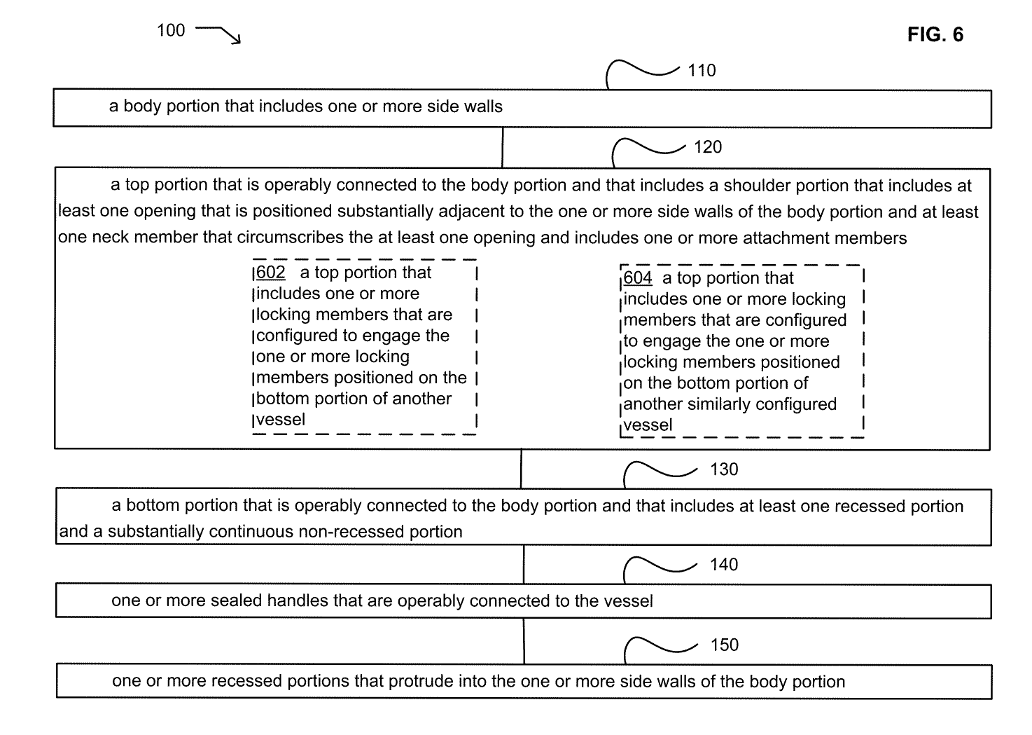

FIG. 6 illustrates example embodiments of a vessel 100. Additional embodiments may include an embodiment 602, and/or an embodiment 604.

Embodiment 602 illustrates a vessel 100 having a top portion that includes one or more locking members that are configured to engage the one or more locking members positioned on the bottom portion of another vessel. In some embodiments, a vessel 100 may include a top portion 120 that includes the one or more locking members that are configured to engage one or more locking members positioned on the bottom portion 130 of another vessel 100. Locking members may be configured in numerous ways. For example, in some embodiments, a top portion 120 of a first vessel 100 may include locking members that are configured in a bolt shape that can insert into a cavity positioned in the bottom portion 130 of another vessel 100. In some embodiments, such locking members may be configured as a dovetail. In some embodiments, such locking members may be configured in a tongue and groove arrangement.

Embodiment 604 illustrates a vessel 100 having a top portion that includes one or more locking members that are configured to engage the one or more locking members positioned on the bottom portion of another similarly configured vessel. In some embodiments, a vessel 100 may include a top portion 120 that includes one or more locking members that are configured to engage the one or more locking members positioned on the bottom portion 130 of another similarly configured vessel 100. Locking members may be configured in numerous ways. For example, in some embodiments, a top portion 120 of a first vessel 100 may include locking members that are configured in a bolt shape that can insert into a cavity positioned in the bottom portion 130 of another vessel 100. In some embodiments, such locking members may be configured as a dovetail. In some embodiments, such locking members may be configured in a tongue and groove arrangement.

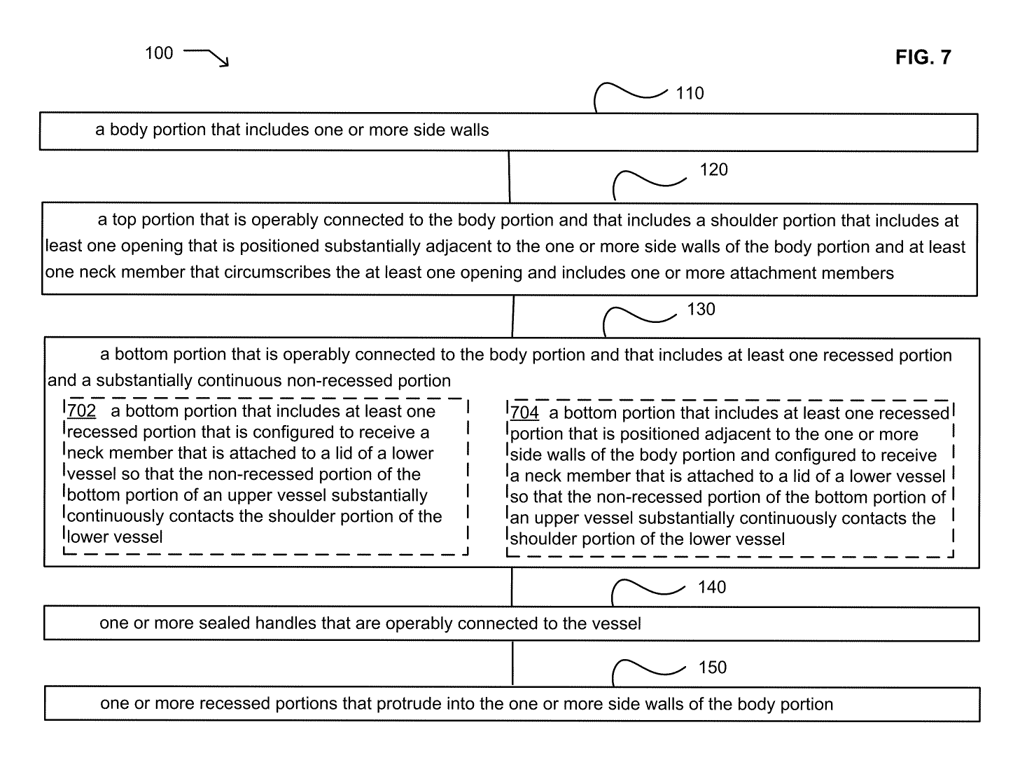

FIG. 7 illustrates example embodiments of a vessel 100. Additional embodiments may include an embodiment 702, and/or an embodiment 704.

Embodiment 702 illustrates a vessel 100 a bottom portion that includes at least one recessed portion that is configured to receive a neck member that is attached to a lid of a lower vessel so that the non-recessed portion of the bottom portion of an upper vessel substantially continuously contacts the shoulder portion of the lower vessel. In some embodiments, a vessel 100 may include a bottom portion 130 that includes at least one recessed portion 150 that is configured to receive a neck member that is attached to a lid of a lower vessel 100 so that the non-recessed portion of the bottom portion 130 of an upper vessel 100 substantially continuously contacts the shoulder portion of the lower vessel 100. In some embodiments, a vessel 100 may include a bottom portion 130 that includes a non-recessed portion that continuously contacts the shoulder portion of another vessel 100 when the vessels 100 are stacked on each other. Accordingly, in some embodiments, the stability of two vessels 100 that are stacked on top of each other is increased due to the substantially continuous contact of the upper vessel 100 with the lower vessel 100.

Embodiment 704 illustrates a vessel 100 having a bottom portion that includes at least one recessed portion that is positioned adjacent to the one or more side walls of the body portion and configured to receive a neck member that is attached to a lid of a lower vessel so that the non-recessed portion of the bottom portion of an upper vessel substantially continuously contacts the shoulder portion of the lower vessel. In some embodiments, a vessel 100 may include a bottom portion 130 that includes at least one recessed portion that is positioned adjacent to the one or more side walls of the body portion 100 and configured to receive a neck member that is attached to a lid of a lower vessel 100 so that the non-recessed portion of the bottom portion 130 of an upper vessel 100 substantially continuously contacts the shoulder portion of the lower vessel 100. In some embodiments, a vessel 100 may include a bottom portion 130 that includes a non-recessed portion that continuously contacts the shoulder portion of another vessel 100 when the vessels 100 are stacked on each other. Accordingly, in some embodiments, the stability of two vessels 100 that are stacked on top of each other is increased due to the substantially continuous contact of the upper vessel 100 with the lower vessel 100.

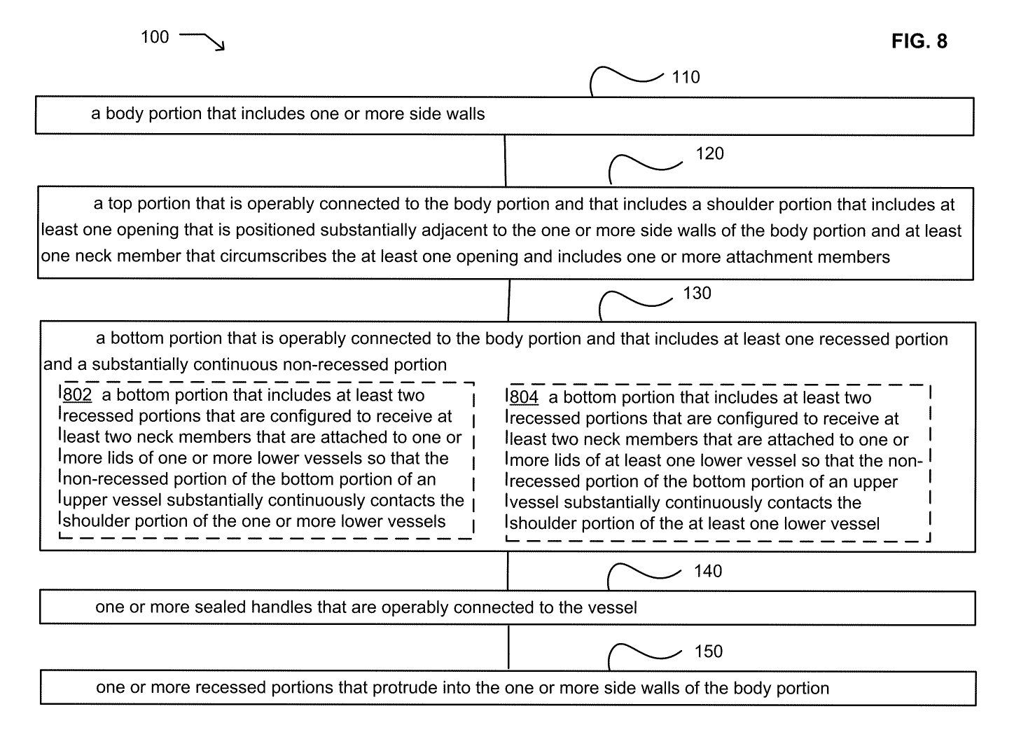

FIG. 8 illustrates example embodiments of a vessel 100. Additional embodiments may include an embodiment 802, and/or an embodiment 804.

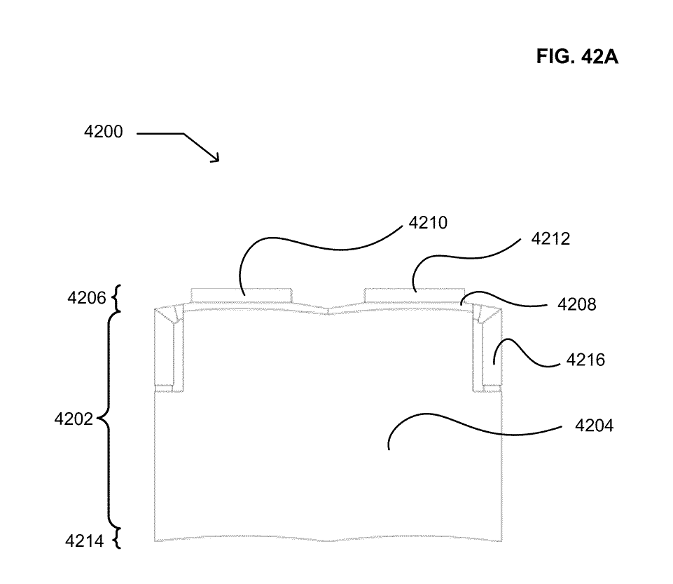

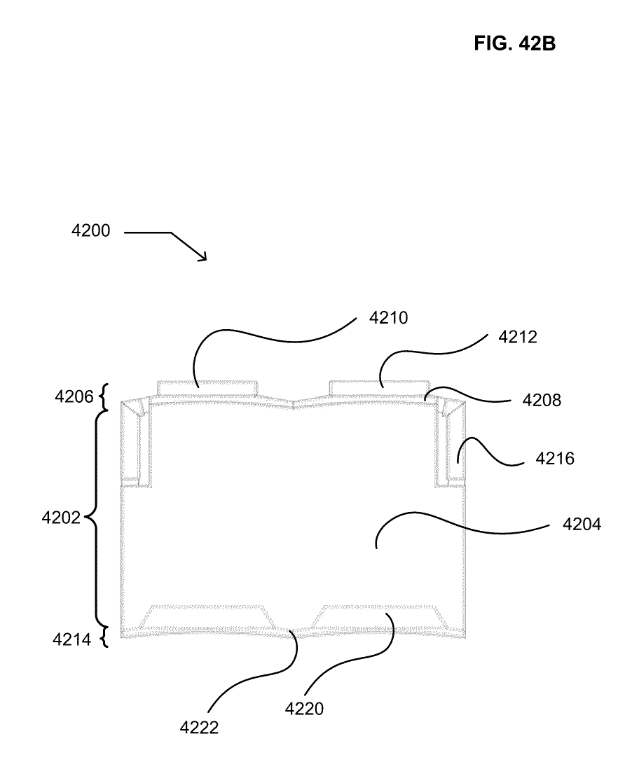

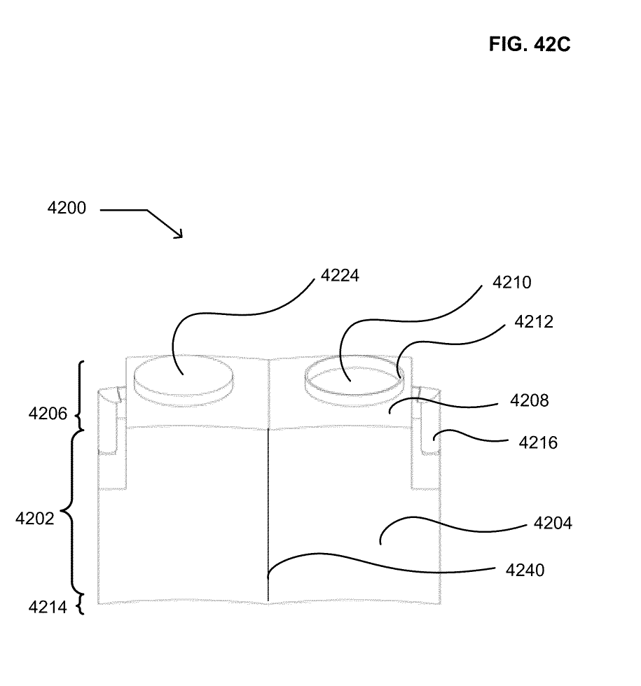

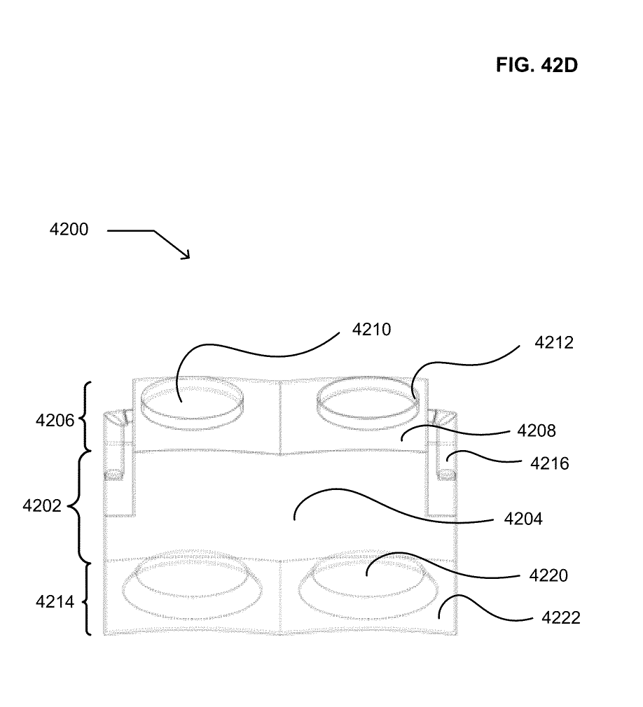

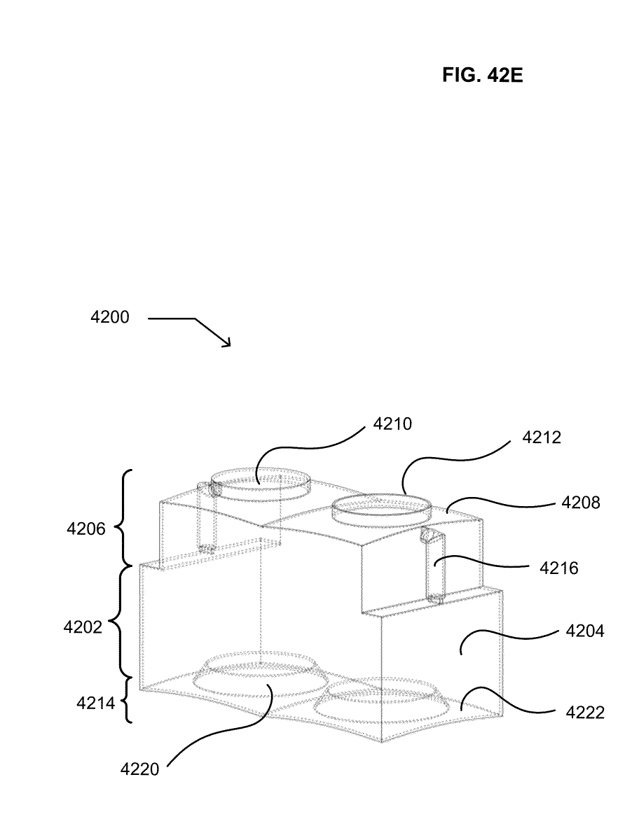

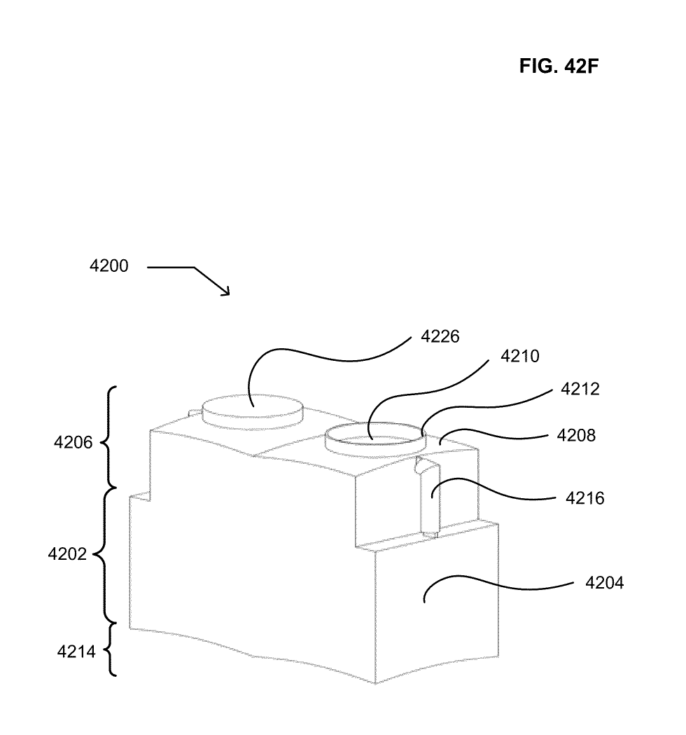

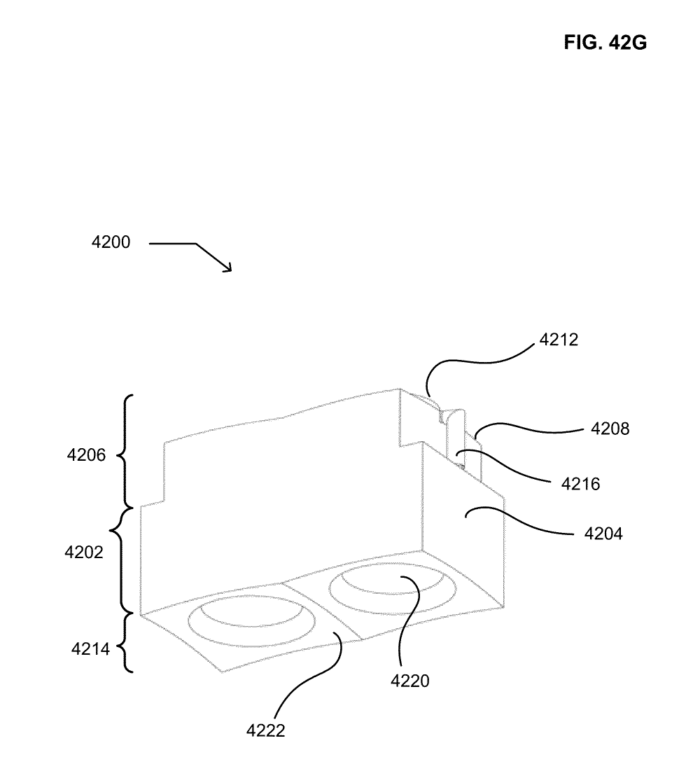

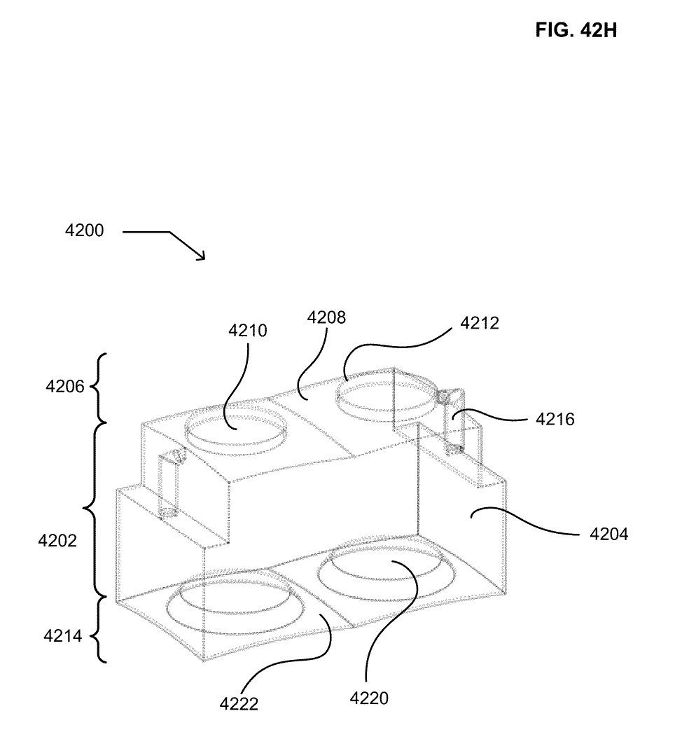

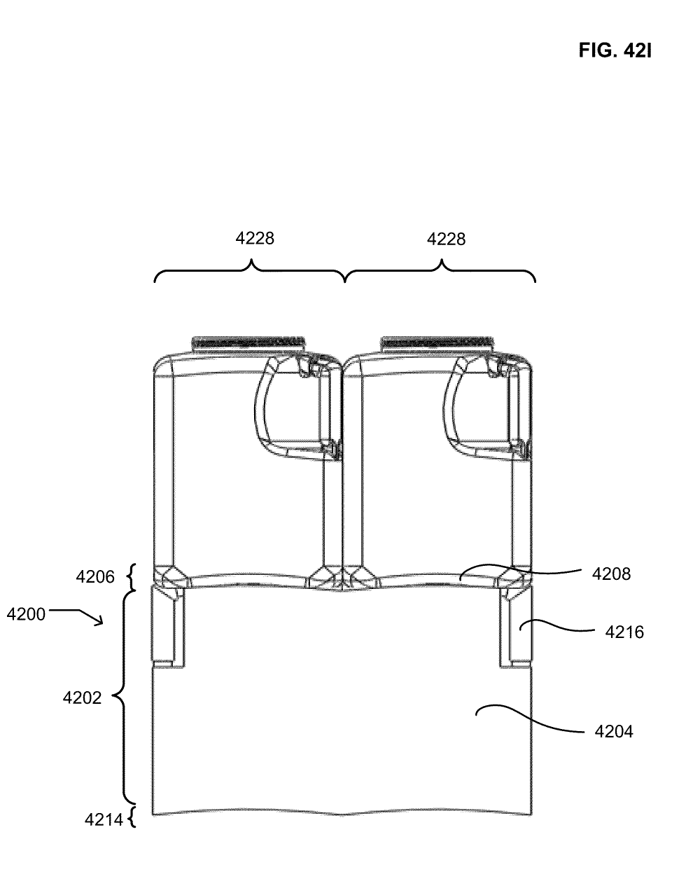

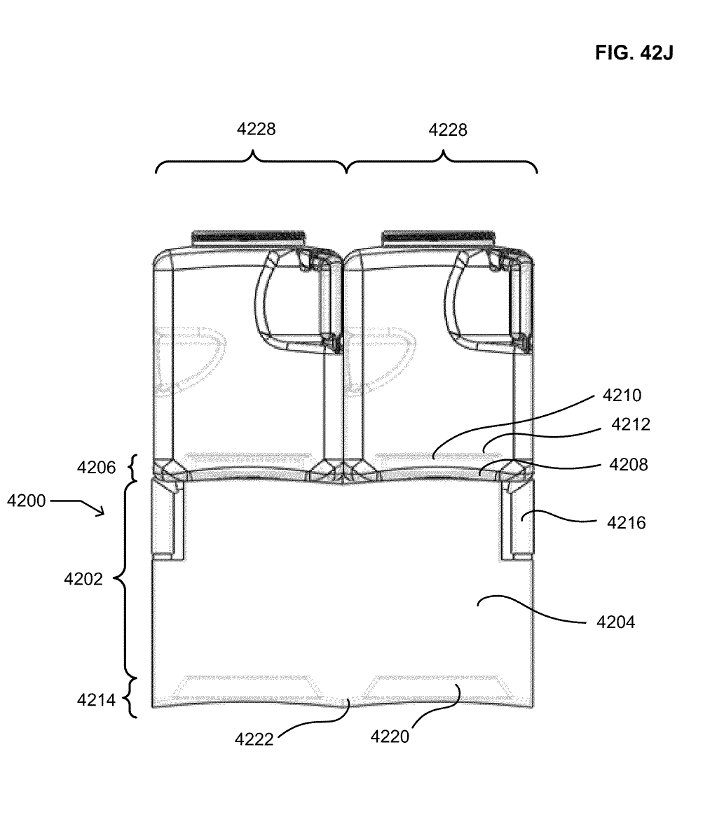

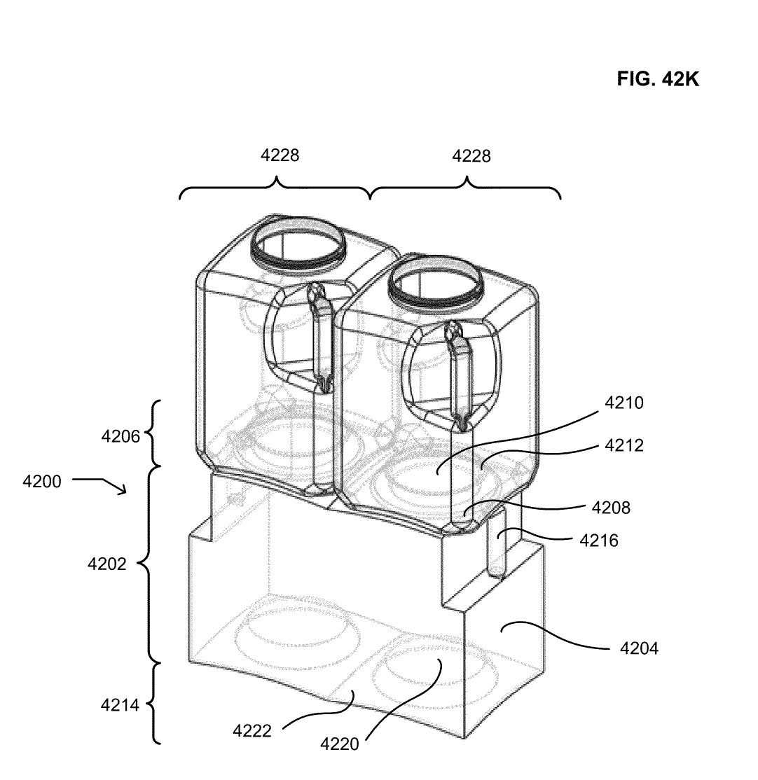

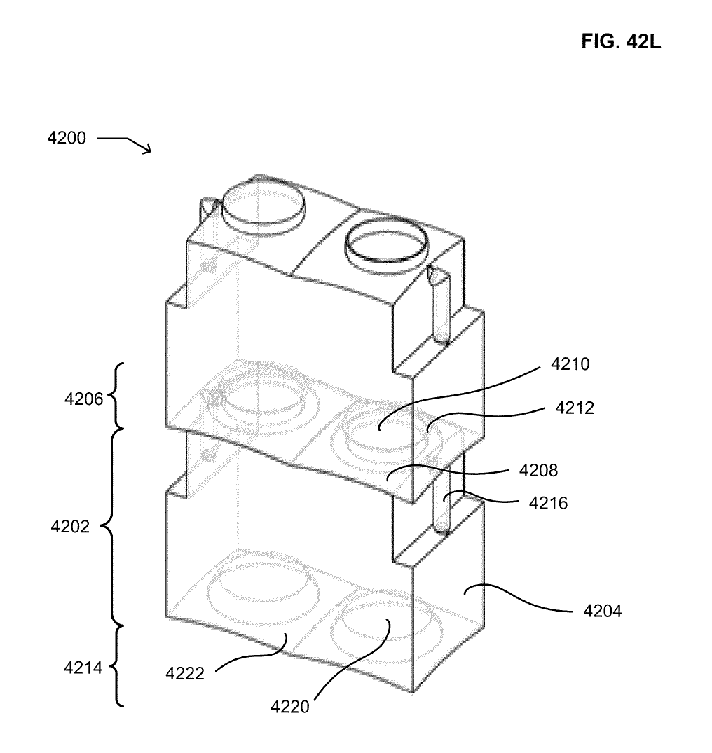

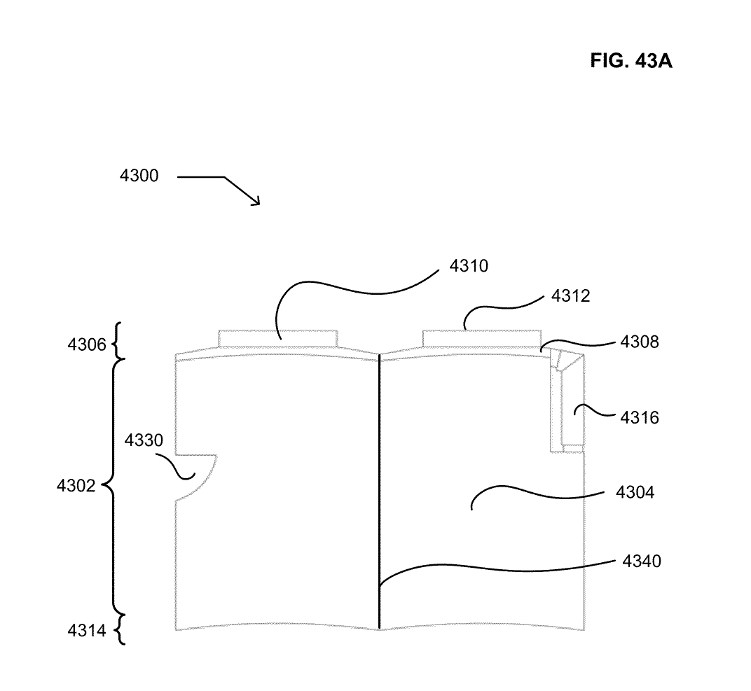

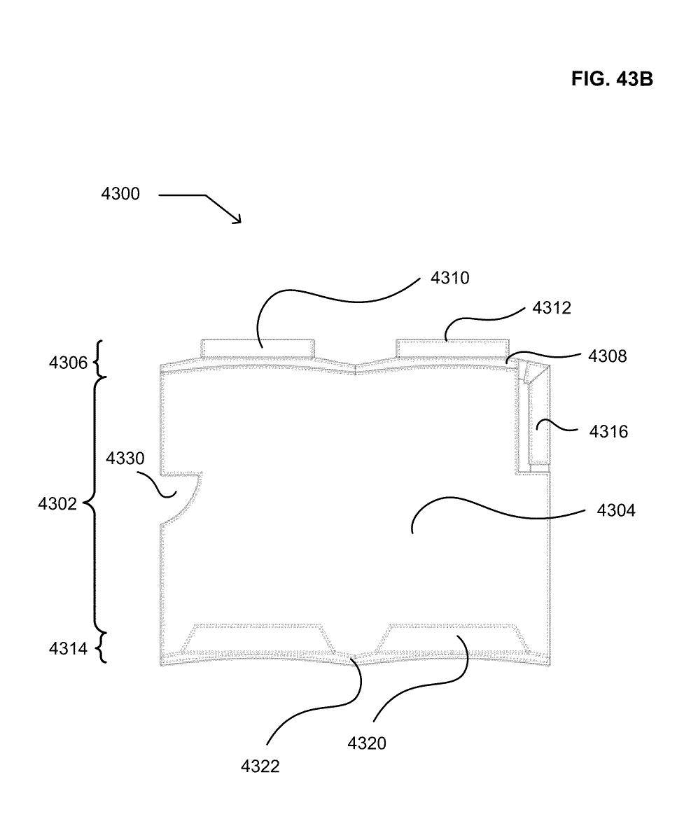

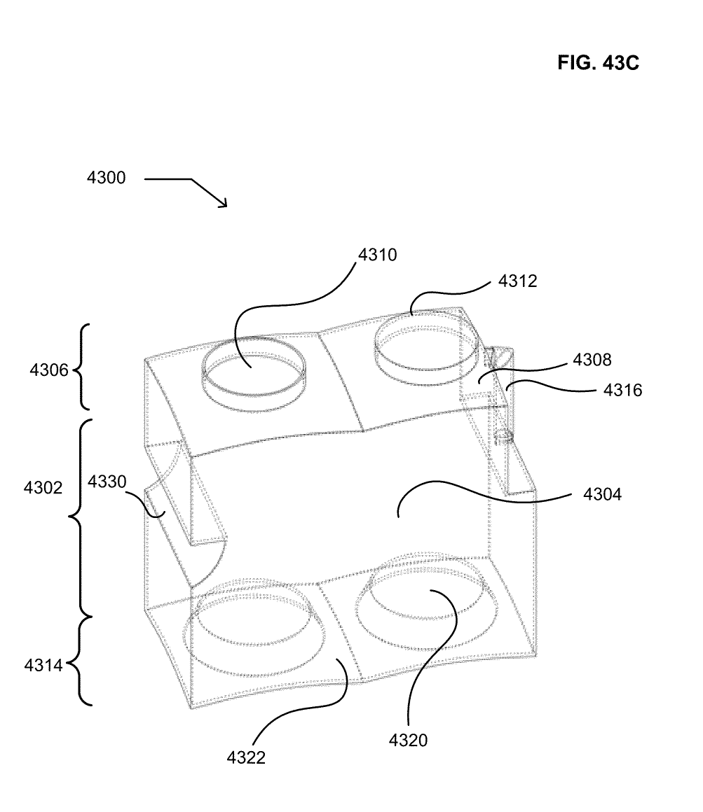

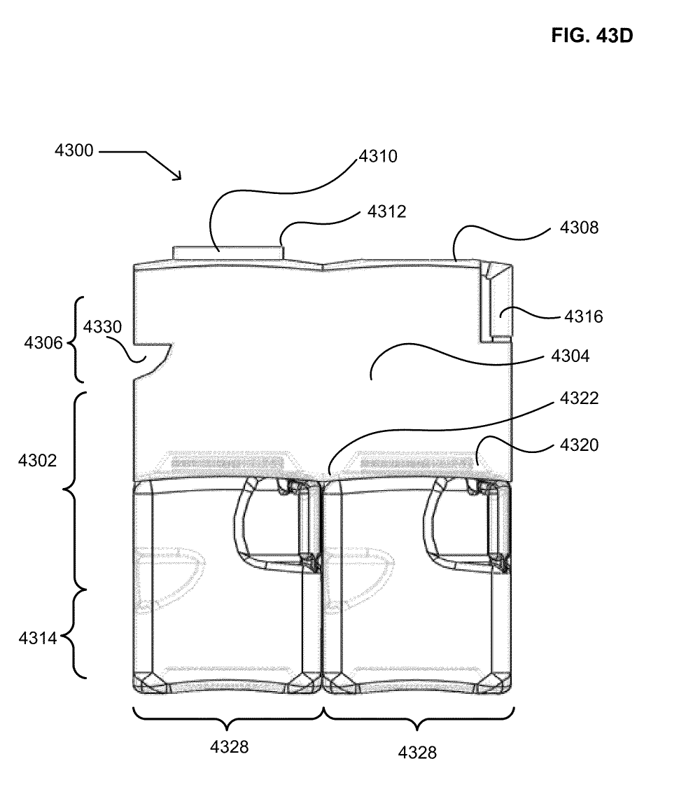

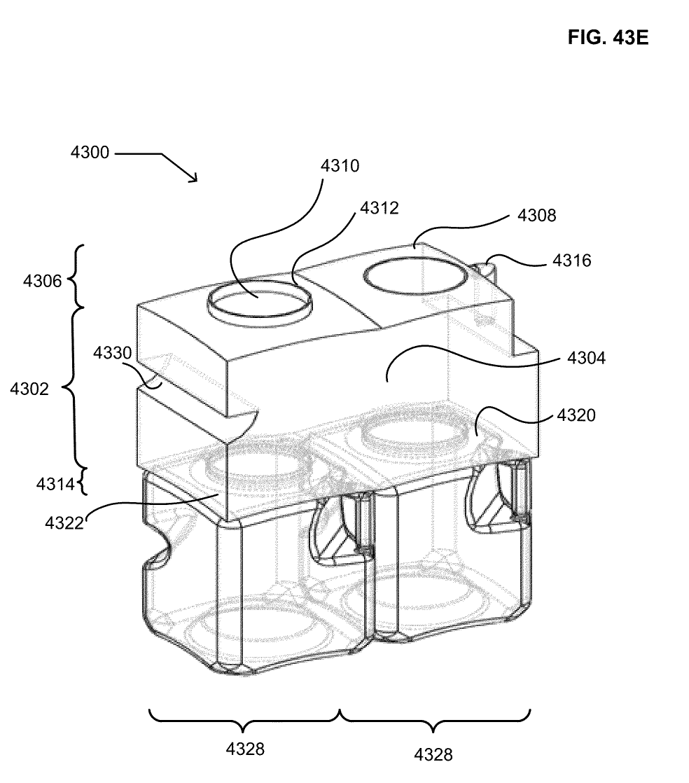

Embodiment 802 illustrates a vessel 100 a bottom portion that includes at least two recessed portions that are configured to receive at least two neck members that are attached to one or more lids of one or more lower vessels so that the non-recessed portion of the bottom portion of an upper vessel substantially continuously contacts the shoulder portion of the one or more lower vessels. In some embodiments, a vessel 100 may include a bottom portion that includes at least two recessed portions that are configured to receive at least two neck members that are attached to one or more lids of one or more lower vessels so that the non-recessed portion of the bottom portion of an upper vessel 100 substantially continuously contacts the shoulder portion of the one or more lower vessels 100. In some embodiments, a vessel 100 may include two recessed portions in the bottom portion of the vessel 100 that are spaced to accept two neck members that are each attached to a lid and included on a single lower vessel 100. In some embodiments, a vessel 100 may include two recessed portions in the bottom portion of the vessel 100 that are spaced to accept at least one neck member that is attached to a lid and included on a single lower vessel 100. In some embodiments, a vessel 100 may include two recessed portions in the bottom portion of the vessel 100 that are spaced to accept two neck members that are each attached to a lid and that are each included on two separate vessels. Accordingly, in some embodiments, a vessel 100 may include a bottom portion that includes at least two recessed portions that allow the vessel to be stacked on top of a single vessel or on top of two vessels (e.g., see FIGS. 42J-42L and 43D-43E). In some embodiments, a first vessel 100 may include two recessed portions in the bottom portion of the first vessel 100 that are spaced to accept one protrusion and one neck member that is attached to a lid of a second vessel.

Embodiment 804 illustrates a vessel 100 having a bottom portion that includes at least two recessed portions that are configured to receive at least two neck members that are attached to one or more lids of at least one lower vessel so that the non-recessed portion of the bottom portion of an upper vessel substantially continuously contacts the shoulder portion of the at least one lower vessel. In some embodiments, a vessel 100 may include a bottom portion that includes at least two recessed portions that are configured to receive at least two neck members that are attached to one or more lids of at least one lower vessel so that the non-recessed portion of the bottom portion of an upper vessel substantially continuously contacts the shoulder portion of the at least one lower vessel 100. In some embodiments, a vessel 100 may include two recessed portions in the bottom portion of the vessel 100 that are spaced to accept two neck members that are each attached to a lid and included on a single lower vessel. In some embodiments, a vessel 100 may include two recessed portions in the bottom portion of the vessel that are spaced to accept at least one neck member that is attached to a lid and included on a single lower vessel. In some embodiments, a vessel 100 may include two recessed portions in the bottom portion of the vessel 100 that are spaced to accept two neck members that are each attached to a lid and that are each included on two separate vessels. Accordingly, in some embodiments, a vessel 100 may include a bottom portion that includes at least two recessed portions that allow the vessel 100 to be stacked on top of a single vessel or on top of two vessels (e.g., see FIG. 42J-42L and 43D-43E). In some embodiments, a first vessel 100 may include two recessed portions 150 in the bottom portion of the first vessel 100 that are spaced to accept one protrusion and one neck member that is attached to a lid of a second vessel.

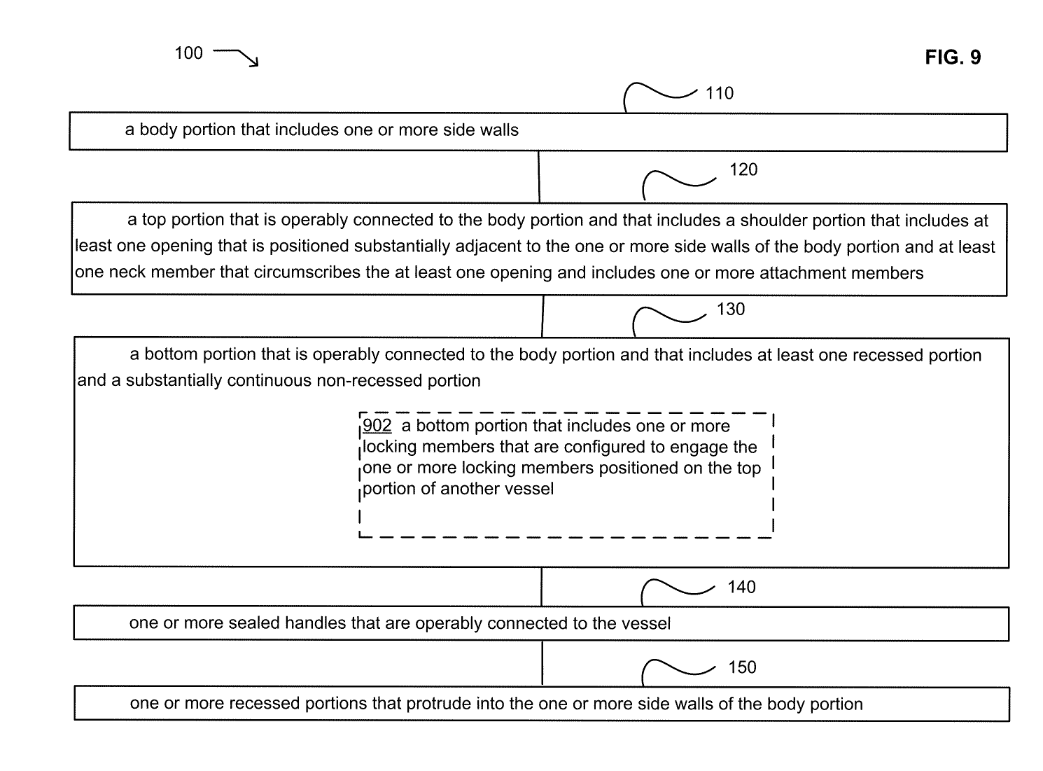

FIG. 9 illustrates example embodiments of a vessel 100. Additional embodiments may include an embodiment 902.

Embodiment 902 illustrates a vessel 100 having a bottom portion that includes one or more locking members that are configured to engage the one or more locking members positioned on the top portion of another vessel. In some embodiments, a vessel 100 may include a bottom portion that includes one or more locking members that are configured to engage the one or more locking members positioned on the top portion of another vessel 100. A vessel 100 may include numerous types of locking members. Examples of such locking members include, but are not limited to, tongue and groove locking members, dovetail locking members, nut and bolt type locking members, and the like.

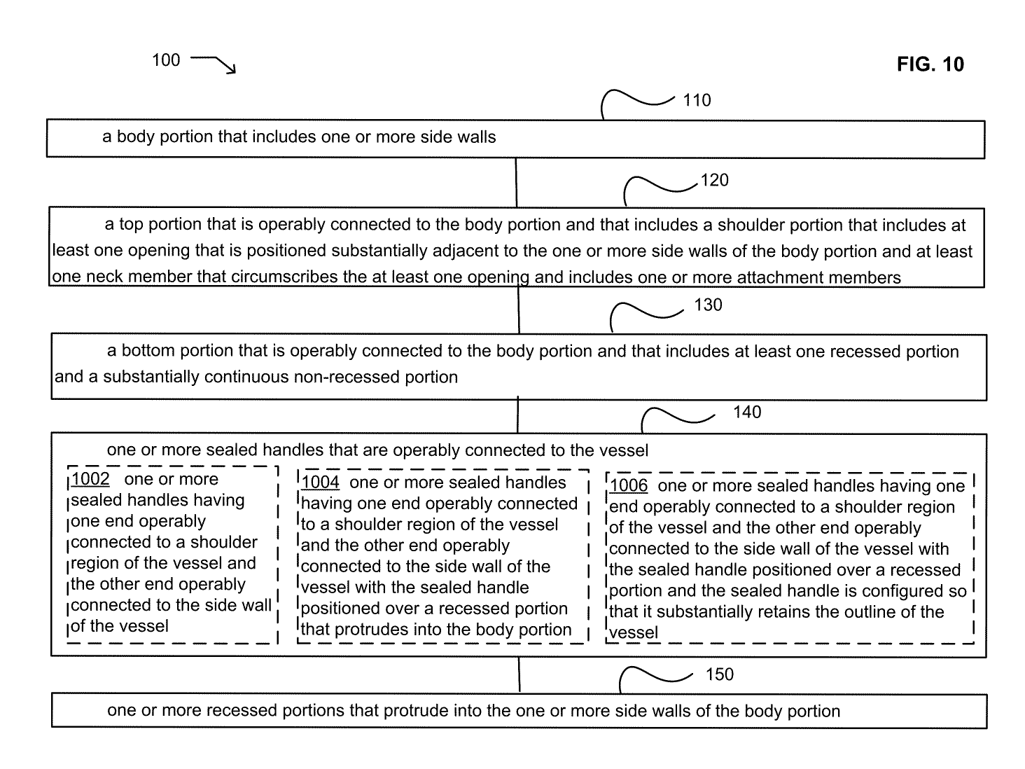

FIG. 10 illustrates example embodiments of a vessel 100. Additional embodiments may include an embodiment 1002, an embodiment 1004, and/or an embodiment 1006.

Embodiment 1002 illustrates a vessel 100 having one or more sealed handles having one end operably connected to a shoulder region of the vessel and the other end operably connected to the side wall of the vessel. In some embodiments, a vessel 100 may include one or more sealed handles 140 having one end operably connected to a shoulder region of the vessel 100 and the other end operably connected to the side wall of the vessel 100. In some embodiments, a vessel 100 may include one or more sealed handles 140 having one end operably connected to the shoulder region of the vessel 100 and the other end operably connected to the side wall of the vessel 100 with the handle protruding out from the outline of the vessel 100. In some embodiments, a vessel 100 may include one or more sealed handles 140 having one end operably connected to the shoulder region of the vessel 100 and the other end operably connected to the side wall of the vessel 100 with the handle being positioned over a recessed portion 150 of the vessel 100. In some embodiments, a vessel 100 may include one or more sealed handles 140 having one end operably connected to the shoulder region of the vessel 100 and the other end operably connected to the side wall of the vessel 100 with the handle being positioned over a recessed portion 150 of the vessel 100 and the handle preserving the outline of the vessel 100. In some embodiments, a vessel 100 may include one or more sealed handles 140 having one end operably connected to the shoulder region of the vessel 100 and the other end operably connected to the side wall of the vessel 100 with both ends of the handle being connected to a corner of the vessel 100.

Embodiment 1004 illustrates a vessel 100 having one or more sealed handles having one end operably connected to a shoulder region of the vessel and the other end operably connected to the side wall of the vessel with the sealed handle positioned over a recessed portion that protrudes into the body portion. In some embodiments, a vessel 100 may include one or more sealed handles 140 having one end operably connected to a shoulder region of the vessel 100 and the other end operably connected to the side wall of the vessel 100 with the sealed handle positioned over a recessed portion 150 that protrudes into the body portion 110. In some embodiments, a vessel 100 may include one or more sealed handles 140 having one end operably connected to the shoulder region of the vessel 100 and the other end operably connected to the side wall of the vessel 100 with the handle protruding out from the outline of the vessel 100. In some embodiments, a vessel 100 may include one or more sealed handles 140 having one end operably connected to the shoulder region of the vessel 100 and the other end operably connected to the side wall of the vessel 100 with the handle being positioned over a recessed portion 150 of the vessel 100 and the handle preserving the outline of the vessel 100. In some embodiments, a vessel 100 may include one or more sealed handles 140 having one end operably connected to the shoulder region of the vessel 100 and the other end operably connected to the side wall of the vessel 100 with both ends of the handle being connected to a corner of the vessel 100.

Embodiment 1006 illustrates a vessel 100 one or more sealed handles having one end operably connected to a shoulder region of the vessel and the other end operably connected to the side wall of the vessel with the sealed handle positioned over a recessed portion and the sealed handle is configured so that it substantially retains the outline of the vessel. In some embodiments, a vessel 100 may include one or more sealed handles 140 having one end operably connected to a shoulder region of the vessel 100 and the other end operably connected to the side wall of the vessel 100 with the sealed handle positioned over a recessed portion 150 and the sealed handle is configured so that it substantially retains the outline of the vessel 100. In some embodiments, a vessel 100 may include one or more sealed handles 140 having one end operably connected to the shoulder region of the vessel 100 and the other end operably connected to the side wall of the vessel 100 with both ends of the handle being connected to a corner of the vessel 100.

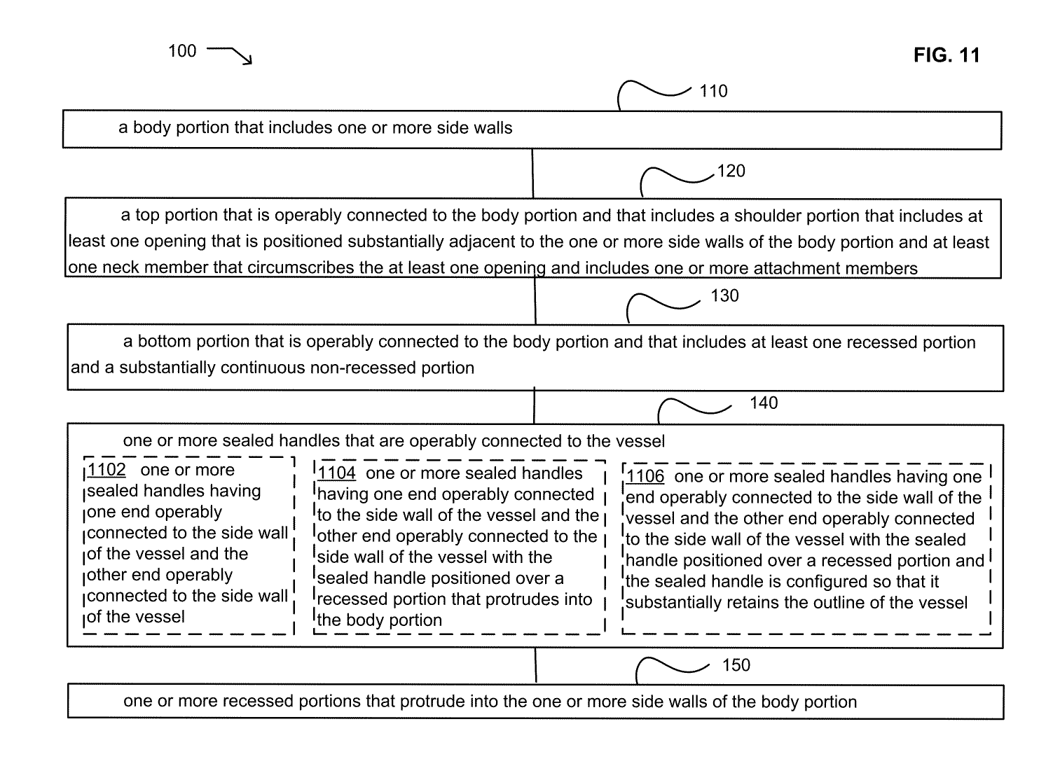

FIG. 11 illustrates example embodiments of a vessel 100. Additional embodiments may include an embodiment 1102, an embodiment 1104, and/or an embodiment 1106.

Embodiment 1102 illustrates a vessel 100 having one or more sealed handles having one end operably connected to the side wall of the vessel and the other end operably connected to the side wall of the vessel. In some embodiments, a vessel 100 may include one or more sealed handles having one end operably connected to the side wall of the vessel and the other end operably connected to the side wall of the vessel. In some embodiments, one or more sealed handles may protrude out from the side of a vessel and therefore do not retain the outline of the vessel. In some embodiments, one or more sealed handles may be positioned over one or more recessed portions that protrude into the side of a vessel. In some embodiments, one or more sealed handles may be positioned over one or more recessed portions that protrude into the side of a vessel and the handles may be configured so that the outline of the vessel is substantially retained.

Embodiment 1104 illustrates a vessel 100 having one or more sealed handles having one end operably connected to the side wall of the vessel and the other end operably connected to the side wall of the vessel with the sealed handle positioned over a recessed portion that protrudes into the body portion. In some embodiments, a vessel 100 may include one or more sealed handles 140 having one end operably connected to the side wall of the vessel 100 and the other end operably connected to the side wall of the vessel 100 with the sealed handle 140 positioned over a recessed portion 150 that protrudes into the body portion 110. In some embodiments, a vessel 100 may include one or more handles 140 that are connected to a corner of the vessel 100. In some embodiments, a vessel 100 may include one or more handles 140 that are connected to a non-corner of the vessel 100.

Embodiment 1106 illustrates a vessel 100 having one or more sealed handles having one end operably connected to the side wall of the vessel and the other end operably connected to the side wall of the vessel with the sealed handle positioned over a recessed portion and the sealed handle is configured so that it substantially retains the outline of the vessel. In some embodiments, a vessel 100 may include one or more sealed handles 140 having one end operably connected to the side wall of the vessel 100 and the other end operably connected to the side wall of the vessel 100 with the sealed handle positioned over a recessed portion 150 and the sealed handle is configured so that it substantially retains the outline of the vessel 100. In some embodiments, a vessel 100 may include one or more handles 140 that are connected to a corner of the vessel 100. In some embodiments, a vessel 100 may include one or more handles 140 that are connected to a non-corner of the vessel 100.

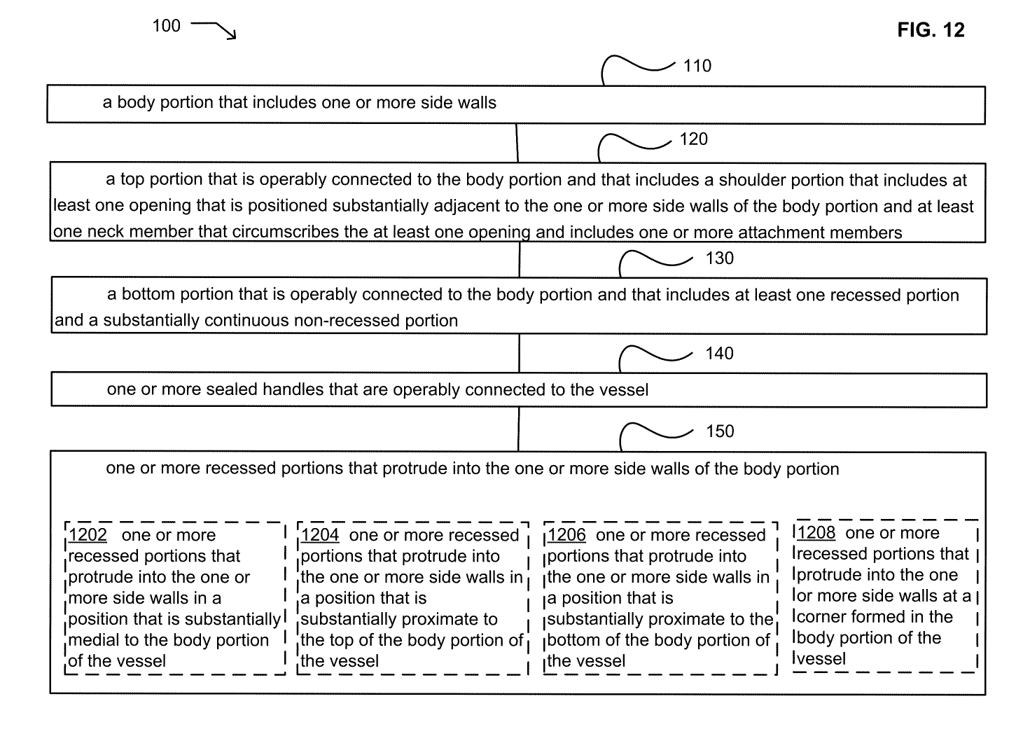

FIG. 12 illustrates example embodiments of a vessel 100. Additional embodiments may include an embodiment 1202, embodiment 1204, embodiment 1206, and/or an embodiment 1208.

Embodiment 1202 illustrates a vessel 100 having one or more recessed portions that protrude into the one or more side walls in a position that is substantially medial to the body portion of the vessel. In some embodiments, a vessel 100 may include one or more recessed portions 150 that protrude into the one or more side walls in a position that is substantially medial to the body portion 110 of the vessel 100. In some embodiments, a vessel 100 may include one or more recessed portions 150 that protrude into the one or more side walls in a position that is substantially opposite to the position of one or more sealed handles 140. In some embodiments, a vessel 100 may include one or more recessed portions 150 that protrude into the one or more side walls to create a grasping structure. In some embodiments, a vessel 100 may include one or more recessed portions 150 that protrude into the one or more side walls to create a grasping structure that a worker can use to assist in lifting the vessel 100. In some embodiments, a vessel 100 may include one or more recessed portions 150 that protrude into the one or more side walls to create a recessed portion 150 with a vertical overhang.

Embodiment 1204 illustrates a vessel 100 having one or more recessed portions that protrude into the one or more side walls in a position that is substantially proximate to the top of the body portion of the vessel. In some embodiments, a vessel 100 may include one or more recessed portions 150 that protrude into the one or more side walls in a position that is substantially proximate to the top of the body portion 110 of the vessel 100. In some embodiments, a vessel 100 may include one or more recessed portions 150 that protrude into the one or more side walls in a position that is substantially opposite to the position of one or more sealed handles 140. In some embodiments, a vessel 100 may include one or more recessed portions 150 that protrude into the one or more side walls to create a grasping structure. In some embodiments, a vessel 100 may include one or more recessed portions 150 that protrude into the one or more side walls to create a grasping structure that a worker can use to assist in lifting the vessel 100. In some embodiments, a vessel 100 may include one or more recessed portions 150 that protrude into the one or more side walls to create a recessed portion 150 with a vertical overhang.

Embodiment 1206 illustrates a vessel 100 having one or more recessed portions that protrude into the one or more side walls in a position that is substantially proximate to the bottom of the body portion of the vessel. In some embodiments, a vessel 100 may include one or more recessed portions 150 that protrude into the one or more side walls in a position that is substantially proximate to the bottom of the body portion 110 of the vessel 100. In some embodiments, a vessel 100 may include one or more recessed portions 150 that protrude into the one or more side walls in a position that is substantially opposite to the position of one or more sealed handles 140. In some embodiments, a vessel 100 may include one or more recessed portions 150 that protrude into the one or more side walls to create a grasping structure. In some embodiments, a vessel 100 may include one or more recessed portions 150 that protrude into the one or more side walls to create a grasping structure that a worker can use to assist in lifting the vessel 100. In some embodiments, a vessel 100 may include one or more recessed portions 150 that protrude into the one or more side walls to create a recessed portion 150 with a vertical overhang.

Embodiment 1208 illustrates a vessel 100 having one or more recessed portions that protrude into the one or more side walls at a corner formed in the body portion of the vessel. In some embodiments, a vessel 100 may include one or more recessed portions 150 that protrude into the one or more side walls at a corner formed in the body portion of the vessel 100. In some embodiments, one or more recessed portions may be positioned adjacent to one or more sealed handles. In some embodiments, one or more recessed portions may be configured to serve as a grasping point for a worker to grasp the vessel.

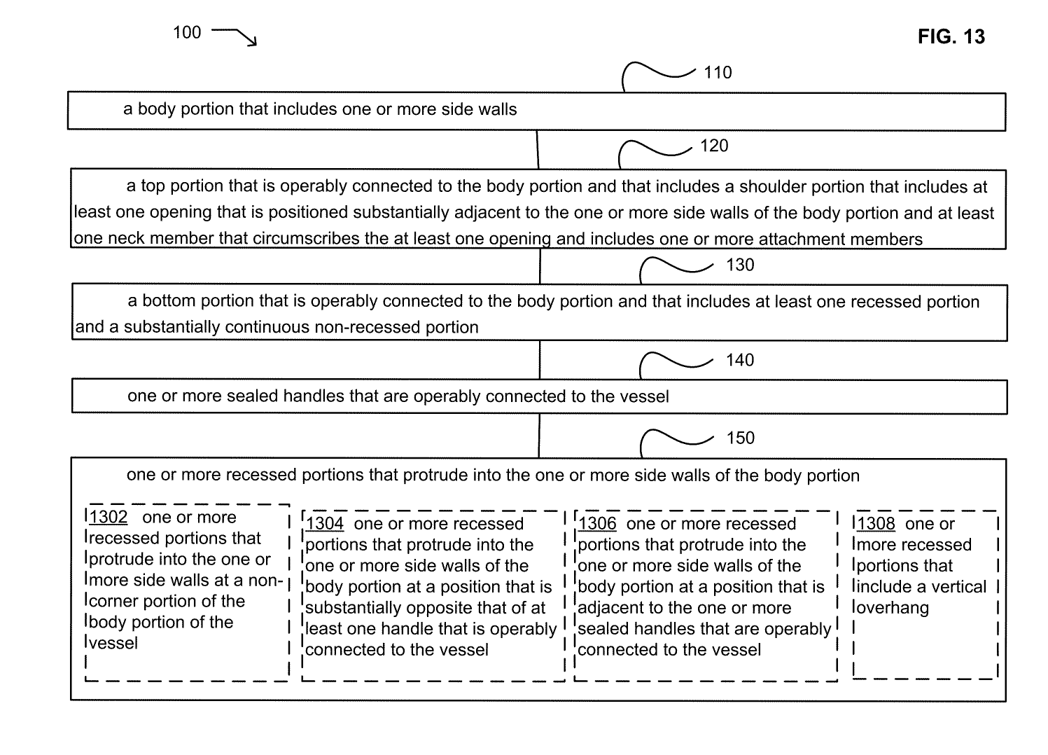

FIG. 13 illustrates example embodiments of a vessel 100. Additional embodiments may include an embodiment 1302, embodiment 1304, embodiment 1306, and/or an embodiment 1308.

Embodiment 1302 illustrates a vessel 100 having one or more recessed portions that protrude into the one or more side walls at a non-corner portion of the body portion of the vessel. In some embodiments, a vessel 100 may include one or more recessed portions 150 that protrude into the one or more side walls at a non-corner portion of the body portion 110 of the vessel 100. In some embodiments, a vessel 100 may include one or more recessed portions 150 that protrude into the one or more side walls in a position that is substantially opposite to the position of one or more sealed handles 140. In some embodiments, a vessel 100 may include one or more recessed portions 150 that protrude into the one or more side walls to create a grasping structure. In some embodiments, a vessel 100 may include one or more recessed portions 150 that protrude into the one or more side walls to create a grasping structure that a worker can use to assist in lifting the vessel 100. In some embodiments, a vessel 100 may include one or more recessed portions 150 that protrude into the one or more side walls to create a recessed portion 150 with a vertical overhang.

Embodiment 1304 illustrates a vessel 100 having one or more recessed portions that protrude into the one or more side walls of the body portion at a position that is substantially opposite that of at least one handle that is operably connected to the vessel. In some embodiments, a vessel 100 may include one or more recessed portions 150 that protrude into the one or more side walls of the body portion 110 at a position that is substantially opposite that of at least one handle that is operably connected to the vessel 100. In some embodiments, a vessel 100 may include one or more recessed portions 150 that protrude into the one or more side walls to create a grasping structure. In some embodiments, a vessel 100 may include one or more recessed portions 150 that protrude into the one or more side walls to create a grasping structure that a worker can use to assist in lifting the vessel 100. In some embodiments, a vessel 100 may include one or more recessed portions 150 that protrude into the one or more side walls to create a recessed portion 150 with a vertical overhang.

Embodiment 1306 illustrates a vessel 100 one or more recessed portions that protrude into the one or more side walls of the body portion at a position that is adjacent to the one or more sealed handles that are operably connected to the vessel. In some embodiments, a vessel 100 may include one or more recessed portions 150 that protrude into the one or more side walls of the body portion 110 at a position that is adjacent to the one or more sealed handles 140 that are operably connected to the vessel 100. Accordingly, in some embodiments, a recessed portion 150 may be positioned in a position on the vessel 100 that is interior to the handle to allow the fingers of a person grasping the handle to occupy a recessed portion.

Embodiment 1308 illustrates a vessel 100 having one or more recessed portions that include a vertical overhang. In some embodiments, a vessel 100 may include one or more recessed portions 150 that include a vertical overhang. Accordingly, in some embodiments, a recessed portion 150 may be configured to have a vertical overhang that allows the recessed portion 150 to be used by a worker to grasp the vessel 100.

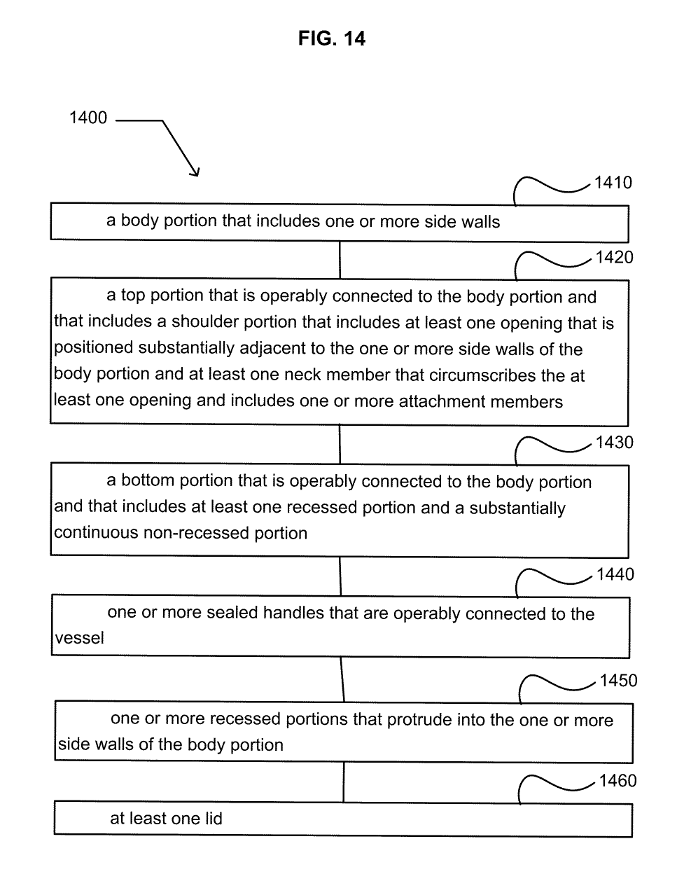

FIG. 14 and the following figures illustrate various embodiments of vessels 1400, discussion and explanation with respect to the above-described embodiment of FIG. 1 with the addition of a lid 1460, and/or with respect to other alternative embodiments and contexts. However, it should be understood that a vessel 1400 may have numerous configurations and/or be a modified version of FIGS. 1 and/or 14. Also, although various embodiments are presented in the figures, it should be understood that a vessel 1400 may have a configuration that is other than those which are illustrated.

FIG. 14 illustrates an example vessel 1400 in which embodiments may be implemented. A vessel 1400 includes a body portion 1410. In some embodiments, the body portion 1410 may be formed from a single side wall. In some embodiments, the body portion 1410 may be formed from two or more side walls. For example, in some embodiments, a vessel 1400 may include two or more side walls that include an air space between the two or more side walls. In some embodiments, a vessel 1400 may include two or more side walls that include insulation between the two or more side walls. In some embodiments, a vessel 1400 may include two or more side walls that include a vacuum between the two or more side walls. In some embodiments, a vessel 1400 may include two or more side walls that include a phase change material between the two or more side walls.

A vessel 1400 includes a top portion 1420 that is operably connected to the body portion 1410. The top portion 1420 includes a shoulder portion that includes an opening and a neck member that circumscribes the opening. In some embodiments, a vessel 1400 may include at least one opening that is positioned substantially adjacent to one or more side walls of the body portion 1410 of the vessel 1400. The opening may be constructed to have numerous sizes. For example, in some embodiments, the size of the opening may be great enough to allow a person to insert their hand through the opening to access the interior of the vessel 1400. In some embodiments, the neck member may optionally include one or more attachment members. The neck member may optionally include numerous types of attachment members. Examples, of such attachment members include, but are not limited to, threads, lugs, compression fittings, ridges, and the like.

A vessel 1400 includes a bottom portion 1430 that is operably connected to the body portion 1410. The bottom portion 1430 includes a bottom portion 1430 that is operably connected to the body portion 1410 and that includes at least one recessed portion and a substantially continuous non-recessed portion. In some embodiments, the recessed portion is configured to accept the neck portion of another vessel 1400. In some embodiments, the recessed portion is configured to accept a neck portion that is attached to a lid of another vessel 1400. Accordingly, in some embodiments, a top vessel 1400 may be stacked on top of a lower vessel 1400 with the neck and lid of the lower vessel 1400 being accepted into the recessed portion of the top vessel 1400. In some embodiments, a vessel 1400 may include a substantially continuous non-recessed portion. The substantially continuously non-recessed portion may circumscribe the recessed portion of the bottom portion 1430 of the vessel 1400. Accordingly, in some embodiments, a top vessel 1400 may be stacked on top of a lower vessel 1400 such that the neck and attached lid of the lower vessel 1400 is accepted into the recessed portion in the bottom portion 1430 of the top vessel 1400 and the substantially continuous non-recessed portion of the top vessel 1400 substantially continuously rests on the shoulder portion of the lower vessel 1400.

A vessel 1400 includes one or more sealed handles 1440 that are operably coupled to the vessel 1400. The sealed handles 1440 are sealed on both ends of the handle such that the interior of the handle is isolated from the interior portion of the body of the vessel 1400. Accordingly, in some embodiments, fluid is unable to flow from the interior of the body of the vessel 1400 into a handle that is coupled to the vessel 1400. In some embodiments, a handle is attached to the vessel 1400 with one end of the handle being coupled to the shoulder of the top portion 1420 of the vessel 1400 and the other end being coupled to a side wall of the vessel 1400. In some embodiments, a handle is attached to the vessel 1400 with one end of the handle being coupled to the side wall of the vessel 1400 and the other end being coupled to a side wall of the vessel 1400. In some embodiments, a handle may extend beyond the outline of the body portion 1410 of a vessel 1400 to which it is attached. In some embodiments, a handle may not extend beyond the outline of the body portion 1410 of a vessel 1400 to which it is attached. Accordingly, in some embodiments, a handle may be attached to a vessel 1400 such that the overall outline of the vessel 1400 is maintained.

A vessel 1400 includes one or more recessed portions 1450 that protrude into the one or more side walls of the body portion 1410. In some embodiments, a recessed portion 1450 may protrude into a side wall of the vessel 1400 at a position that is adjacent a handle such that the handle may be grasped and the fingers of the grasping hand will be positioned adjacent the recessed portion. In some embodiments, a recessed portion 1450 may protrude into a side wall of the vessel 1400 at a position on the vessel 1400 that is opposite the position of a handle that is attached to the vessel 1400. In some embodiments, a recessed portion 1450 may protrude into a side wall of a vessel 1400 at a position on the vessel 1400 that is opposite that of an attached handle so that the recessed portion 1450 serves as a handle for lifting the vessel 1400. For example, in some embodiments, a worker may grasp a handle that is attached to a vessel 1400 with one hand and grasp a recessed portion 1450 that protrudes into a side wall of the vessel 1400 on the opposite side of the handle with the other hand. Recessed portions 1450 may protrude into the side wall of a vessel 1400 in numerous places relative to the vessel 1400. For example, in some embodiments, a recessed portion 1450 may protrude into the vessel 1400 at a position that is in the middle of the vessel 1400 relative to the vertical axis of the vessel 1400. In some embodiments, a recessed portion 1450 may protrude into the vessel 1400 at a position that is near the bottom portion 1430 of the vessel 1400. In some embodiments, a recessed portion 1450 may protrude into the vessel 1400 at a position that is near the top portion 1420 of the vessel 1400.

In some embodiments, a vessel 1400 may include at least one lid 1460. In some embodiments, a vessel 1400 may include a lid 1460 that is connected to the vessel 1400. A lid 1460 may be connected to a vessel 1400 in numerous ways. In some embodiments, a lid 1460 may be connected to a vessel 1400 through a tether. In some embodiments, a lid 1460 may be connected to a vessel 1400 through a hinge. In some embodiments, a lid 1460 may be connected to a vessel 1400 through a pivoting member that allows the lid 1460 to be laterally rotated away from the opening of the vessel 1400.

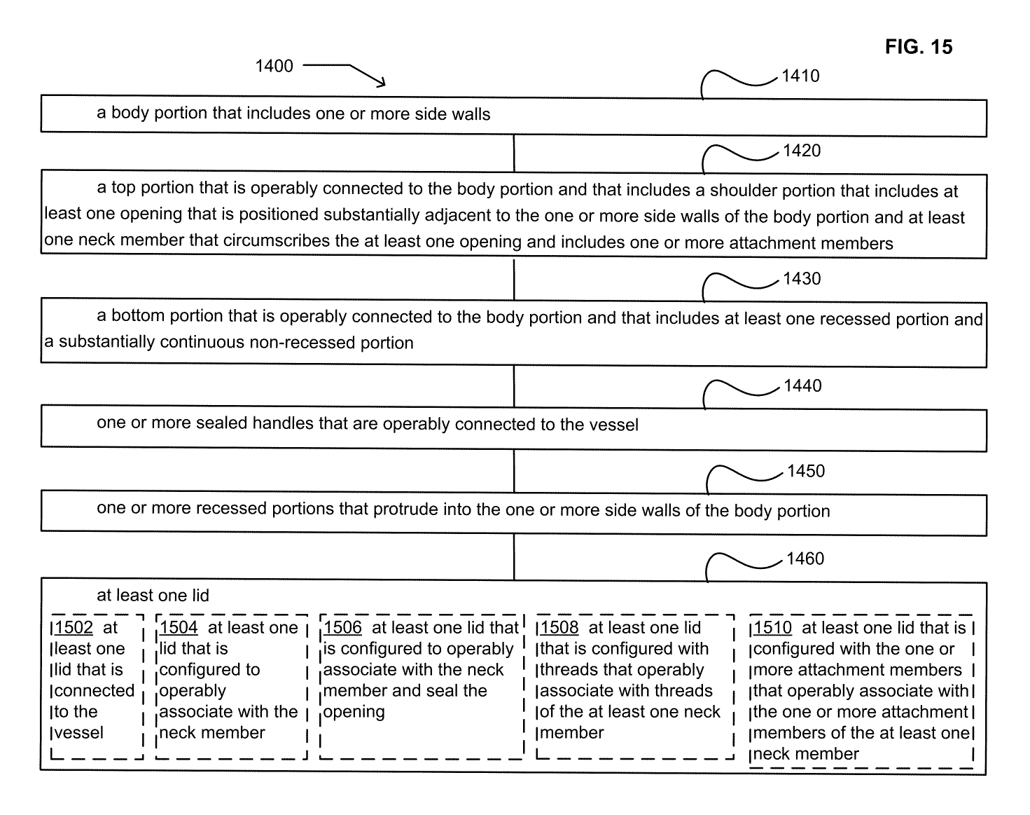

FIG. 15 illustrates example embodiments of a vessel 1400. Additional embodiments may include an embodiment 1502, an embodiment 1504, an embodiment 1506, an embodiment 1508, and/or an embodiment 1510.

Embodiment 1502 illustrates a vessel 1400 having at least one lid that is connected to the vessel. In some embodiments, a vessel 1400 may include at least one lid 1460 that is connected to the vessel 1400. A lid 1460 may be connected to a vessel 1400 in numerous ways. In some embodiments, a lid 1460 may be connected to a vessel 1400 through a tether. In some embodiments, a lid 1460 may be connected to a vessel 1400 through a hinge. In some embodiments, a lid 1460 may be connected to a vessel 1400 through a pivoting member that allows the lid 1460 to be laterally rotated away from the opening of the vessel 1400.

Embodiment 1504 illustrates a vessel 1400 having at least one lid that is configured to operably associate with the neck member. In some embodiments, a vessel 1400 may include at least one lid 1460 that is configured to operably associate with the neck member. In some embodiments, a lid 1460 may be threaded so that it will screw down on a threaded neck member and seal an opening in a vessel 1400. In some embodiments, a lid 1460 may include a compression fitting that it compress on a neck member and seal an opening in a vessel 1400. In some embodiments, a lid 1460 may include a gasket that will compress on a neck member and seal an opening in a vessel 1400. Accordingly, a lid 1460 may have numerous configurations that allow the lid 1460 to seal an opening in the vessel 1400.

Embodiment 1506 illustrates a vessel 1400 having at least one lid that is configured to operably associate with the neck member and seal the opening. In some embodiments, a vessel 1400 may include at least one lid 1460 that is configured to operably associate with the neck member and seal the opening. In some embodiments, a lid 1460 may be threaded so that it will screw down on a threaded neck member and seal an opening in a vessel 1400. In some embodiments, a lid 1460 may include a compression fitting that it compress on a neck member and seal an opening in a vessel 1400. In some embodiments, a lid 1460 may include a gasket that will compress on a neck member and seal an opening in a vessel 1400. Accordingly, a lid 1460 may have numerous configurations that allow the lid 1460 to seal an opening in the vessel 1400.

Embodiment 1508 illustrates a vessel 1400 having at least one lid that is configured with threads that operably associate with threads of the at least one neck member. In some embodiments, a vessel 1400 may include at least one lid 1460 that is configured with threads that operably associate with threads of the at least one neck member.

Embodiment 1510 illustrates a vessel 1400 having at least one lid that is configured with the one or more attachment members that operably associate with the one or more attachment members of the at least one neck member. In some embodiments, a vessel 1400 may include at least one lid 1460 that is configured with the one or more attachment members that operably associate with the one or more attachment members of the at least one neck member. A lid 1460 may include numerous types of attachment members. In some embodiments, a lid 1460 may include one or more substantially transverse rods that insert into one or more cavities in the neck member. In some embodiments, a lid 1460 may include one or more cavities that accept one or more substantially transverse rods that are associated with the neck member. In some embodiments, a lid 1460 may include one or more compression rings that squeeze onto a neck member of a vessel 1400. In some embodiments, a lid 1460 may be constructed from elastomeric material that stretches over the neck member on a vessel 1400. Accordingly, a lid may include numerous types of attachment members.

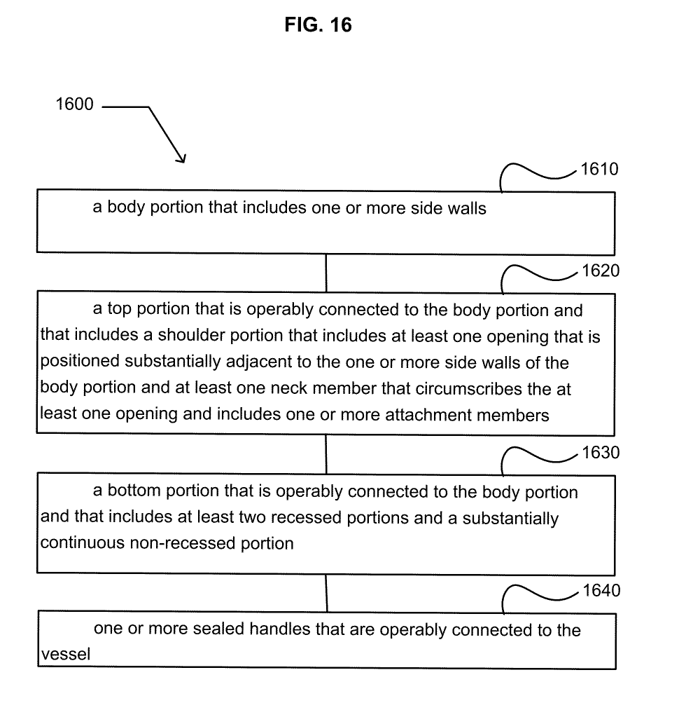

FIG. 16 illustrates an example vessel 1600 in which embodiments may be implemented. A vessel 1600 includes a body portion 1610. In some embodiments, the body portion 1610 may be formed from a single side wall. In some embodiments, the body portion 1610 may be formed from two or more side walls. For example, in some embodiments, a vessel 1600 may include two or more side walls that include an air space between the two or more side walls. In some embodiments, a vessel 1600 may include two or more side walls that include insulation between the two or more side walls. In some embodiments, a vessel 1600 may include two or more side walls that include a vacuum between the two or more side walls. In some embodiments, a vessel 1600 may include two or more side walls that include a phase change material between the two or more side walls. In some embodiments, a vessel 1600 may include one or more walls that separate the interior of the vessel into two or more chambers.

A vessel 1600 includes a top portion 1620 that is operably connected to the body portion 1610. In some embodiments, a vessel 1600 may include a top portion that is operably connected to the body portion and that includes a shoulder portion that includes at least one opening that is positioned substantially adjacent to one or more side walls of the body portion. The top portion 1620 includes at least one neck member that circumscribes the at least one opening. The opening may be constructed to have numerous sizes. For example, in some embodiments, the size of the opening may be great enough to allow a person to insert their hand through the opening to access the interior of the vessel 1600. In some embodiments, the neck member may optionally include one or more attachment members. The neck member may optionally include numerous types of attachment members. Examples, of such attachment members include, but are not limited to, threads, lugs, compression fittings, ridges, and the like. In some embodiments, a neck member may include transverse members that protrude from the neck member. In some embodiments, a neck member may include a friction fitting. In some embodiments, a neck member may include one or more insets that are configured to receive one or more protruding members. Accordingly, a neck member may include numerous types of attachment members.

A vessel 1600 includes a bottom portion 1630 that is operably connected to the body portion 1610. The bottom portion 1630 includes at least two recessed portions and a substantially continuous non-recessed portion. In some embodiments, the at least two recessed portions are configured to accept the neck portion of another vessel 1600. In some embodiments, the two or more recessed portions are each configured to accept a neck portion that is attached to a lid of another vessel 1600. Accordingly, in some embodiments, a top vessel 1600 may be stacked on top of a lower vessel 1600 with one or more necks and lids of the lower vessel 1600 being accepted into the two or more recessed portions of the top vessel 1600. In some embodiments, a vessel 1600 may include a substantially continuous non-recessed portion. The substantially continuously non-recessed portion may circumscribe the two or more recessed portions of the bottom portion 1630 of the vessel 1600. Accordingly, in some embodiments, a top vessel 1600 may be stacked on top of a lower vessel 1600 such that one or more necks and attached lids of the lower vessel 1600 are accepted into the two or more recessed portions in the bottom portion 1630 of the top vessel 1600 and the substantially continuous non-recessed portion of the top vessel 1600 substantially continuously rests on the shoulder portion of the lower vessel 1600.

A vessel 1600 includes one or more sealed handles 1640 that are operably connected to the vessel 1600. The sealed handles 1640 are sealed on both ends of the handle such that the interior of the handle is isolated from the interior portion of the body of the vessel 1600. Accordingly, in some embodiments, fluid is unable to flow from the interior of the body of the vessel 1600 into a sealed handle 1640 that is coupled to the vessel 1600. In some embodiments, a sealed handle 1640 is attached to the vessel 1600 with one end of the sealed handle 1640 being coupled to the shoulder of the top portion 1620 of the vessel 1600 and the other end being coupled to a side wall of the vessel 1600. In some embodiments, a sealed handle 1640 is attached to the vessel 1600 with one end of the sealed handle 1640 being coupled to the side wall of the vessel 1600 and the other end being coupled to a side wall of the vessel 1600. In some embodiments, a sealed handle 1640 may extend beyond the outline of the body portion 1610 of a vessel 1600 to which it is attached. In some embodiments, a sealed handle 1640 may not extend beyond the outline of the body portion 1610 of a vessel 1600 to which it is attached. Accordingly, in some embodiments, a sealed handle 1640 may be attached to a vessel 1600 such that the overall outline of the vessel 1600 is maintained.

The following figure descriptions include various embodiments of vessels 1600, discussion and explanation with respect to other alternative embodiments and contexts. However, it should be understood that a vessel 1600 may have numerous configurations and modifications. Also, although various embodiments are presented in the figures, it should be understood that a vessel 1600 may have a configuration that is other than those which are illustrated.

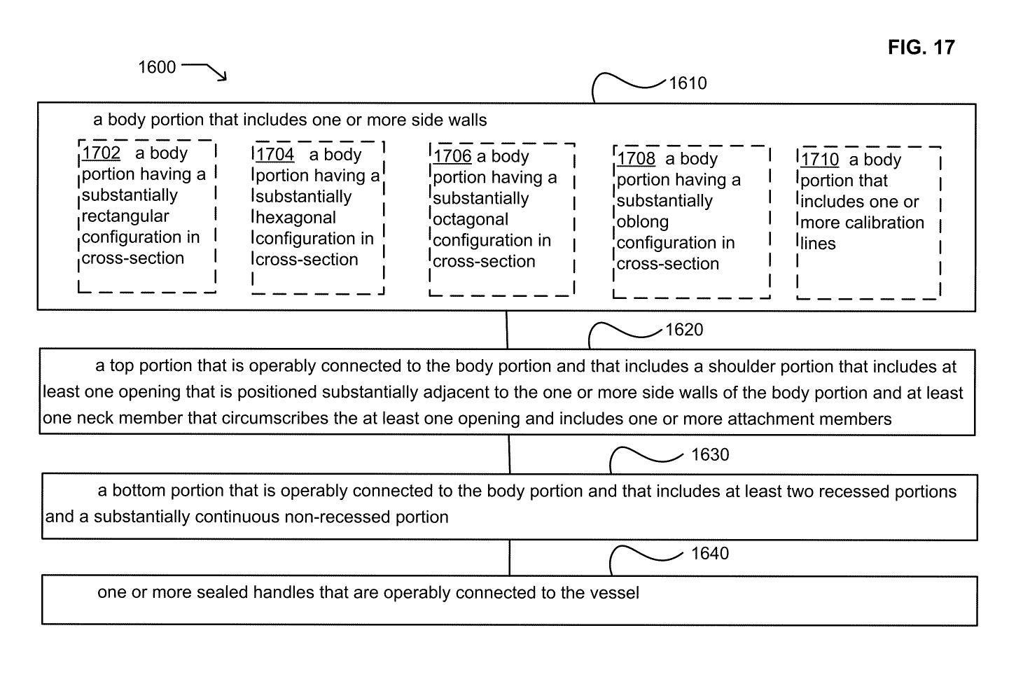

FIG. 17 illustrates example embodiments of a vessel 1600. Additional embodiments may include an embodiment 1702, an embodiment 1704, an embodiment 1706, an embodiment 1708, and/or an embodiment 1710.

Embodiment 1702 illustrates a vessel 1600 having a body portion having a substantially rectangular configuration in cross-section. In some embodiments, a vessel 1600 may have a body portion 1610 that has a substantially rectangular shape in cross-section relative to the vertical axis of the vessel 1600. In some embodiments, a vessel 100 may include two or more side walls that are in a substantially rectangular shape.

Embodiment 1704 illustrates a vessel 1600 having a body portion having a substantially hexagonal configuration in cross-section. In some embodiments, a vessel 1600 may have a body portion 1610 that has a substantially hexagonal shape in cross-section relative to the vertical axis of the vessel 1600. In some embodiments, a vessel 1600 may include two or more side walls that are in a substantially hexagonal shape.

Embodiment 1706 illustrates a vessel 1600 having a body portion having a substantially octagonal configuration in cross-section. In some embodiments, a vessel 1600 may have a body portion 1610 that has a substantially octagonal shape in cross-section relative to the vertical axis of the vessel 1600. In some embodiments, a vessel 1600 may include two or more side walls that are in a substantially octagonal shape.

Embodiment 1708 illustrates a vessel 1600 having a body portion having a substantially oblong configuration in cross-section. In some embodiments, a vessel 1600 may have a body portion 1610 that has a substantially oblong shape in cross-section relative to the vertical axis of the vessel 1600. In some embodiments, a vessel 1600 may include two or more side walls that are in a substantially oblong shape.

Embodiment 1710 illustrates a vessel 1600 having a body portion that includes one or more calibration lines. In some embodiments, a vessel 1600 may have a body portion 1610 that includes one or more calibration lines. In some embodiments, a vessel 1600 may include calibration lines that indicate a volume of material that is held within a vessel 1600. For example, in some embodiments, calibration lines may be configured to indicate the quantity of liquid that is held within a vessel 1600. In some embodiments, a vessel 1600 may include calibration lines that indicate a mass of material that is held within a vessel 1600. For example, in some embodiments, calibration lines may be configured to indicate the mass of grain that is held within a vessel 1600. Accordingly, a vessel 1600 may include calibration lines that are configured to provide information about numerous materials that may be held within the vessel 1600.

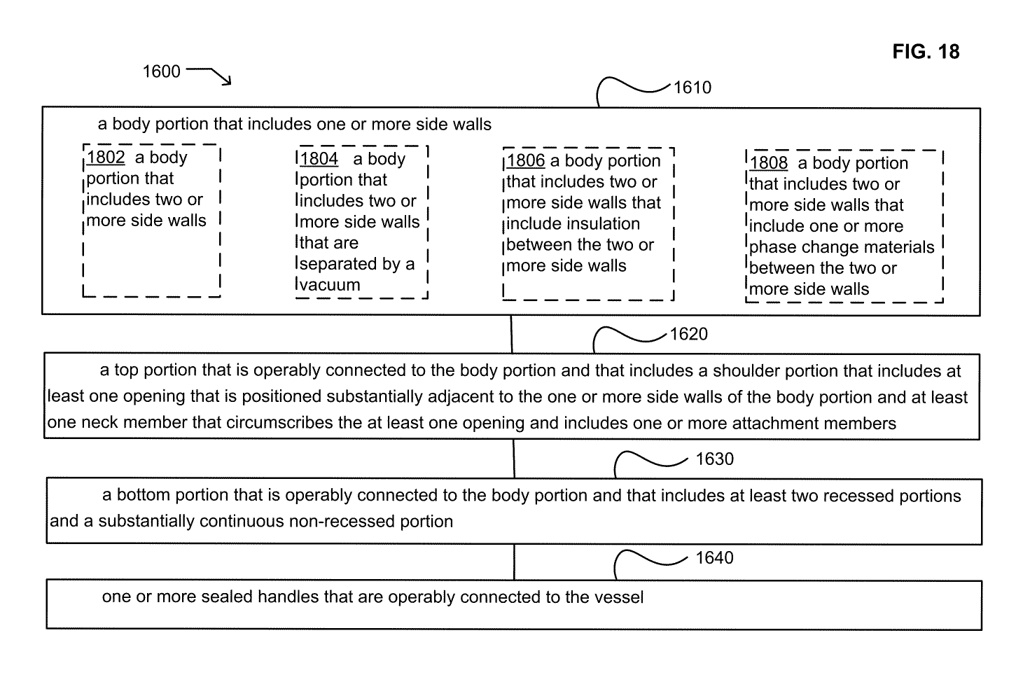

FIG. 18 illustrates example embodiments of a vessel 1600. Additional embodiments may include an embodiment 1802, an embodiment 1804, an embodiment 1806, and/or an embodiment 1808.

Embodiment 1802 illustrates a vessel 1600 having a body portion that includes two or more side walls. In some embodiments, a vessel 1600 may have a body portion 1610 that includes two or more side walls. In some embodiments, a vessel 1600 may include a body portion 1610 that includes two or more side walls that are separated by a vacuum. In some embodiments, a vessel 1600 may include a body portion 1610 that includes two or more side walls that are separated by insulation material. Numerous types of insulation material may be included between the walls of a vessel 1600. Examples of such insulation material include, but are not limited to, one or more aerogels, polymeric foam materials, fiberglass, and the like. In some embodiments, a vessel 1600 may include a body portion 1610 that includes two or more side walls that are separated by a phase change material. Numerous types of phase change materials may be included between the walls of a vessel 1600. Examples of such phase change materials include, but are not limited to, eutectics, salt hydrates, organic materials, and the like. Numerous phase change materials are known (e.g., Farid et al., A review on phase change energy storage: materials and applications, Energy Conservation and Management (45), pgs. 1597-1615 (2004)).

Embodiment 1804 illustrates a vessel 1600 having a body portion that includes two or more side walls that are separated by a vacuum. In some embodiments, a vessel 1600 may include a body portion 1610 that includes two or more side walls that are separated by a vacuum. In some embodiments, a vessel 1600 may include a body portion 1610 that includes two or more side walls that are separated by a vacuum and that include one or more getters within the vacuum space. Numerous types of getters are known and may be used. In some embodiments, a vessel 1600 may include a body portion 1610 that includes two or more side walls that are separated by a vacuum and that include one or more getters and insulation within the vacuum space.

Embodiment 1806 illustrates a vessel 1600 having a body portion that includes two or more side walls that include insulation between the two or more side walls. In some embodiments, a vessel 1600 may include a body portion 1610 that includes two or more side walls that are separated by insulation material. Numerous types of insulation material may be included between the walls of a vessel 1600. Examples of such insulation material include, but are not limited to, one or more aerogels, polymeric foam materials, fiberglass, and the like.

Embodiment 1808 illustrates a vessel 1600 having a body portion that includes two or more side walls that include one or more phase change materials between the two or more side walls. In some embodiments, a vessel 1600 may include a body portion 1610 that includes two or more side walls that are separated by a phase change material. Numerous types of phase change materials may be included between the walls of a vessel 1600. Examples of such phase change materials include, but are not limited to, eutectics, salt hydrates, organic materials, and the like. Numerous phase change materials are known (e.g., Farid et al., A review on phase change energy storage: materials and applications, Energy Conservation and Management (45), pgs. 1597-1615 (2004)).

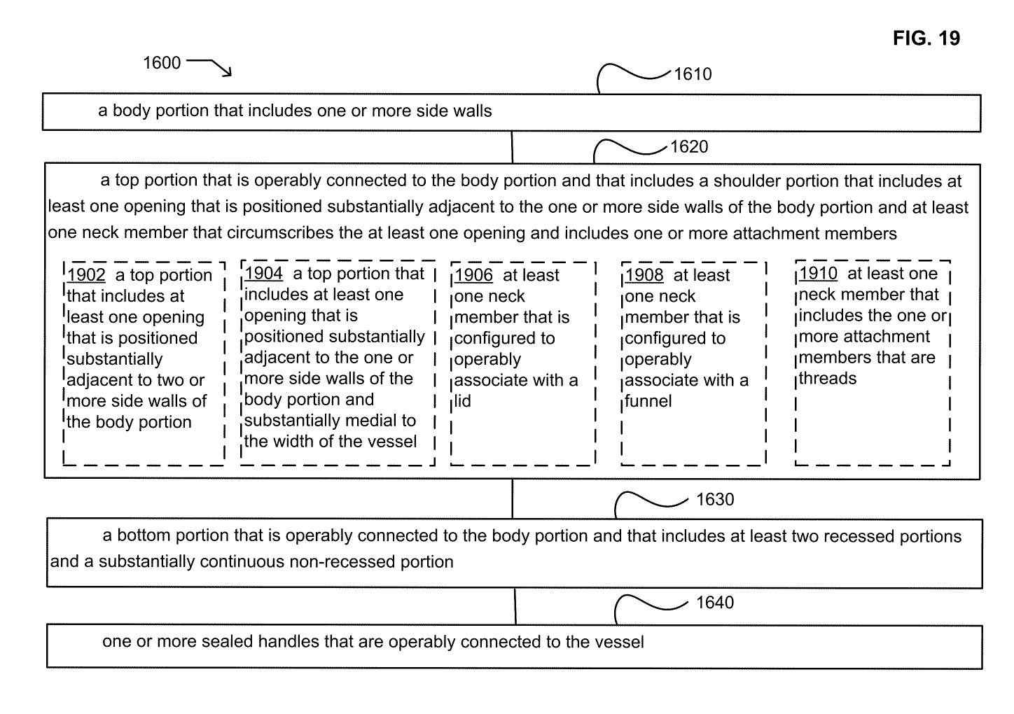

FIG. 19 illustrates example embodiments of a vessel 1600. Additional embodiments may include an embodiment 1902, an embodiment 1904, an embodiment 1906, an embodiment 1908, and/or an embodiment 1910.

Embodiment 1902 illustrates a vessel 1600 having a top portion that includes at least one opening that is positioned substantially adjacent to two or more side walls of the body portion. In some embodiments, a vessel 1600 may include a top portion 1620 that includes at least one opening that is positioned substantially adjacent to two or more side walls of the body portion 1610. For example, in some embodiments, an opening may be positioned in the top portion 1620 of a vessel 1600 in a position that is substantially in a corner of the top portion 1620 of the vessel 1600 that is operably connected to two side walls of the vessel 1600.

Embodiment 1904 illustrates a vessel 1600 having a top portion that includes at least one opening that is positioned substantially adjacent to the one or more side walls of the body portion and substantially medial to the width of the vessel. In some embodiments, a vessel 1600 may include a top portion 1620 that includes at least one opening that is positioned substantially adjacent to the one or more side walls of the body portion 1610 and substantially medial to the width of the vessel 1600. For example, in some embodiments, a vessel 1610 may include a top portion 1620 that includes an opening that is positioned proximate to one side of the narrow end of a substantially rectangular top portion 1620.

Embodiment 1906 illustrates a vessel 1600 having at least one neck member that is configured to operably associate with a lid. In some embodiments, a vessel 1600 may include a neck member that is configured to operably associate with a lid. In some embodiments, the neck member is threaded and configured to associate with a threaded lid. In some embodiments, the neck member may include one or more transverse members that are configured to associate with a lid that includes attachment members that are configured to accept the one or more transverse members. Accordingly, a neck member may be configured in numerous ways to associate with a lid.

Embodiment 1908 illustrates a vessel 1600 having at least one neck member that is configured to operably associate with a funnel. In some embodiments, a vessel 1600 may include a neck member that is configured to operably associate with a funnel. In some embodiments, the neck member is threaded and configured to associate with a threaded funnel. In some embodiments, the neck member may include one or more transverse members that are configured to associate with a funnel that includes attachment members that are configured to accept the one or more transverse members. Accordingly, a neck member may be configured in numerous ways to associate with a funnel.

Embodiment 1910 illustrates a vessel 1600 having at least one neck member that includes the one or more attachment members that are threads. In some embodiments, a vessel 1600 may include a neck member that includes the one or more attachment members that are threads. Accordingly, in some embodiments, a vessel 1600 may be configured to accept numerous types of similarly threaded items. Examples of such items include, but are not limited to, pouring spouts, lids, funnels, and the like.

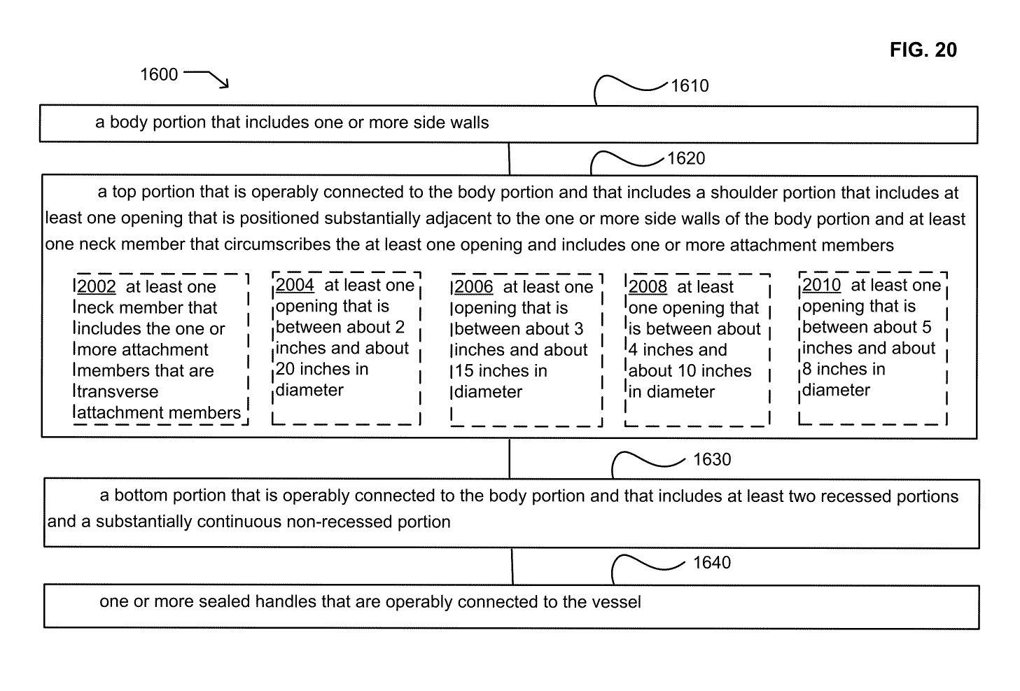

FIG. 20 illustrates example embodiments of a vessel 1600. Additional embodiments may include an embodiment 2002, an embodiment 2004, an embodiment 2006, an embodiment 2008, and/or an embodiment 2010.

Embodiment 2002 illustrates a vessel 1600 having at least one neck member that includes the one or more attachment members that are transverse attachment members. In some embodiments, a vessel 1600 may include a neck member that includes the one or more attachment members that are transverse attachment members. A vessel 1600 may include numerous types of transverse attachment members. Transverse attachment members may have numerous configurations. For example, in some embodiments, a transverse attachment member may be shaped as a rod that protrudes in a transverse manner from the neck member of a vessel 1600. In some embodiments, a transverse attachment member may be shaped as a bolt that protrudes in a transverse manner from the neck member of a vessel 1600. Accordingly, in some embodiments, a vessel 1600 may be configured to accept numerous types of items having similar attachment members. Examples of such items include, but are not limited to, pouring spouts, lids, funnels, and the like.

Embodiment 2004 illustrates a vessel 1600 having at least one opening that is between about 2 inches and about 20 inches in diameter. In some embodiments, a vessel 1600 may include an opening that is between about 2 inches and about 20 inches in diameter.

Embodiment 2006 illustrates a vessel 1600 having at least one opening that is between about 3 inches and about 15 inches in diameter. In some embodiments, a vessel 1600 may include an opening that is between about 3 inches and about 15 inches in diameter.

Embodiment 2008 illustrates a vessel 1600 having at least one opening that is between about 4 inches and about 10 inches in diameter. In some embodiments, a vessel 1600 may include an opening that is between about 4 inches and about 10 inches in diameter.

Embodiment 2010 illustrates a vessel 1600 having at least one opening that is between about 5 inches and about 8 inches in diameter. In some embodiments, a vessel 1600 may include an opening that is between about 5 inches and about 8 inches in diameter.

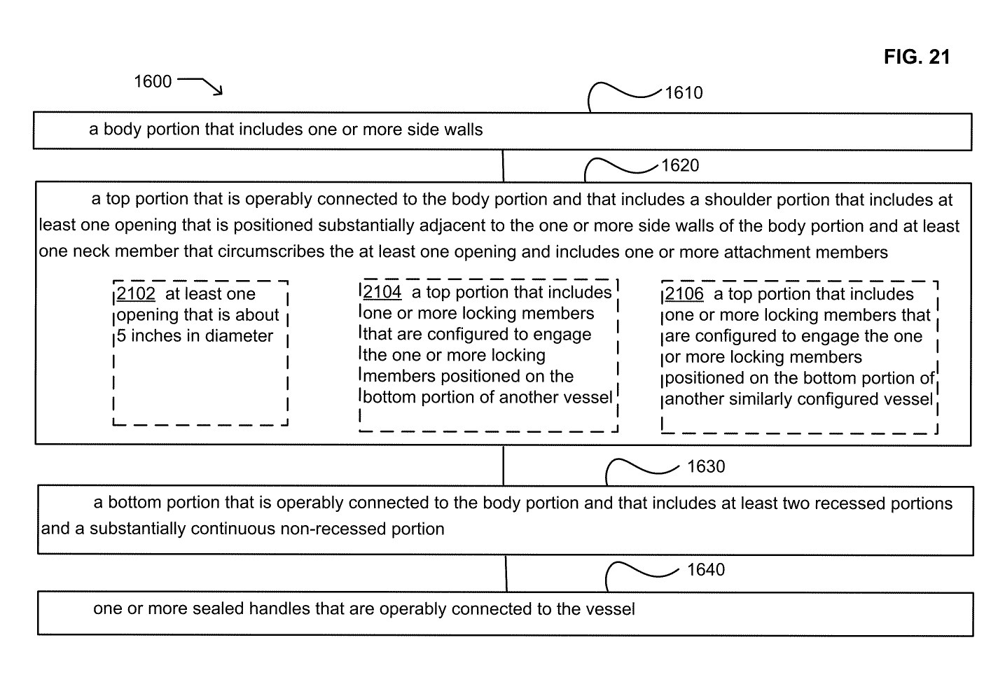

FIG. 21 illustrates example embodiments of a vessel 1600. Additional embodiments may include an embodiment 2102, an embodiment 2104, and/or an embodiment 2106.

Embodiment 2102 illustrates a vessel 1600 having at least one opening that is about 5 inches in diameter. In some embodiments, a vessel 1600 may include an opening that is about 5 inches in diameter.

Embodiment 2104 illustrates a vessel 1600 having a top portion that includes one or more locking members that are configured to engage the one or more locking members positioned on the bottom portion of another vessel. In some embodiments, a vessel 1600 may include a top portion 1620 that includes one or more locking members that are configured to engage the one or more locking members positioned on the bottom portion of another vessel 1600. Locking members may be configured in numerous ways. For example, in some embodiments, a top portion 1620 of a first vessel 1600 may include locking members that are configured in a bolt shape that can insert into a cavity positioned in the bottom portion of another vessel. In some embodiments, such locking members may be configured as a dovetail. In some embodiments, such locking members may be configured in a tongue and groove arrangement.

Embodiment 2106 illustrates a vessel 1600 having a top portion that includes one or more locking members that are configured to engage the one or more locking members positioned on the bottom portion of another similarly configured vessel. In some embodiments, a vessel 1600 may include a top portion 1620 that includes one or more locking members that are configured to engage the one or more locking members positioned on the bottom portion of another similarly configured vessel. Locking members may be configured in numerous ways. For example, in some embodiments, a top portion 1620 of a first vessel 1600 may include locking members that are configured in a bolt shape that can insert into a cavity positioned in the bottom portion of another vessel. In some embodiments, such locking members may be configured as a dovetail. In some embodiments, such locking members may be configured in a tongue and groove arrangement.

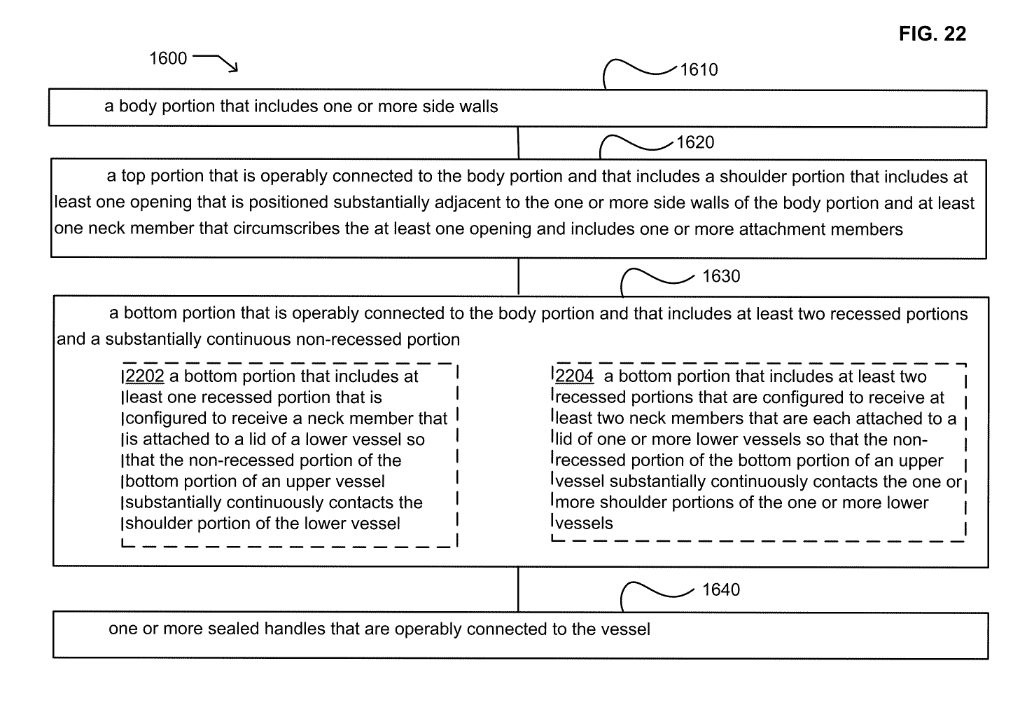

FIG. 22 illustrates example embodiments of a vessel 1600. Additional embodiments may include an embodiment 2202 and/or an embodiment 2204.

Embodiment 2202 illustrates a vessel 1600 having a bottom portion that includes at least one recessed portion that is configured to receive a neck member that is attached to a lid of a lower vessel so that the non-recessed portion of the bottom portion of an upper vessel substantially continuously contacts the shoulder portion of the lower vessel. In some embodiments, a vessel 1600 may include a bottom portion 1630 that includes at least one recessed portion that is configured to receive a neck member that is attached to a lid of a lower vessel so that the non-recessed portion of the bottom portion 1630 of an upper vessel 1600 substantially continuously contacts the shoulder portion of the lower vessel. In some embodiments, a vessel 1600 may include a bottom portion 1630 that includes a non-recessed portion that continuously contacts the shoulder portion of another vessel when the vessels are stacked on each other. Accordingly, in some embodiments, the stability of two vessels that are stacked on top of each other is increased due to the substantially continuous contact of the upper vessel 1600 with the lower vessel 1600.

Embodiment 2204 illustrates a vessel 1600 having a bottom portion that includes at least two recessed portions that are configured to receive at least two neck members that are each attached to a lid of one or more lower vessels so that the non-recessed portion of the bottom portion of an upper vessel substantially continuously contacts the one or more shoulder portions of the one or more lower vessels. In some embodiments, a vessel 1600 may include a bottom portion 1630 that includes at least two recessed portions that are configured to receive at least two neck members that are each attached to a lid of one or more lower vessels so that the non-recessed portion of the bottom portion of an upper vessel 1600 substantially continuously contacts the one or more shoulder portions of the one or more lower vessels. In some embodiments, a vessel 1600 may include two recessed portions in the bottom portion of the vessel 1600 that are spaced to accept two neck members that are each attached to a lid and included on a single lower vessel. In some embodiments, a vessel 1600 may include two recessed portions in the bottom portion of the vessel 1600 that are spaced to accept at least one neck member that is attached to a lid and included on a single lower vessel. In some embodiments, a vessel 1600 may include two recessed portions in the bottom portion of the vessel 1600 that are spaced to accept two neck members that are each attached to a lid and that are each included on two separate vessels. Accordingly, in some embodiments, a vessel 1600 may include a bottom portion that includes at least two recessed portions that allow the vessel 1600 to be stacked on top of a single vessel or on top of two vessels (e.g., see FIG. 42J-42L and 43D-43E). In some embodiments, a first vessel 1600 may include two recessed portions in the bottom portion of the first vessel 1600 that are spaced to accept one protrusion and one neck member that is attached to a lid of a second vessel.

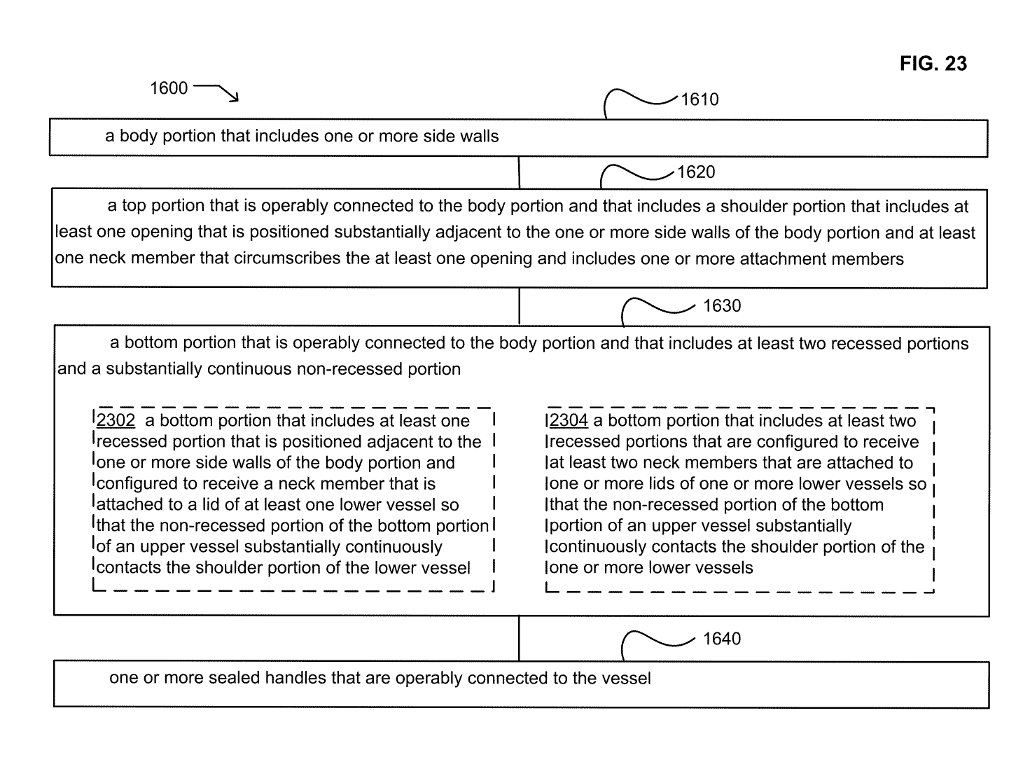

FIG. 23 illustrates example embodiments of a vessel 1600. Additional embodiments may include an embodiment 2302 and/or an embodiment 2304.

Embodiment 2302 illustrates a vessel 1600 having a bottom portion that includes at least one recessed portion that is positioned adjacent to the one or more side walls of the body portion and configured to receive a neck member that is attached to a lid of at least one lower vessel so that the non-recessed portion of the bottom portion of an upper vessel substantially continuously contacts the shoulder portion of the lower vessel. In some embodiments, a vessel 1600 may include a bottom portion 1630 that includes at least one recessed portion that is positioned adjacent to the one or more side walls of the body portion 1610 and configured to receive a neck member that is attached to a lid of at least one lower vessel so that the non-recessed portion of the bottom portion of an upper vessel 1600 substantially continuously contacts the shoulder portion of the lower vessel. In some embodiments, a vessel 1600 may include a bottom portion 1630 that includes a non-recessed portion that continuously contacts the shoulder portion of another vessel when the vessels are stacked on each other. Accordingly, in some embodiments, the stability of two vessels that are stacked on top of each other is increased due to the substantially continuous contact of the upper vessel 1600 with the lower vessel.

Embodiment 2304 illustrates a vessel 1600 having a bottom portion that includes at least two recessed portions that are configured to receive at least two neck members that are attached to one or more lids of one or more lower vessels so that the non-recessed portion of the bottom portion of an upper vessel substantially continuously contacts the shoulder portion of the one or more lower vessels. In some embodiments, a vessel 1600 may include a bottom portion 1630 that includes at least two recessed portions that are configured to receive at least two neck members that are attached to one or more lids of one or more lower vessels so that the non-recessed portion of the bottom portion of an upper vessel substantially continuously contacts the shoulder portion of the one or more lower vessels. In some embodiments, a vessel 1600 may include two recessed portions in the bottom portion 1630 of the vessel 1600 that are spaced to accept two neck members that are each attached to a lid and included on a single lower vessel. In some embodiments, a vessel 1600 may include two recessed portions in the bottom portion of the vessel that are spaced to accept at least one neck member that is attached to a lid and included on a single lower vessel. In some embodiments, a vessel 1600 may include two recessed portions in the bottom portion of the vessel 1600 that are spaced to accept two neck members that are each attached to a lid and that are each included on two separate vessels. Accordingly, in some embodiments, a vessel 1600 may include a bottom portion that includes at least two recessed portions that allow the vessel 1600 to be stacked on top of a single vessel or on top of two vessels (e.g., see FIG. 42J-42L and 43D-43E). In some embodiments, a first vessel 1600 may include two recessed portions in the bottom portion of the first vessel that are spaced to accept one protrusion and one neck member that is attached to a lid of a second vessel.

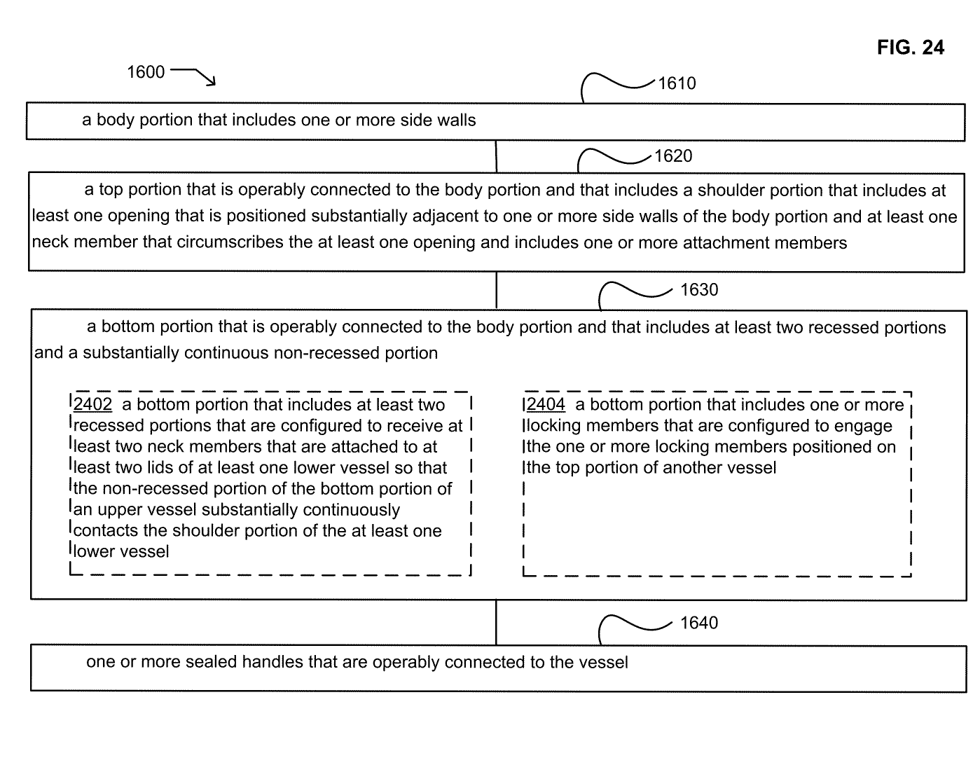

FIG. 24 illustrates example embodiments of a vessel 1600. Additional embodiments may include an embodiment 2402 and/or an embodiment 2404.

Embodiment 2402 illustrates a vessel 1600 having a bottom portion that includes at least two recessed portions that are configured to receive at least two neck members that are attached to at least two lids of at least one lower vessel so that the non-recessed portion of the bottom portion of an upper vessel substantially continuously contacts the shoulder portion of the at least one lower vessel. In some embodiments, a vessel 1600 may include a bottom portion 1630 that includes at least two recessed portions that are configured to receive at least two neck members that are attached to at least two lids of at least one lower vessel so that the non-recessed portion of the bottom portion 1630 of an upper vessel 1600 substantially continuously contacts the shoulder portion of the at least one lower vessel. In some embodiments, a vessel 1600 may include two recessed portions in the bottom portion of the vessel 1600 that are spaced to accept two neck members that are each attached to a lid and included on a single lower vessel. In some embodiments, a vessel 1600 may include two recessed portions in the bottom portion of the vessel 1600 that are spaced to accept at least one neck member that is attached to a lid and included on a single lower vessel. In some embodiments, a vessel 1600 may include two recessed portions in the bottom portion 1630 of the vessel 1600 that are spaced to accept two neck members that are each attached to a lid and that are each included on two separate vessels. Accordingly, in some embodiments, a vessel 1600 may include a bottom portion 1630 that includes at least two recessed portions that allow the vessel to be stacked on top of a single vessel or on top of two vessels (e.g., see FIG. 42J-42L and 43D-43E). In some embodiments, a first vessel 1600 may include two recessed portions in the bottom portion 1630 of the first vessel 1600 that are spaced to accept one protrusion and one neck member that is attached to a lid of a second vessel.

Embodiment 2404 illustrates a vessel 1600 having a bottom portion that includes one or more locking members that are configured to engage the one or more locking members positioned on the top portion of another vessel. In some embodiments, a vessel 1600 may include a bottom portion 1630 that includes one or more locking members that are configured to engage the one or more locking members positioned on the top portion of another vessel. A vessel 1600 may include numerous types of locking members. Examples of such locking members include, but are not limited to, tongue and groove locking members, dovetail locking members, nut and bolt type locking members, and the like.

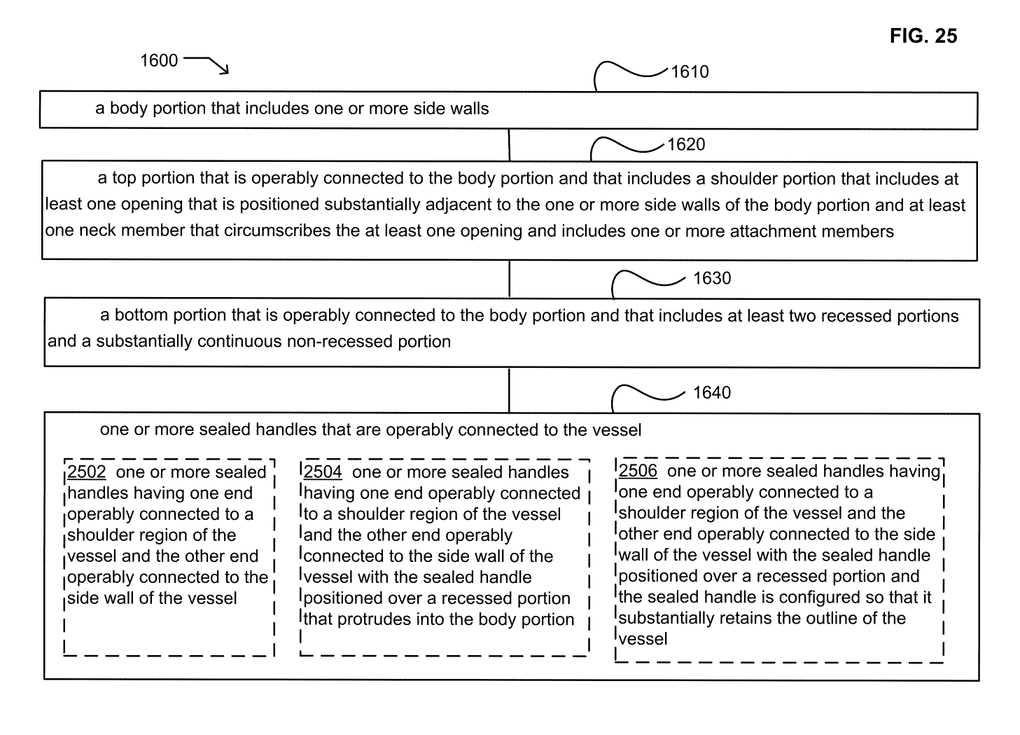

FIG. 25 illustrates example embodiments of a vessel 1600. Additional embodiments may include an embodiment 2502, an embodiment 2504, and/or an embodiment 2506.

Embodiment 2502 illustrates a vessel 1600 having one or more sealed handles having one end operably connected to a shoulder region of the vessel and the other end operably connected to the side wall of the vessel. In some embodiments, a vessel 1600 may include one or more sealed handles 1640 having one end operably connected to a shoulder region of the vessel 1600 and the other end operably connected to the side wall of the vessel 1600. In some embodiments, a vessel 1600 may include one or more sealed handles 1640 having one end operably connected to the shoulder region of the vessel 1600 and the other end operably connected to the side wall of the vessel 1600 with the handle protruding out from the outline of the vessel 1600. In some embodiments, a vessel 1600 may include one or more sealed handles 1640 having one end operably connected to the shoulder region of the vessel 1600 and the other end operably connected to the side wall of the vessel 1600 with the handle being positioned over a recessed portion of the vessel 1600. In some embodiments, a vessel 1600 may include one or more sealed handles 1640 having one end operably connected to the shoulder region of the vessel 1600 and the other end operably connected to the side wall of the vessel 1600 with the handle being positioned over a recessed portion of the vessel 1600 and the handle preserving the outline of the vessel 1600. In some embodiments, a vessel 1600 may include one or more sealed handles 1640 having one end operably connected to the shoulder region of the vessel 1600 and the other end operably connected to the side wall of the vessel 1600 with both ends of the handle being connected to a corner of the vessel 1600.

Embodiment 2504 illustrates a vessel 1600 having one or more sealed handles having one end operably connected to a shoulder region of the vessel and the other end operably connected to the side wall of the vessel with the sealed handle positioned over a recessed portion that protrudes into the body portion. In some embodiments, a vessel 1600 may include one or more sealed handles 1640 having one end operably connected to a shoulder region of the vessel 1600 and the other end operably connected to the side wall of the vessel 1600 with the sealed handle positioned over a recessed portion that protrudes into the body portion 1610. In some embodiments, a vessel 1600 may include one or more sealed handles 1460 having one end operably connected to the shoulder region of the vessel 1600 and the other end operably connected to the side wall of the vessel 1600 with the handle protruding out from the outline of the vessel 1600. In some embodiments, a vessel 1600 may include one or more sealed handles 1640 having one end operably connected to the shoulder region of the vessel 1600 and the other end operably connected to the side wall of the vessel 1600 with the handle being positioned over a recessed portion of the vessel 1600 and the handle preserving the outline of the vessel 1600. In some embodiments, a vessel 1600 may include one or more sealed handles 1640 having one end operably connected to the shoulder region of the vessel 1600 and the other end operably connected to the side wall of the vessel 1600 with both ends of the handle being connected to a corner of the vessel 1600.

Embodiment 2506 illustrates a vessel 1600 having one or more sealed handles having one end operably connected to a shoulder region of the vessel and the other end operably connected to the side wall of the vessel with the sealed handle positioned over a recessed portion and the sealed handle is configured so that it substantially retains the outline of the vessel. In some embodiments, a vessel 1600 may include one or more sealed handles 1640 having one end operably connected to a shoulder region of the vessel 1600 and the other end operably connected to the side wall of the vessel 1600 with the sealed handle positioned over a recessed portion and the sealed handle 1640 is configured so that it substantially retains the outline of the vessel 1600. In some embodiments, a vessel 1600 may include one or more sealed handles 1640 having one end operably connected to the shoulder region of the vessel 1600 and the other end operably connected to the side wall of the vessel 1600 with both ends of the handle being connected to a corner of the vessel 1600.

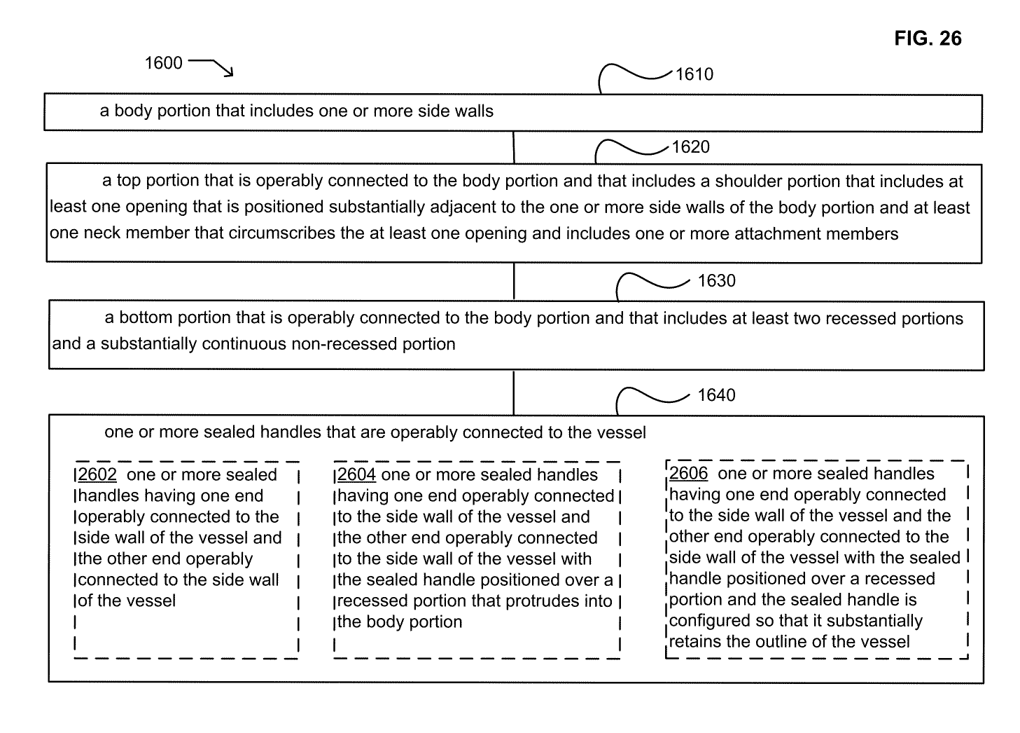

FIG. 26 illustrates example embodiments of a vessel 1600. Additional embodiments may include an embodiment 2602, an embodiment 2604, and/or an embodiment 2606.

Embodiment 2602 illustrates a vessel 1600 having one or more sealed handles having one end operably connected to the side wall of the vessel and the other end operably connected to the side wall of the vessel. In some embodiments, a vessel 1600 may include one or more sealed handles 1640 having one end operably connected to the side wall of the vessel 1600 and the other end operably connected to the side wall of the vessel 1600. In some embodiments, one or more sealed handles 1640 may protrude out from the side of a vessel 1600 and therefore do not retain the outline of the vessel 1600. In some embodiments, one or more sealed handles 1640 may be positioned over one or more recessed portions that protrude into the side of a vessel 1600. In some embodiments, one or more sealed handles 1640 may be positioned over one or more recessed portions that protrude into the side of a vessel 1600 and the handles may be configured so that the outline of the vessel 1600 is substantially retained.

Embodiment 2604 illustrates a vessel 1600 having one or more sealed handles having one end operably connected to the side wall of the vessel and the other end operably connected to the side wall of the vessel with the sealed handle positioned over a recessed portion that protrudes into the body portion. In some embodiments, a vessel 1600 may include one or more sealed handles 1640 having one end operably connected to the side wall of the vessel 1600 and the other end operably connected to the side wall of the vessel 1600 with the sealed handle 1640 positioned over a recessed portion 1650 that protrudes into the body portion 1610. In some embodiments, a vessel 1600 may include one or more handles 1640 that are connected to a corner of the vessel 1600. In some embodiments, a vessel 100 may include one or more handles 1640 that are connected to a non-corner of the vessel 1600.

Embodiment 2606 illustrates a vessel 1600 having one or more sealed handles having one end operably connected to the side wall of the vessel and the other end operably connected to the side wall of the vessel with the sealed handle positioned over a recessed portion and the sealed handle is configured so that it substantially retains the outline of the vessel. In some embodiments, a vessel 1600 may include one or more sealed handles 1640 having one end operably connected to the side wall of the vessel 1600 and the other end operably connected to the side wall of the vessel 1600 with the sealed handle positioned over a recessed portion and the sealed handle is configured so that it substantially retains the outline of the vessel 1600. In some embodiments, a vessel 1600 may include one or more handles 1640 that are connected to a corner of the vessel 1600. In some embodiments, a vessel 1600 may include one or more handles 1640 that are connected to a non-corner of the vessel 1600.

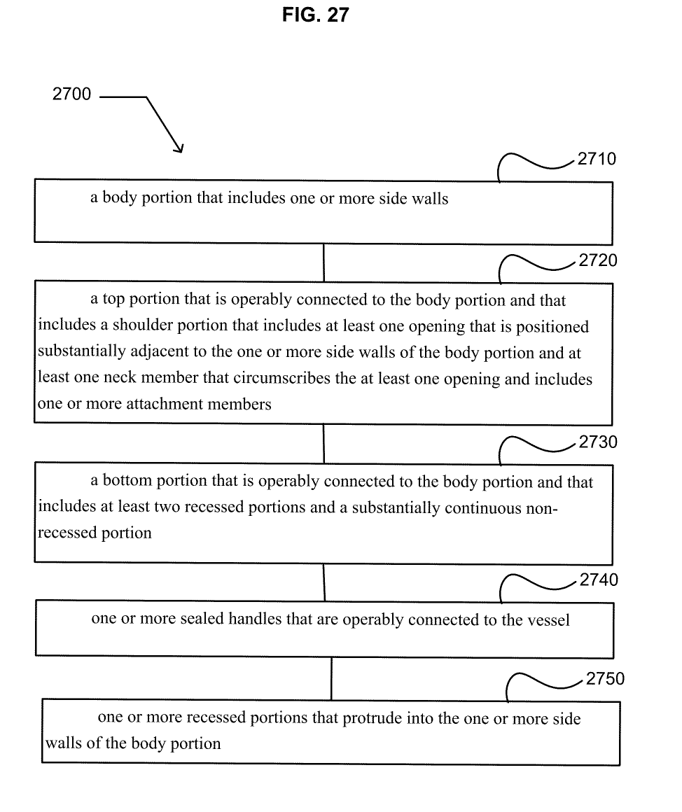

FIG. 27 and the following figures illustrate various embodiments of vessels 2700, discussion and explanation with respect to the above-described embodiment of FIG. 16 with the addition of one or more recessed portions 2750, and/or with respect to other alternative embodiments and contexts. However, it should be understood that a vessel 2700 may have numerous configurations and/or be a modified version of FIGS. 16 and/or 27. Also, although various embodiments are presented in the figures, it should be understood that a vessel 2700 may have a configuration that is other than those which are illustrated.

FIG. 27 illustrates an example vessel 2700 in which embodiments may be implemented. A vessel 2700 includes a body portion 2710. In some embodiments, the body portion 2710 may be formed from a single side wall. In some embodiments, the body portion 2710 may be formed from two or more side walls. For example, in some embodiments, a vessel 2700 may include two or more side walls that include an air space between the two or more side walls. In some embodiments, a vessel 2700 may include two or more side walls that include insulation between the two or more side walls. In some embodiments, a vessel 2700 may include two or more side walls that include a vacuum between the two or more side walls. In some embodiments, a vessel 2700 may include two or more side walls that include a phase change material between the two or more side walls. In some embodiments, a vessel 2700 may include one or more walls that separate the interior of the vessel into two or more chambers.

A vessel 2700 includes a top portion 2720 that is operably connected to the body portion 2710. The top portion 2720 includes a shoulder portion that includes an opening and a neck member that circumscribes the opening. In some embodiments, an opening may be positioned substantially adjacent to one or more side walls of the body portion of the vessel. The opening may be constructed to have numerous sizes. For example, in some embodiments, the size of the opening may be great enough to allow a person to insert their hand through the opening to access the interior of the vessel 2700. In some embodiments, the neck member may optionally include one or more attachment members. The neck member may optionally include numerous types of attachment members. Examples, of such attachment members include, but are not limited to, threads, lugs, compression fittings, ridges, and the like.

A vessel 2700 includes a bottom portion 2730 that is operably connected to the body portion 2710. The bottom portion 2730 includes at least two recessed portions and a substantially continuous non-recessed portion. In some embodiments, the recessed portions are configured to accept at least one neck member of another vessel. In some embodiments, the recessed portions are configured to accept at least one neck member that is attached to a lid of another vessel. Accordingly, in some embodiments, a top vessel 2700 may be stacked on top of at least one lower vessel with at least one neck and lid of the lower vessel being accepted into at least one of the two or more recessed portions of the top vessel 2700. In some embodiments, a vessel 2700 may include a substantially continuous non-recessed portion. The substantially continuously non-recessed portion may circumscribe the at least two recessed portions of the bottom portion 2730 of the vessel 2700. Accordingly, in some embodiments, a top vessel 2700 may be stacked on top of one or more lower vessels such that the neck and attached lid of the at least one lower vessel is accepted into the two or more recessed portions in the bottom portion 2730 of the top vessel 2700 and the substantially continuous non-recessed portion of the top vessel 2700 substantially continuously rests on the shoulder portion of the at least one lower vessel.

A vessel 2700 includes one or more sealed handles 2740 that are operably connected to the vessel 2700. The sealed handles 2740 are sealed on both ends of the handle such that the interior of the handle is isolated from the interior portion of the body of the vessel 2700. Accordingly, in some embodiments, fluid is unable to flow from the interior of the body of the vessel 2700 into a handle that is coupled to the vessel 2700. In some embodiments, a handle is attached to the vessel 2700 with one end of the handle being coupled to the shoulder of the top portion 2720 of the vessel 2700 and the other end being coupled to a side wall of the vessel 2700. In some embodiments, a handle is attached to the vessel 2700 with one end of the handle being coupled to the side wall of the vessel 2700 and the other end being coupled to a side wall of the vessel 2700. In some embodiments, a handle may extend beyond the outline of the body portion 2710 of a vessel 2700 to which it is attached. In some embodiments, a handle may not extend beyond the outline of the body portion 2710 of a vessel 2700 to which it is attached. Accordingly, in some embodiments, a handle may be attached to a vessel 2700 such that the overall outline of the vessel 2700 is maintained.

A vessel 2700 includes one or more recessed portions 2750 that protrude into the one or more side walls of the body portion 2710. In some embodiments, a recessed portion 2750 may protrude into a side wall of the vessel 2700 at a position that is adjacent a handle such that the handle may be grasped and the fingers of the grasping hand will be positioned adjacent the recessed portion. In some embodiments, a recessed portion 2750 may protrude into a side wall of the vessel 2700 at a position on the vessel 2700 that is opposite the position of a handle that is attached to the vessel 2700. In some embodiments, a recessed portion 2750 may protrude into a side wall of a vessel 2700 at a position on the vessel 2700 that is opposite that of an attached handle so that the recessed portion 2750 serves as a handle for lifting the vessel 2700. For example, in some embodiments, a worker may grasp a handle that is attached to a vessel 2700 with one hand and grasp a recessed portion 2750 that protrudes into a side wall of the vessel 2700 on the opposite side of the handle with the other hand. Recessed portions 2750 may protrude into the side wall of a vessel 2700 in numerous places relative to the vessel 2700. For example, in some embodiments, a recessed portion 2750 may protrude into the vessel 2700 at a position that is in the middle of the vessel 2700 relative to the vertical axis of the vessel 2700. In some embodiments, a recessed portion 2750 may protrude into the vessel 2700 at a position that is near the bottom portion 2730 of the vessel 2700. In some embodiments, a recessed portion 2750 may protrude into the vessel 2700 at a position that is near the top portion 2720 of the vessel 2700.

The following figure descriptions include various embodiments of vessels 2700, discussion and explanation with respect to other alternative embodiments and contexts. However, it should be understood that a vessel 2700 may have numerous configurations and modifications. Also, although various embodiments are presented in the figures, it should be understood that a vessel 2700 may have a configuration that is other than those which are illustrated.

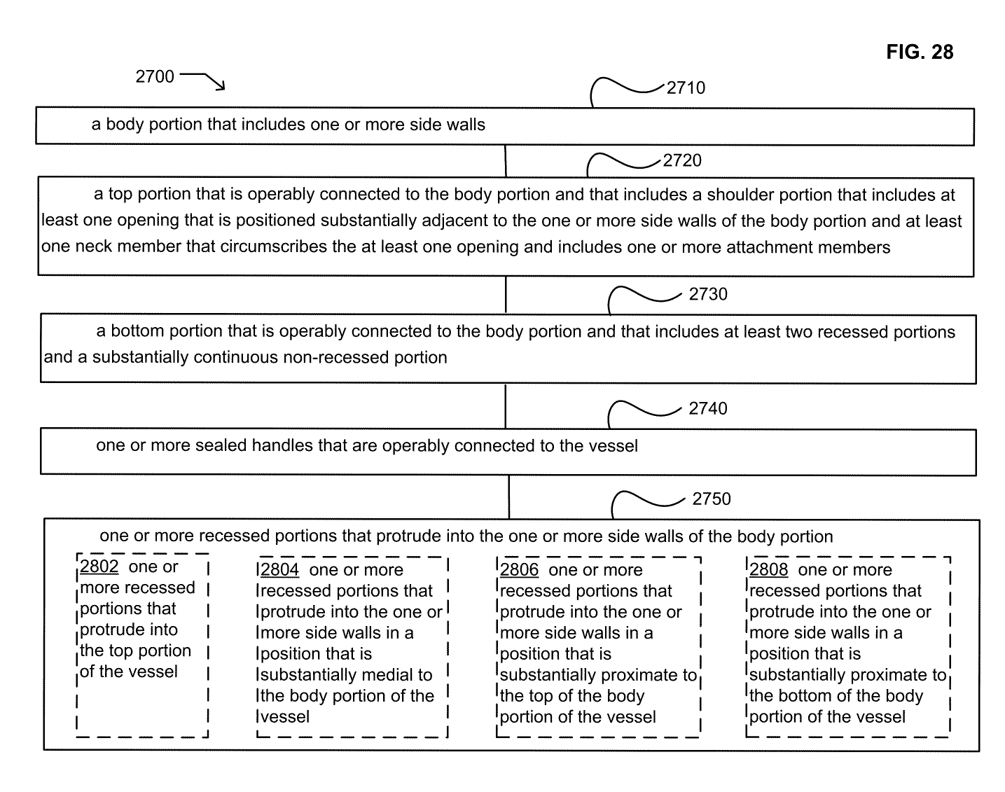

FIG. 28 illustrates example embodiments of a vessel 2700. Additional embodiments may include an embodiment 2802, an embodiment 2804, an embodiment 2806, and/or an embodiment 2808.

Embodiment 2802 illustrates a vessel 2700 having one or more recessed portions that protrude into the top portion of the vessel. In some embodiments, a vessel 2700 may include one or more recessed portions that protrude into the top portion of the vessel. In some embodiments, a first vessel may include one or more recessed portions that protrude into the top portion of the first vessel that are configured to accept one or more portions of one or more second vessels that have attachment members that protrude from the bottom portion of the second vessel. Accordingly, in some embodiments, one or more recessed portions in the top portion of a vessel may serve to stabilize the two vessels that are stacked on top of each other.

Embodiment 2804 illustrates a vessel 2700 having one or more recessed portions that protrude into the one or more side walls in a position that is substantially medial to the body portion of the vessel. In some embodiments, a vessel 2700 may include one or more recessed portions 2750 that protrude into the one or more side walls in a position that is substantially medial to the body portion 2710 of the vessel 2700. In some embodiments, a vessel 2700 may include one or more recessed portions 2750 that protrude into the one or more side walls in a position that is substantially opposite to the position of one or more sealed handles 2740. In some embodiments, a vessel 2700 may include one or more recessed portions 2750 that protrude into the one or more side walls to create a grasping structure. In some embodiments, a vessel 2700 may include one or more recessed portions 2750 that protrude into the one or more side walls to create a grasping structure that a worker can use to assist in lifting the vessel 2700. In some embodiments, a vessel 100 may include one or more recessed portions 2750 that protrude into the one or more side walls to create a recessed portion 2750 with a vertical overhang.

Embodiment 2806 illustrates a vessel 2700 having one or more recessed portions that protrude into the one or more side walls in a position that is substantially proximate to the top of the body portion of the vessel. In some embodiments, a vessel 2700 may include one or more recessed portions 2750 that protrude into the one or more side walls in a position that is substantially proximate to the top of the body portion 2710 of the vessel 2700. In some embodiments, a vessel 2700 may include one or more recessed portions 2750 that protrude into the one or more side walls in a position that is substantially opposite to the position of one or more sealed handles 2740. In some embodiments, a vessel 2700 may include one or more recessed portions 2750 that protrude into the one or more side walls to create a grasping structure. In some embodiments, a vessel 2700 may include one or more recessed portions 2750 that protrude into the one or more side walls to create a grasping structure that a worker can use to assist in lifting the vessel 2700. In some embodiments, a vessel 2700 may include one or more recessed portions 2750 that protrude into the one or more side walls to create a recessed portion 2750 with a vertical overhang.

Embodiment 2808 illustrates a vessel 2700 having one or more recessed portions that protrude into the one or more side walls in a position that is substantially proximate to the bottom of the body portion of the vessel. In some embodiments, a vessel 2700 may include one or more recessed portions 2750 that protrude into the one or more side walls in a position that is substantially proximate to the bottom of the body portion 2710 of the vessel 2700. In some embodiments, a vessel 2700 may include one or more recessed portions 2750 that protrude into the one or more side walls in a position that is substantially opposite to the position of one or more sealed handles 2740. In some embodiments, a vessel 2700 may include one or more recessed portions 2750 that protrude into the one or more side walls to create a grasping structure. In some embodiments, a vessel 2700 may include one or more recessed portions 2750 that protrude into the one or more side walls to create a grasping structure that a worker can use to assist in lifting the vessel 2700. In some embodiments, a vessel 2700 may include one or more recessed portions 2750 that protrude into the one or more side walls to create a recessed portion 2750 with a vertical overhang.

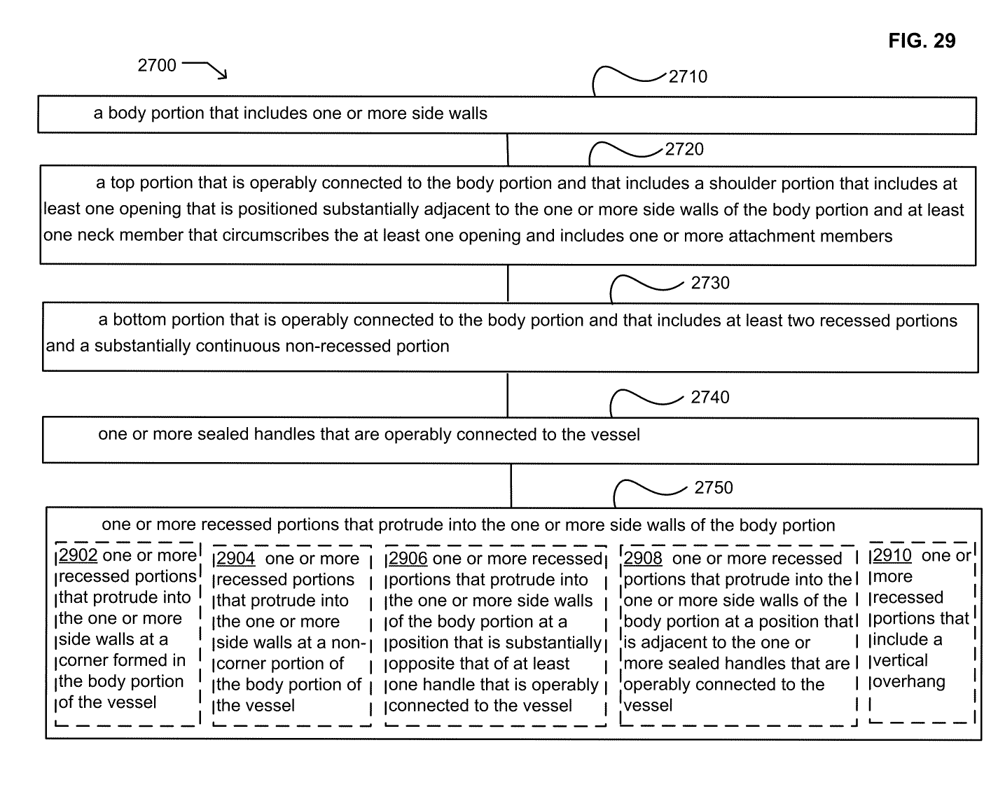

FIG. 29 illustrates example embodiments of a vessel 2700. Additional embodiments may include an embodiment 2902, an embodiment 2904, an embodiment 2906, an embodiment 2908, and/or an embodiment 2910.

Embodiment 2902 illustrates a vessel 2700 having one or more recessed portions that protrude into the one or more side walls at a corner formed in the body portion of the vessel. In some embodiments, a vessel 2700 may include one or more recessed portions 2750 that protrude into the one or more side walls at a corner formed in the body portion of the vessel 2700. In some embodiments, one or more recessed portions may be positioned adjacent to one or more sealed handles. In some embodiments, one or more recessed portions may be configured to serve as a grasping point for a worker to grasp the vessel.

Embodiment 2904 illustrates a vessel 2700 having one or more recessed portions that protrude into the one or more side walls at a non-corner portion of the body portion of the vessel. In some embodiments, a vessel 2700 may include one or more recessed portions 2750 that protrude into the one or more side walls at a non-corner portion of the body portion 2710 of the vessel 2700. In some embodiments, a vessel 2700 may include one or more recessed portions 2750 that protrude into the one or more side walls in a position that is substantially opposite to the position of one or more sealed handles 2740. In some embodiments, a vessel 2700 may include one or more recessed portions 2750 that protrude into the one or more side walls to create a grasping structure. In some embodiments, a vessel 2700 may include one or more recessed portions 2750 that protrude into the one or more side walls to create a grasping structure that a worker can use to assist in lifting the vessel 2700. In some embodiments, a vessel 2700 may include one or more recessed portions 2750 that protrude into the one or more side walls to create a recessed portion 2750 with a vertical overhang.

Embodiment 2906 illustrates a vessel 2700 having one or more recessed portions that protrude into the one or more side walls of the body portion at a position that is substantially opposite that of at least one handle that is operably connected to the vessel. In some embodiments, a vessel 2700 may include one or more recessed portions 2750 that protrude into the one or more side walls of the body portion 2710 at a position that is substantially opposite that of at least one handle that is operably connected to the vessel 2700. In some embodiments, a vessel 2700 may include one or more recessed portions 2750 that protrude into the one or more side walls to create a grasping structure. In some embodiments, a vessel 2700 may include one or more recessed portions 2750 that protrude into the one or more side walls to create a grasping structure that a worker can use to assist in lifting the vessel 2700. In some embodiments, a vessel 2700 may include one or more recessed portions 2750 that protrude into the one or more side walls to create a recessed portion 2750 with a vertical overhang.

Embodiment 2908 illustrates a vessel 2700 having one or more recessed portions that protrude into the one or more side walls of the body portion at a position that is adjacent to the one or more sealed handles that are operably connected to the vessel. In some embodiments, a vessel 2700 may include one or more recessed portions 2750 that protrude into the one or more side walls of the body portion 2710 at a position that is adjacent to the one or more sealed handles 2740 that are operably connected to the vessel 2700. Accordingly, in some embodiments, a recessed portion 2750 may be positioned in a position on the vessel 2700 that is interior to the handle to allow the fingers of a person grasping the handle to occupy a recessed portion.

Embodiment 2910 illustrates a vessel 2700 having one or more recessed portions that include a vertical overhang. In some embodiments, a vessel 2700 may include one or more recessed portions 2750 that include a vertical overhang. Accordingly, in some embodiments, a recessed portion 2750 may be configured to have a vertical overhang that allows the recessed portion 2750 to be used by a worker to grasp the vessel 2700.

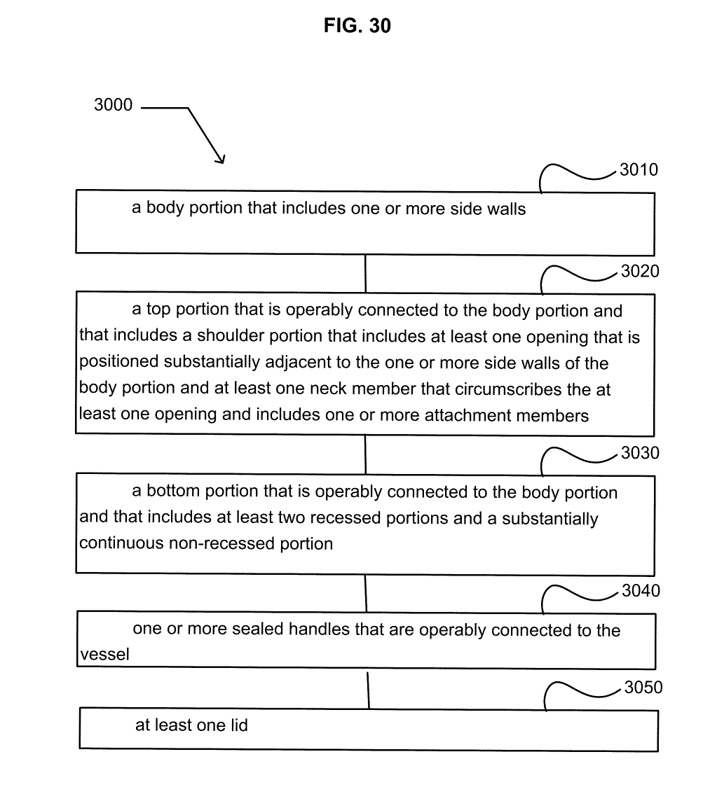

FIG. 30 and the following figures illustrate various embodiments of vessels 3000, discussion and explanation with respect to the above-described embodiment of FIG. 16 with the addition of at least one lid 3050, and/or with respect to other alternative embodiments and contexts. However, it should be understood that a vessel 3000 may have numerous configurations and/or be a modified version of FIGS. 16 and/or 30. Also, although various embodiments are presented in the figures, it should be understood that a vessel 3000 may have a configuration that is other than those which are illustrated.

FIG. 30 illustrates an example vessel 3000 in which embodiments may be implemented. A vessel 3000 includes a body portion 3010. In some embodiments, the body portion 3010 may be formed from a single side wall. In some embodiments, the body portion 3010 may be formed from two or more side walls. For example, in some embodiments, a vessel 3000 may include two or more side walls that include an air space between the two or more side walls. In some embodiments, a vessel 3000 may include two or more side walls that include insulation between the two or more side walls. In some embodiments, a vessel 3000 may include two or more side walls that include a vacuum between the two or more side walls. In some embodiments, a vessel 3000 may include two or more side walls that include a phase change material between the two or more side walls. In some embodiments, a vessel 3000 may include one or more walls that separate the interior of the vessel into two or more chambers.

A vessel 3000 includes a top portion 3020 that is operably connected to the body portion 3010. In some embodiments, a vessel 3000 may include a top portion that is operably connected to the body portion and that includes a shoulder portion that includes at least one opening that is positioned substantially adjacent to one or more side walls of the body portion. The top portion 3020 includes at least one neck member that circumscribes the at least one opening. The opening may be constructed to have numerous sizes. For example, in some embodiments, the size of the opening may be great enough to allow a person to insert their hand through the opening to access the interior of the vessel 3000. In some embodiments, the neck member may optionally include one or more attachment members. The neck member may optionally include numerous types of attachment members. Examples, of such attachment members include, but are not limited to, threads, lugs, compression fittings, ridges, and the like. In some embodiments, a neck member may include transverse members that protrude from the neck member. In some embodiments, a neck member may include a friction fitting. In some embodiments, a neck member may include one or more insets that are configured to receive one or more protruding members. Accordingly, a neck member may include numerous types of attachment members.

A vessel 3000 includes a bottom portion 3030 that is operably connected to the body portion 3010. The bottom portion 3030 includes at least two recessed portions and a substantially continuous non-recessed portion. In some embodiments, the at least two recessed portions are configured to accept the neck portion of another vessel 3000. In some embodiments, the two or more recessed portions are each configured to accept a neck portion that is attached to a lid of another vessel. Accordingly, in some embodiments, a top vessel 3000 may be stacked on top of a lower vessel with one or more necks and lids of the lower vessel being accepted into the two or more recessed portions of the top vessel 3000. In some embodiments, a vessel 3000 may include a substantially continuous non-recessed portion. The substantially continuously non-recessed portion may circumscribe the two or more recessed portions of the bottom portion 3030 of the vessel 3000. Accordingly, in some embodiments, a top vessel 3000 may be stacked on top of a lower vessel such that one or more necks and attached lids of the lower vessel are accepted into the two or more recessed portions in the bottom portion 3030 of the top vessel 3000 and the substantially continuous non-recessed portion of the top vessel 3000 substantially continuously rests on the shoulder portion of the lower vessel.

A vessel 3000 includes one or more sealed handles 3040 that are operably coupled to the vessel 3000. The sealed handles 3040 are sealed on both ends of the handle such that the interior of the handle is isolated from the interior portion of the body of the vessel 3000. Accordingly, in some embodiments, fluid is unable to flow from the interior of the body of the vessel 3000 into a sealed handle 3040 that is coupled to the vessel 3000. In some embodiments, a sealed handle 3040 is attached to the vessel 3000 with one end of the sealed handle 3040 being coupled to the shoulder of the top portion 3020 of the vessel 3000 and the other end being coupled to a side wall of the vessel 3000. In some embodiments, a sealed handle 3040 is attached to the vessel 3000 with one end of the sealed handle 3040 being coupled to the side wall of the vessel 3000 and the other end being coupled to a side wall of the vessel 3000. In some embodiments, a sealed handle 3040 may extend beyond the outline of the body portion 3010 of a vessel 3000 to which it is attached. In some embodiments, a sealed handle 3040 may not extend beyond the outline of the body portion 3010 of a vessel 3000 to which it is attached. Accordingly, in some embodiments, a sealed handle 3040 may be attached to a vessel 3000 such that the overall outline of the vessel 3000 is maintained.

In some embodiments, a vessel 3000 may include a lid 3050. In some embodiments, a vessel 3000 may include a lid 3050 that is connected to the vessel 3000. A lid 3050 may be connected to a vessel 3000 in numerous ways. In some embodiments, a lid 3050 may be connected to a vessel 3000 through a tether. In some embodiments, a lid 3050 may be connected to a vessel 3000 through a hinge. In some embodiments, a lid 3050 may be connected to a vessel 3000 through a pivoting member that allows the lid 3050 to be laterally rotated away from the opening of the vessel 3000.

The following figure descriptions include various embodiments of vessels 3000, discussion and explanation with respect to other alternative embodiments and contexts. However, it should be understood that a vessel 3000 may have numerous configurations and modifications. Also, although various embodiments are presented in the figures, it should be understood that a vessel 3000 may have a configuration that is other than those which are illustrated.

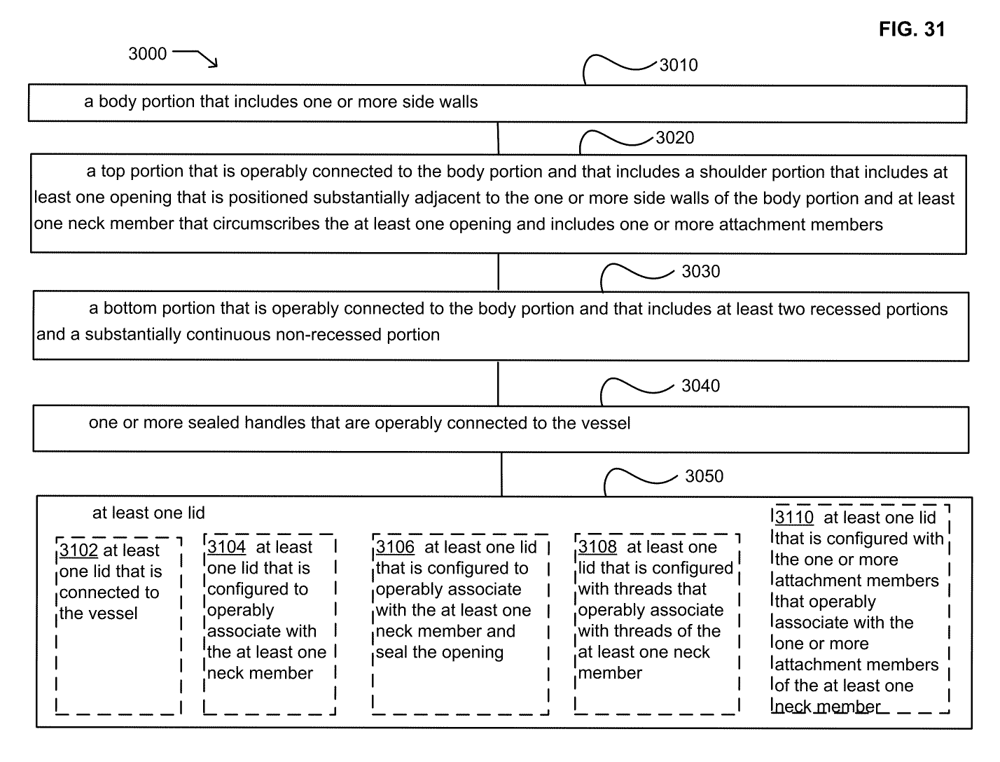

FIG. 31 illustrates example embodiments of a vessel 3000. Additional embodiments may include an embodiment 3102, an embodiment 3104, an embodiment 3106, an embodiment 3108, and/or an embodiment 3110.

Embodiment 3102 illustrates a vessel 3000 having at least one lid that is connected to the vessel. In some embodiments, a vessel 3000 may include a lid 3050 that is connected to the vessel 3000. A lid 3050 may be connected to a vessel 3000 in numerous ways. In some embodiments, a lid 3050 may be connected to a vessel 3000 through a tether. In some embodiments, a lid 3050 may be connected to a vessel 3000 through a hinge. In some embodiments, a lid 3050 may be connected to a vessel 3000 through a pivoting member that allows the lid 3050 to be laterally rotated away from the opening of the vessel 3000.

Embodiment 3104 illustrates a vessel 3000 having at least one lid that is configured to operably associate with the at least one neck member. In some embodiments, a vessel 3000 may include a lid 3050 that is configured to operably associate with the neck member and seal the substantially centrally defined opening. In some embodiments, a lid 3050 may be threaded so that it will screw down on a threaded neck member and seal an opening in a vessel 3000. In some embodiments, a lid 3050 may include a compression fitting that it compress on a neck member and seal an opening in a vessel 3000. In some embodiments, a lid 3050 may include a gasket that will compress on a neck member and seal an opening in a vessel 3000. Accordingly, a lid 3050 may have numerous configurations that allow the lid 3050 to seal an opening in the vessel 3000.

Embodiment 3106 illustrates a vessel 3000 having at least one lid that is configured to operably associate with the at least one neck member and seal the opening. In some embodiments, a vessel 3000 may include a lid 3050 that is configured to operably associate with the at least one neck member and seal the opening. In some embodiments, a lid 3050 may be threaded so that it will screw down on a threaded neck member and seal an opening in a vessel 3000. In some embodiments, a lid 3050 may include a compression fitting that it compress on a neck member and seal an opening in a vessel 3000. In some embodiments, a lid 3050 may include a gasket that will compress on a neck member and seal an opening in a vessel 3000. Accordingly, a lid 3050 may have numerous configurations that allow the lid 3050 to seal an opening in the vessel 3000.

Embodiment 3108 illustrates a vessel 3000 having at least one lid that is configured with threads that operably associate with threads of the at least one neck member. In some embodiments, a vessel 3000 may include a lid 3050 that is configured with threads that operably associate with threads of the at least neck member.

Embodiment 3110 illustrates a vessel 3000 having at least one lid that is configured with the one or more attachment members that operably associate with the one or more attachment members of the at least one neck member. In some embodiments, a vessel 3000 may include a lid 3050 that is configured with the one or more attachment members that operably associate with the one or more attachment members of the at least one neck member. A lid 3050 may include numerous types of attachment members. In some embodiments, a lid 3050 may include one or more substantially transverse rods that insert into one or more cavities in the neck member. In some embodiments, a lid 3050 may include one or more cavities that accept one or more substantially transverse rods that are associated with the neck member. In some embodiments, a lid 3050 may include one or more compression rings that squeeze onto a neck member of a vessel 3000. In some embodiments, a lid 3050 may be constructed from elastomeric material that stretches over the neck member on a vessel 3000. Accordingly, a lid may include numerous types of attachment members.

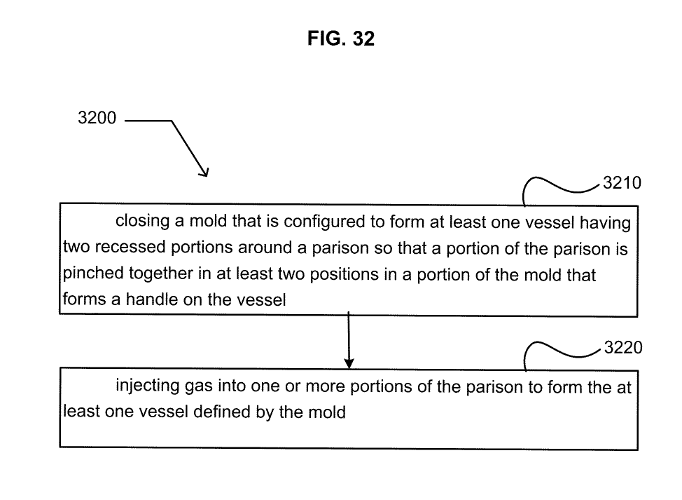

FIG. 32 illustrates an operational flow 3200. Operational flow 3200 includes a closing operation 3210 that involves closing a mold that is configured to form at least one vessel having two recessed portions around a parison so that a portion of the parison is pinched together in at least two positions in a portion of the mold that forms a handle on the vessel. In some embodiments, a process may include closing a mold that is configured to form at least one vessel having two recessed portions around a parison so that a portion of the parison is pinched together in at least two positions in a portion of the mold that forms a handle on the vessel. In some embodiments, the mold is configured so that a gap left in the mold that forms the pinch point at either end of a handle when the mold is fully closed is approximately twice the wall thickness of the parison. Molds may be configured that produce handles having numerous thicknesses at a pinch point on a handle. An extruded parison wall thickness may be controlled by the extruder die head tooling. As the molten material is extruded, the die head opening may be programmed to partially open and close, resulting in axial variation of the parison wall thickness. The parison wall thickness may be controlled radially by differentially opening and closing sections of the die head along its circumference. In some embodiments, a parison may be a preformed blank.

Operational flow 3200 includes an injecting operation 3220 that involves injecting gas into one or more portions of the parison to form the at least one vessel defined by the mold. In some embodiments, a process may include injecting gas into one or more portions of the parison to form the at least one vessel defined by the mold. In some embodiments, gas may be blown into the parison through one or more blow pins. In some embodiments, one or more blow pins may be inserted into the parison before the mold is closed. In some embodiments, one or more blow pins may be inserted into the parison after the mold is closed. Numerous types of gas may be injected into the parison. In some embodiments, air is injected into the parison. In some embodiments, a gas is injected into the parison that is non-reactive with the material making up the parison.

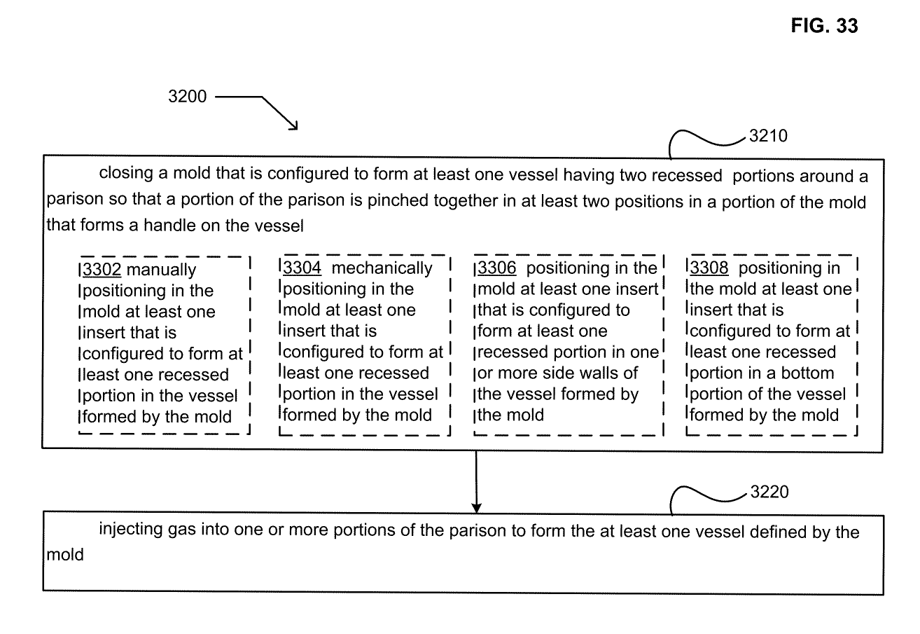

FIG. 33 illustrates alternative embodiments of the example operational flow 3200 of FIG. 32. FIG. 33 illustrates example embodiments where the closing operation 3210 may include at least one additional operation. Additional operations may include an operation 3302, an operation 3304, an operation 3306, and/or an operation 3308.

At operation 3302, operation 3210 may include manually positioning in the mold at least one insert that is configured to form at least one recessed portion in the vessel formed by the mold. In some embodiments, a process may include manually positioning in the mold at least one insert that is configured to form at least one recessed portion in the vessel formed by the mold. For example, one or more inserts may be manually positioned at the bottom of a mold that create one or more recessed portions in the bottom portion of a vessel defined by the mold.

At operation 3304, operation 3210 may include mechanically positioning in the mold at least one insert that is configured to form at least one recessed portion in the vessel formed by the mold. In some embodiments, a process may include mechanically positioning in the mold at least one insert that is configured to form at least one recessed portion in the vessel formed by the mold. For example, one or more inserts may be mechanically positioned at the bottom of a mold that create one or more recessed portions in the bottom portion of a vessel defined by the mold. In some embodiments, inserts may be positioned through use of hydraulics.

At operation 3306, operation 3210 may include positioning in the mold at least one insert that is configured to form at least one recessed portion in one or more side walls of the vessel formed by the mold. In some embodiments, a process may include positioning in the mold at least one insert that is configured to form at least one recessed portion in one or more side walls of the vessel formed by the mold. For example, one or more inserts may be positioned on the side of a mold that create one or more recessed portions in one or more side walls of a vessel defined by the mold.

At operation 3308, operation 3210 may include positioning in the mold at least one insert that is configured to form at least one recessed portion in a bottom portion of the vessel formed by the mold. In some embodiments, a process may include positioning in the mold at least one insert that is configured to form at least one recessed portion in a bottom portion of the vessel formed by the mold. For example, one or more inserts may be positioned at the bottom of a mold that create one or more recessed portions in the bottom portion of a vessel defined by the mold.

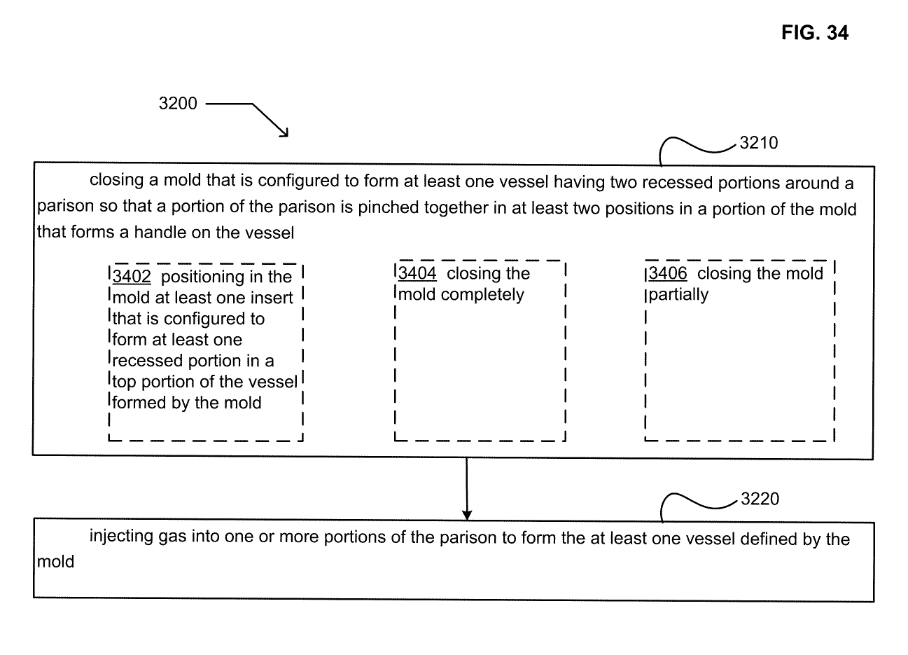

FIG. 34 illustrates alternative embodiments of the example operational flow 3200 of FIG. 32. FIG. 34 illustrates example embodiments where the closing operation 3210 may include at least one additional operation. Additional operations may include an operation 3402, an operation 3404, and/or an operation 3406.

At operation 3402, operation 3210 may include positioning in the mold at least one insert that is configured to form at least one recessed portion in a top portion of the vessel formed by the mold. In some embodiments, a process may include positioning in the mold at least one insert that is configured to form at least one recessed portion in a top portion of the vessel formed by the mold. For example, one or more inserts may be positioned at the top of a mold that create one or more recessed portions in the top portion of a vessel defined by the mold.

At operation 3404, operation 3210 may include closing the mold completely. In some embodiments, a process may include closing the mold completely. In some embodiments, a mold may be closed completely before gas is injected into the parison. In some embodiments, a mold is configured such that closing the mold on a parison will pinch a portion of the parison material that will form a closed handle. In some embodiments, a mold will be configured to pinch a portion of the parison that will form a handle such that both ends of the handle are completely filled with parison material. Accordingly, in some embodiments when gas is injected into a portion of the mold that will form a handle, a hollow handle having ends that are completely closed is formed.

At operation 3406, operation 3210 may include closing the mold partially. In some embodiments, a process may include closing the mold partially. In some embodiments, a mold may be partially closed when gas is injected into the parison. In some embodiments, a mold is configured such that a vessel is partially formed in the partially closed mold and then the mold may be completely closed to pinch a portion of the material forming the partial vessel to form a completed vessel. For example, a hollow handle having two open ends may be initially formed in the partially closed mold and then the mold may be closed to pinch the ends of the handle portion to create a hollow handle that is closed on both ends.

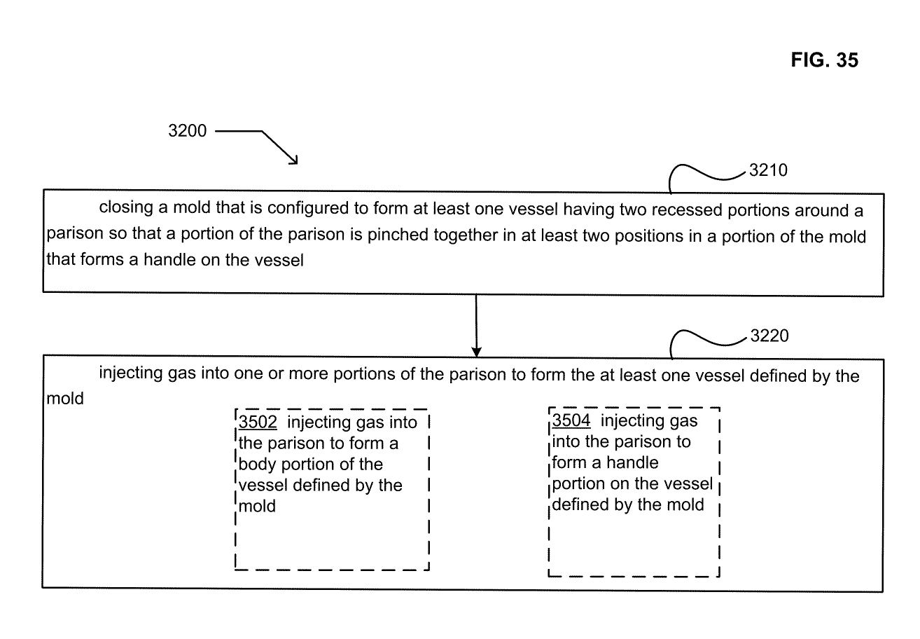

FIG. 35 illustrates alternative embodiments of the example operational flow 3200 of FIG. 32. FIG. 35 illustrates example embodiments where the injecting operation 3220 may include at least one additional operation. Additional operations may include an operation 3502, and/or an operation 3504.

At operation 3502, operation 3220 may include injecting gas into the parison to form a body portion of the vessel defined by the mold. In some embodiments, a process may include injecting gas into the parison to form at least one body portion of the vessel defined by the mold. In some embodiments, gas may be injected into a portion of the parison that will form the body portion of the vessel. In some embodiments, gas may be injected into a portion of the parison that will form the body portion of the vessel and not injected into a portion of the parison that will form a handle. In some embodiments, gas may be injected into a portion of the parison that will form the body portion of the vessel and gas may also be injected into a portion of the parison that will form a handle.

At operation 3504, operation 3220 may include injecting gas into the parison to form a handle portion on the vessel defined by the mold. In some embodiments, a process may include injecting gas into the parison to form a handle portion on the vessel defined by the mold. In some embodiments, a blow needle may be inserted into a portion of the parison that is contained within a portion of a mold that is configured to create a handle on a vessel. Gas may then be injected into the portion of the parison that will form the handle to create a hollow handle.

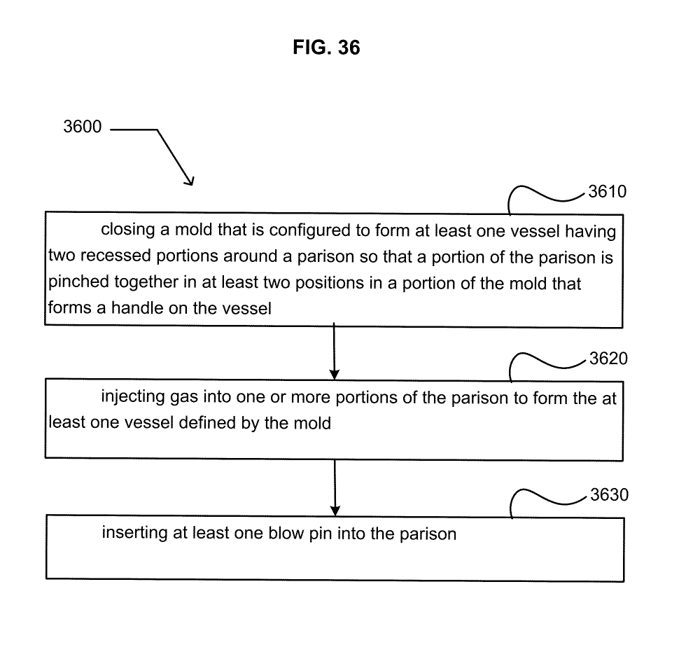

FIG. 36 illustrates an operational flow 3600. Operational flow 3600 includes a closing operation 3610 that involves closing a mold that is configured to form at least one vessel having two recessed portions around a parison so that a portion of the parison is pinched together in at least two positions in a portion of the mold that forms a handle on the vessel. In some embodiments, a process may include closing a mold that is configured to form at least one vessel having two recessed portions around a parison so that a portion of the parison is pinched together in at least two positions in a portion of the mold that forms a handle on the vessel. In some embodiments, the mold is configured so that a gap left in the mold that forms the pinch point at either end of a handle when the mold is fully closed is approximately twice the wall thickness of the parison. Molds may be configured that produce handles having numerous thicknesses at a pinch point on a handle.

Operational flow 3600 includes an injecting operation 3620 that involves injecting gas into one or more portions of the parison to form the at least one vessel defined by the mold. In some embodiments, a process may include injecting gas into one or more portions of the parison to form the at least one vessel defined by the mold. In some embodiments, gas may be blown into the parison through one or more blow pins. In some embodiments, one or more blow pins may be inserted into the parison before the mold is closed. In some embodiments, one or more blow pins may be inserted into the parison after the mold is closed. Numerous types of gas may be injected into the parison. In some embodiments, air is injected into the parison. In some embodiments, a gas is injected into the parison that is non-reactive with the material making up the parison.

Operational flow 3600 includes an inserting operation 3630 that involves inserting at least one blow pin into the parison. In some embodiments, a process may include inserting at least one blow pin into the parison. In some embodiments, a parison may be extruded around a blow pin that is positioned within a mold. In some embodiments, a parison may be extruded and then a blow pin may be positioned within the parison within a mold. In some embodiments, a blow pin may be inserted into an extruded parison that is within an open mold. In some embodiments, a blow pin may be inserted into an extruded parison that is within a closed mold.

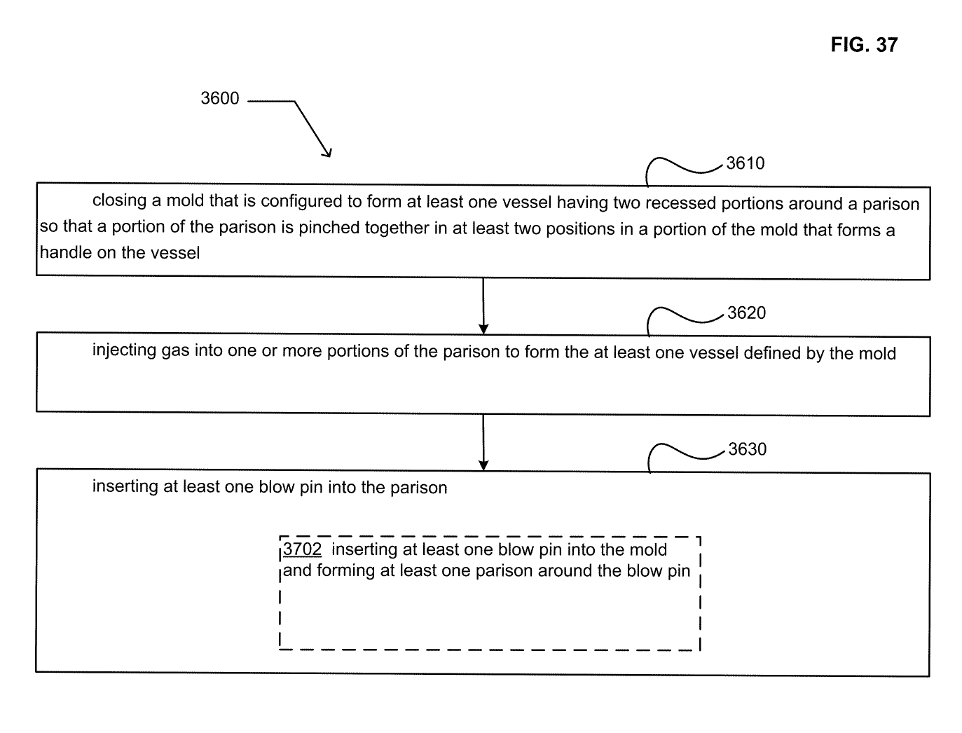

FIG. 37 illustrates alternative embodiments of the example operational flow 3600 of FIG. 36. FIG. 37 illustrates example embodiments where the inserting operation 3630 may include at least one additional operation. Additional operations may include an operation 3702.

At operation 3702, operation 3630 may include inserting at least one blow pin into the mold and forming at least one parison around the blow pin. In some embodiments, a process may include inserting at least one blow pin into the mold and forming at least one parison around the blow pin. In some embodiments, a parison is formed around the blow pin within an open mold. In some embodiments, a parison is formed around the blow pin within a closed mold.

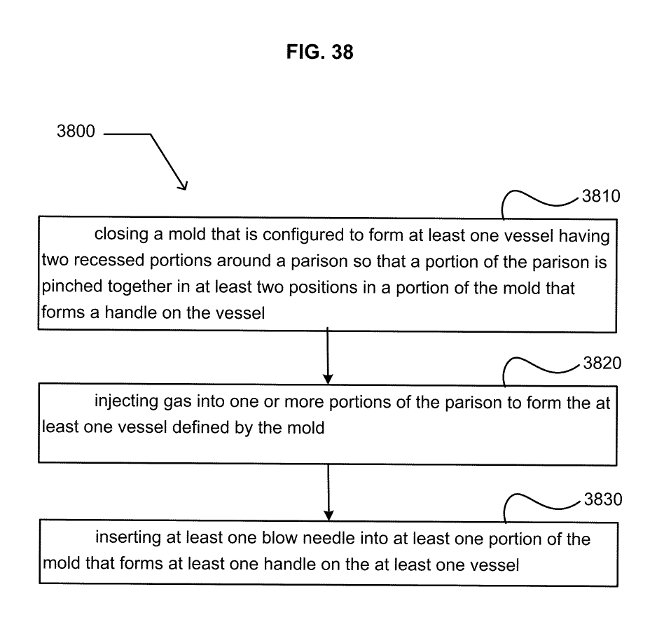

FIG. 38 illustrates an operational flow 3800. Operational flow 3800 includes a closing operation 3810 that involves closing a mold that is configured to form at least one vessel having two recessed portions around a parison so that a portion of the parison is pinched together in at least two positions in a portion of the mold that forms a handle on the vessel. In some embodiments, a process may include closing a mold that is configured to form at least one vessel having two recessed portions around a parison so that a portion of the parison is pinched together in at least two positions in a portion of the mold that forms a handle on the vessel. In some embodiments, the mold is configured so that a gap left in the mold that forms the pinch point at either end of a handle when the mold is fully closed is approximately twice the wall thickness of the parison. Molds may be configured that produce handles having numerous thicknesses at a pinch point on a handle.

Operational flow 3800 includes an injecting operation 3820 that involves injecting gas into one or more portions of the parison to form the at least one vessel defined by the mold. In some embodiments, a process may include injecting gas into one or more portions of the parison to form the at least one vessel defined by the mold. In some embodiments, gas may be blown into the parison through one or more blow pins. In some embodiments, one or more blow pins may be inserted into the parison before the mold is closed. In some embodiments, one or more blow pins may be inserted into the parison after the mold is closed. Numerous types of gas may be injected into the parison. In some embodiments, air is injected into the parison. In some embodiments, a gas is injected into the parison that is non-reactive with the material making up the parison.

Operational flow 3800 includes an inserting operation 3830 that involves inserting at least one blow needle into at least one portion of the mold that forms at least one handle on the at least one vessel. In some embodiments, a process may include inserting at least one blow needle into one or more portions of the mold that forms at least one handle on the at least one vessel. In some embodiments, a blow needle may be inserted into a portion of a parison that is contained within a portion of the mold that is configured to create a close ended hollow handle. Gas may be injected through the blow needle into the parison contained within the handle portion to create a hollow handle.

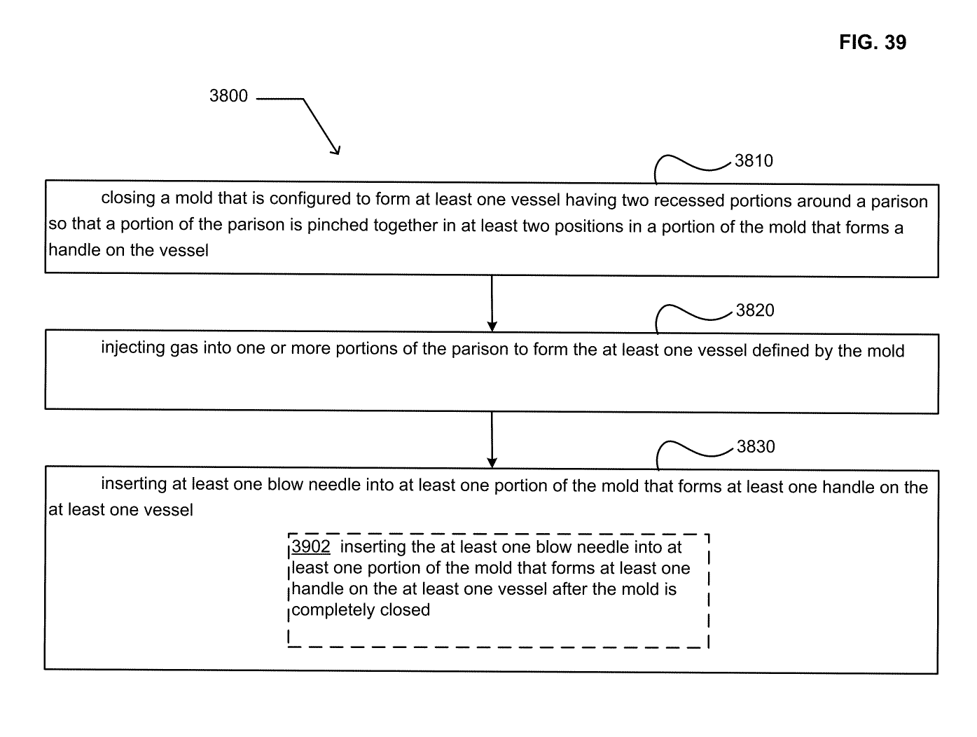

FIG. 39 illustrates alternative embodiments of the example operational flow 3800 of FIG. 38. FIG. 39 illustrates example embodiments where the inserting operation 3830 may include at least one additional operation. Additional operations may include an operation 3902.

At operation 3902, operation 3830 may include inserting the at least one blow needle into at least one portion of the mold that forms at least one handle on the at least one vessel after the mold is completely closed. In some embodiments, a process may include inserting the at least one blow needle into at least one portion of the mold that forms at least one handle on the at least one vessel after the mold is completely closed.

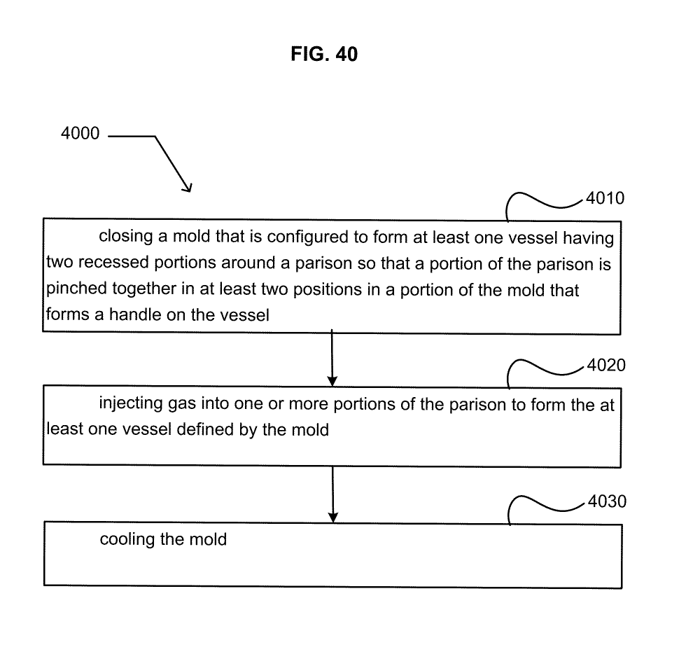

FIG. 40 illustrates an operational flow 4000. Operational flow 4000 includes a closing operation 4010 that involves closing a mold that is configured to form at least one vessel having two recessed portions around a parison so that a portion of the parison is pinched together in at least two positions in a portion of the mold that forms a handle on the vessel. In some embodiments, a process may include closing a mold that is configured to form at least one vessel having two recessed portions around a parison so that a portion of the parison is pinched together in at least two positions in a portion of the mold that forms a handle on the vessel. In some embodiments, the mold is configured so that a gap left in the mold that forms the pinch point at either end of a handle when the mold is fully closed is approximately twice the wall thickness of the parison. Molds may be configured that produce handles having numerous thicknesses at a pinch point on a handle.

Operational flow 4000 includes an injecting operation 4020 that involves injecting gas into one or more portions of the parison to form the at least one vessel defined by the mold. In some embodiments, a process may include injecting gas into one or more portions of the parison to form the at least one vessel defined by the mold. In some embodiments, gas may be blown into the parison through one or more blow pins. In some embodiments, one or more blow pins may be inserted into the parison before the mold is closed. In some embodiments, one or more blow pins may be inserted into the parison after the mold is closed. Numerous types of gas may be injected into the parison. In some embodiments, air is injected into the parison. In some embodiments, a gas is injected into the parison that is non-reactive with the material making up the parison.

Operational flow 4000 includes a cooling operation 4030 that involves cooling the mold. In some embodiments, a process may include cooling the mold. Numerous methods may be used to cool a mold. For example, in some embodiments, fluid may be circulated through channels in the mold to cool the mold. In some embodiments, gas may be circulated through channels in the mold to cool the mold. In some embodiments, liquefied gas may be circulated through channels in the mold to cool the mold.

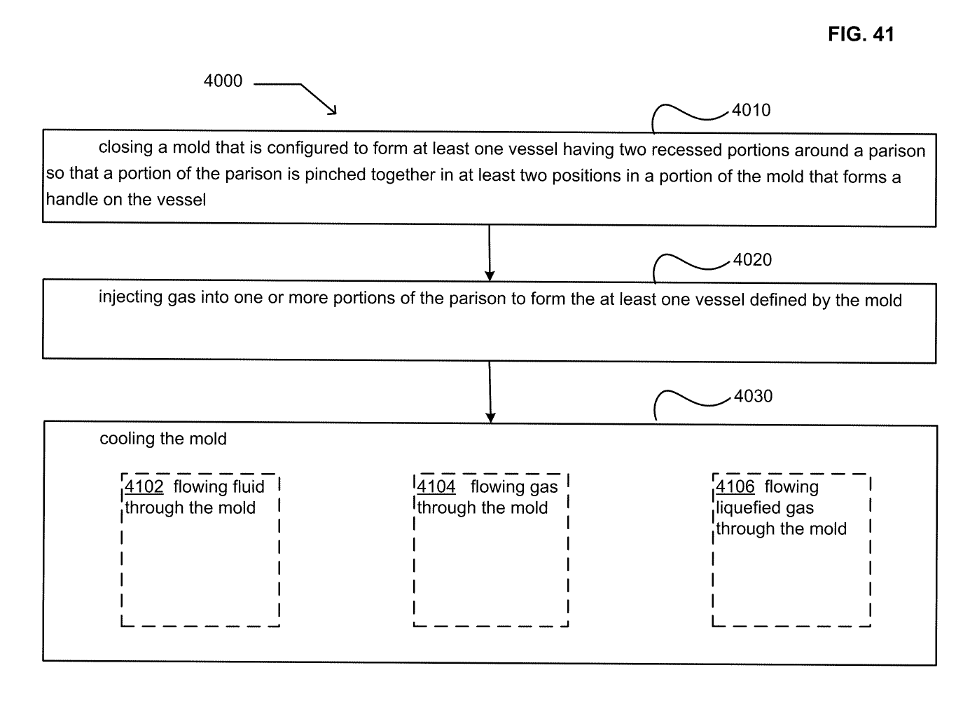

FIG. 41 illustrates alternative embodiments of the example operational flow 4000 of FIG. 40. FIG. 41 illustrates example embodiments where the cooling operation 4030 may include at least one additional operation. Additional operations may include an operation 4102, an operation 4104, and/or an operation 4106.

At operation 4102, operation 4030 may include flowing fluid through the mold. In some embodiments, a process may include flowing fluid through the mold. Numerous types of fluids and combinations of fluids may be used to cool a mold and are commercially available (e.g., Dimplex Thermal Solutions, 2625 Emerald Drive, Kalamazoo, Mich. 49001-4542).

At operation 4104, operation 4030 may include flowing gas through the mold. In some embodiments, a process may include flowing gas through the mold. Numerous types of gases and combinations of gases may be used to cool a mold. Examples of such gases include, but are not limited to, Freon, carbon dioxide, and the like.

At operation 4106, operation 4030 may include flowing liquefied gas through the mold. In some embodiments, a process may include flowing liquefied gas through the mold. Numerous types of gases and combinations of gases may be used to cool a mold. Examples of such gases include, but are not limited to, liquid oxygen, liquid helium, liquid nitrogen, and the like.

FIG. 42A illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes a substantially centrally defined recessed portion 4220 (not shown) and a substantially continuous non-recessed portion 4222 (not shown). The vessel 4200 also includes two sealed handles 4216 that are operably connected to the vessel 4200.

FIG. 42B illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200.

FIG. 42C illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes a substantially centrally defined recessed portion 4220 (not shown) and a substantially continuous non-recessed portion 4222 (not shown). The vessel 4200 also includes two sealed handles 4216 that are operably connected to the vessel 4200. The vessel 4200 also includes a lid 4224 that is coupled to the neck member 4212.

FIG. 42D illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200.

FIG. 42E illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200.

FIG. 42F illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and an opening 4210 with a neck member 4212 that circumscribes the opening 4210. The vessel 4200 also includes a bottom portion 4214 that is operably connected to the body portion 4202 and that includes two recessed portions 4220 (not shown) and a substantially continuous non-recessed portion 4222 (not shown). The vessel 4200 also includes two sealed handles 4216 that are operably connected to the vessel 4200. The vessel 4200 also includes a protuberance 4226 that extends away from the top portion of the vessel 4200.

FIG. 42G illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and an opening 4210 (not shown) with a neck member 4212 that circumscribes the opening 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 (one shown) that are operably connected to the vessel 4200. The vessel 4200 also includes a wall 4240 that separates the vessel cavity into two separate chambers.

FIG. 42H illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200.

FIG. 42I illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 (not shown) with neck members 4212 (not shown) that circumscribes the openings 4210. The vessel 4200 also includes a bottom portion 4214 that is operably connected to the body portion 4202 and that includes two recessed portions 4220 (not shown) and a substantially continuous non-recessed portion 4222 (not shown). The vessel 4200 also includes two sealed handles 4216 that are operably connected to the vessel 4200. Also shown are two non-similar vessels 4228 that are stacked on top of vessel 4200.

FIG. 42J illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200. Also shown are two non-similar vessels 4228 that are stacked on top of vessel 4200.

FIG. 42K illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200. Also shown are two non-similar vessels 4228 that are stacked on top of vessel 4200.

FIG. 42L illustrates a vessel 4200. The vessel 4200 includes a body portion 4202 that includes at least one side wall 4204. The vessel 4200 also includes a top portion 4206 that is operably connected to the body portion 4202 and that includes a shoulder portion 4208 and two openings 4210 with neck members 4212 that circumscribes the openings 4210. The vessel 4200 also includes a bottom portion 4214 that is operably connected to the body portion 4202 and that includes two recessed portions 4220 and a substantially continuous non-recessed portion 4222. The vessel 4200 also includes two sealed handles 4216 that are operably connected to the vessel 4200. Also shown is a vessel 4200 that is stacked on top of vessel 4200.

FIG. 43A illustrates a vessel 4300. The vessel 4300 includes a body portion 4302 that includes at least one side wall 4304. The vessel 4300 also includes a top portion 4306 that is operably connected to the body portion 4302 and that includes a shoulder portion 4308 and two openings 4310 with neck members 4312 that circumscribes the openings 4310. The vessel 4300 also includes a bottom portion 4314 that is operably connected to the body portion 4302 and that includes two recessed portions 4320 (not shown) and a substantially continuous non-recessed portion 4322 (not shown). The vessel 4300 also includes a sealed handle 4316 that is operably connected to the vessel 4300. Also shown is a recessed portion 4330 in a side wall of the vessel 4300. The vessel 4300 also includes a wall 4340 that separates the cavity of the vessel 4300 into two separate chambers.

FIG. 43B illustrates a vessel 4300. The vessel 4300 includes a body portion 4302 that includes at least one side wall 4304. The vessel 4300 also includes a top portion 4306 that is operably connected to the body portion 4302 and that includes a shoulder portion 4308 and two openings 4310 with neck members 4312 that circumscribes the openings 4310. The vessel 4300 also includes a bottom portion 4314 that is operably connected to the body portion 4302 and that includes two recessed portions 4320 and a substantially continuous non-recessed portion 4322. The vessel 4300 also includes a sealed handle 4316 that is operably connected to the vessel 4300. Also shown is a recessed portion 4330 in a side wall of the vessel 4300.

FIG. 43C illustrates a vessel 4300. The vessel 4300 includes a body portion 4302 that includes at least one side wall 4304. The vessel 4300 also includes a top portion 4306 that is operably connected to the body portion 4302 and that includes a shoulder portion 4308 and two openings 4310 with neck members 4312 that circumscribes the openings 4310. The vessel 4300 also includes a bottom portion 4314 that is operably connected to the body portion 4302 and that includes two recessed portions 4320 and a substantially continuous non-recessed portion 4322. The vessel 4300 also includes a sealed handle 4316 that is operably connected to the vessel 4300. Also shown is a recessed portion 4330 in a side wall of the vessel 4300.

FIG. 43D illustrates a vessel 4300. The vessel 4300 includes a body portion 4302 that includes at least one side wall 4304. The vessel 4300 also includes a top portion 4306 that is operably connected to the body portion 4302 and that includes a shoulder portion 4308 and an opening 4310 with a neck member 4312 that circumscribes the opening 4310. The vessel 4300 also includes a bottom portion 4314 that is operably connected to the body portion 4302 and that includes two recessed portions 4320 and a substantially continuous non-recessed portion 4322. The vessel 4300 also includes a sealed handle 4316 that is operably connected to the vessel 4300. Also shown is a recessed portion 4330 in a side wall of the vessel 4300. The vessel 4300 is shown stacked on top of two non-similar vessels 4328.

FIG. 43E illustrates a vessel 4300. The vessel 4300 includes a body portion 4302 that includes at least one side wall 4304. The vessel 4300 also includes a top portion 4306 that is operably connected to the body portion 4302 and that includes a shoulder portion 4308 and an opening 4310 with a neck member 4312 that circumscribes the opening 4310. The vessel 4300 also includes a bottom portion 4314 that is operably connected to the body portion 4302 and that includes two recessed portions 4320 and a substantially continuous non-recessed portion 4322. The vessel 4300 also includes a sealed handle 4316 that is operably connected to the vessel 4300. Also shown is a recessed portion 4330 in a side wall of the vessel 4300. The vessel 4300 is shown stacked on top of two non-similar vessels 4328.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting. With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively ““associated”” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or ““operably coupled,”” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. A vessel comprising:
a body portion that includes one or more side walls,
a top portion that is operably connected to the body portion and that includes a shoulder portion that includes at least one opening that is positioned substantially adjacent to the one or more side walls of the body portion and at least one neck member that circumscribes the at least one opening and includes one or more attachment members,
a bottom portion that is operably connected to the body portion and that includes at least one recessed portion and a substantially continuous non-recessed portion,
one or more sealed handles that are operably connected to the vessel, and
one or more recessed portions that protrude into the one or more side walls of the body portion.

2. The vessel of claim 1, wherein the body portion that includes one or more side walls comprises:
a body portion having a substantially rectangular configuration in cross-section.

3.-9. (canceled)

10. The vessel of claim 1, wherein the body portion that includes one or more side walls comprises:
a body portion that includes two or more side walls that include one or more phase change materials between the two or more side walls.

11.-13. (canceled)

14. The vessel of claim 1, wherein the top portion that is operably connected to the body portion and that includes a shoulder portion that includes at least one opening that is positioned substantially adjacent to the one or more side walls of the body portion and at least one neck member that circumscribes the at least one opening and includes one or more attachment members comprises:
at least one neck member that includes the one or more attachment members that are threads.

15.-18. (canceled)

19. The vessel of claim 1, wherein the top portion that is operably connected to the body portion and that includes a shoulder portion that includes at least one opening that is positioned substantially adjacent to the one or more side walls of the body portion and at least one neck member that circumscribes the at least one opening and includes one or more attachment members comprises:
at least one opening that is between about 5 inches and about 8 inches in diameter.

20.-22. (canceled)

23. The vessel of claim 1, wherein the bottom portion that is operably connected to the body portion and that includes at least one recessed portion and a substantially continuous non-recessed portion comprises:
a bottom portion that includes at least one recessed portion that is configured to receive a neck member that is attached to a lid of a lower vessel so that the non-recessed portion of the bottom portion of an upper vessel substantially continuously contacts the shoulder portion of the lower vessel.

24. (canceled)

25. The vessel of claim 1, wherein the bottom portion that is operably connected to the body portion and that includes at least one recessed portion and a substantially continuous non-recessed portion comprises:
a bottom portion that includes at least two recessed portions that are configured to receive at least two neck members that are attached to one or more lids of one or more lower vessels so that the non-recessed portion of the bottom portion of an upper vessel substantially continuously contacts the shoulder portion of the one or more lower vessels.

26. The vessel of claim 1, wherein the bottom portion that is operably connected to the body portion and that includes at least one recessed portion and a substantially continuous non-recessed portion comprises:
a bottom portion that includes at least two recessed portions that are configured to receive at least two neck members that are attached to one or more lids of at least one lower vessel so that the non-recessed portion of the bottom portion of an upper vessel substantially continuously contacts the shoulder portion of the at least one lower vessel.

27.-29. (canceled)

30. The vessel of claim 1, wherein the one or more sealed handles that are operably connected to the vessel comprise:
one or more sealed handles having one end operably connected to a shoulder region of the vessel and the other end operably connected to the side wall of the vessel with the sealed handle positioned over a recessed portion and the sealed handle is configured so that it substantially retains the outline of the vessel.

31.-33. (canceled)

34. The vessel of claim 1, wherein the one or more recessed portions that protrude into the one or more side walls of the body portion comprise:
one or more recessed portions that protrude into the one or more side walls in a position that is substantially medial to the body portion of the vessel.

35.-36. (canceled)

37. The vessel of claim 1, wherein the one or more recessed portions that protrude into the one or more side walls of the body portion comprise:
one or more recessed portions that protrude into the one or more side walls at a corner formed in the body portion of the vessel.

38. The vessel of claim 1, wherein the one or more recessed portions that protrude into the one or more side walls of the body portion comprise:
one or more recessed portions that protrude into the one or more side walls at a non-corner portion of the body portion of the vessel.

39. The vessel of claim 1, wherein the one or more recessed portions that protrude into the one or more side walls of the body portion comprise:
one or more recessed portions that protrude into the one or more side walls of the body portion at a position that is substantially opposite that of at least one handle that is operably connected to the vessel.

40.-42. (canceled)

43. The vessel of claim 1, further comprising:
at least one lid.

44. The vessel of claim 43, wherein the at least one lid comprises:
at least one lid that is connected to the vessel.

45. The vessel of claim 43, wherein the at least one lid comprises:
at least one lid that is configured to operably associate with the neck member.

46.-48. (canceled)

49. A vessel comprising:
a body portion that includes one or more side walls,
a top portion that is operably connected to the body portion and that includes a shoulder portion that includes at least one opening that is positioned substantially adjacent to the one or more side walls of the body portion and at least one neck member that circumscribes the at least one opening and includes one or more attachment members,
a bottom portion that is operably connected to the body portion and that includes at least two recessed portions and a substantially continuous non-recessed portion, and
one or more sealed handles that are operably connected to the vessel.

50. The vessel of claim 49, wherein the body portion that includes one or more side walls comprises:
a body portion having a substantially rectangular configuration in cross-section.

51.-57. (canceled)

58. The vessel of claim 49, wherein the body portion that includes one or more side walls comprises:
a body portion that includes two or more side walls that include one or more phase change materials between the two or more side walls.

59.-62. (canceled)

63. The vessel of claim 49, wherein the top portion that is operably connected to the body portion and that includes a shoulder portion that includes at least one opening that is positioned substantially adjacent to the one or more side walls of the body portion and at least one neck member that circumscribes the at least one opening and includes one or more attachment members comprises:
at least one neck member that includes the one or more attachment members that are threads.

64.-67. (canceled)

68. The vessel of claim 49, wherein the top portion that is operably connected to the body portion and that includes a shoulder portion that includes at least one opening that is positioned substantially adjacent to the one or more side walls of the body portion and at least one neck member that circumscribes the at least one opening and includes one or more attachment members comprises:
at least one opening that is between about 5 inches and about 8 inches in diameter.

69.-71. (canceled)

72. The vessel of claim 49, wherein the bottom portion that is operably connected to the body portion and that includes at least two recessed portions and a substantially continuous non-recessed portion comprises:
a bottom portion that includes at least one recessed portion that is configured to receive a neck member that is attached to a lid of a lower vessel so that the non-recessed portion of the bottom portion of an upper vessel substantially continuously contacts the shoulder portion of the lower vessel.

73. The vessel of claim 49, wherein the bottom portion that is operably connected to the body portion and that includes at least two recessed portions and a substantially continuous non-recessed portion comprises:
a bottom portion that includes at least two recessed portions that are configured to receive at least two neck members that are each attached to a lid of one or more lower vessels so that the non-recessed portion of the bottom portion of an upper vessel substantially continuously contacts the one or more shoulder portions of the one or more lower vessels.

74.-78. (canceled)

79. The vessel of claim 49, wherein the one or more sealed handles that are operably connected to the vessel comprise:
one or more sealed handles having one end operably connected to a shoulder region of the vessel and the other end operably connected to the side wall of the vessel with the sealed handle positioned over a recessed portion that protrudes into the body portion.

80.-84. (canceled)

85. The vessel of claim 49, further comprising:
one or more recessed portions that protrude into the one or more side walls of the body portion.

86. (canceled)

87. The vessel of claim 85, wherein the one or more recessed portions that protrude into the one or more side walls of the body portion comprise:
one or more recessed portions that protrude into the one or more side walls in a position that is substantially medial to the body portion of the vessel.

88.-89. (canceled)

90. The vessel of claim 85, wherein the one or more recessed portions that protrude into the one or more side walls of the body portion comprise:
one or more recessed portions that protrude into the one or more side walls at a corner formed in the body portion of the vessel.

91. The vessel of claim 85, wherein the one or more recessed portions that protrude into the one or more side walls of the body portion comprise:
one or more recessed portions that protrude into the one or more side walls at a non-corner portion of the body portion of the vessel.

92. The vessel of claim 85, wherein the one or more recessed portions that protrude into the one or more side walls of the body portion comprise:
one or more recessed portions that protrude into the one or more side walls of the body portion at a position that is substantially opposite that of at least one handle that is operably connected to the vessel.

93.-94. (canceled)

95. The vessel of claim 49, further comprising:
at least one lid.

96. The vessel of claim 95, wherein the at least one lid comprises:
at least one lid that is connected to the vessel.

97.-98. (canceled)

99. The vessel of claim 95, wherein the at least one lid comprises:
at least one lid that is configured with threads that operably associate with threads of the at least one neck member.

100. (canceled)

101. A process comprising:
closing a mold that is configured to form at least one vessel having two recessed portions around a parison so that a portion of the parison is pinched together in at least two positions in a portion of the mold that forms a handle on the vessel, and
injecting gas into one or more portions of the parison to form the at least one vessel defined by the mold.

102.-103. (canceled)

104. The process of claim 101, wherein the closing a mold that is configured to form at least one vessel having two recessed portions around a parison so that a portion of the parison is pinched together in at least two positions in a portion of the mold that forms a handle on the vessel comprises:
positioning in the mold at least one insert that is configured to form at least one recessed portion in one or more side walls of the vessel formed by the mold.

105.-107. (canceled)

108. The process of claim 101, wherein the closing a mold that is configured to form at least one vessel having two recessed portions around a parison so that a portion of the parison is pinched together in at least two positions in a portion of the mold that forms a handle on the vessel comprises:
closing the mold partially.

109.-112. (canceled)

113. The process of claim 101, further comprising:
inserting at least one blow needle into at least one portion of the mold that forms at least one handle on the at least one vessel.

114. The process of claim 113, wherein the inserting at least one blow needle into at least one portion of the mold that forms at least one handle on the at least one vessel comprises:
inserting the at least one blow needle into at least one portion of the mold that forms at least one handle on the at least one vessel after the mold is completely closed.

115.-118. (canceled)
